(19) United States
(12) Patent Application Publication
(10) Pub. No.: US 2013/0042011 A1
(43) Pub. Date: Feb. 14, 2013

(54) COMMUNICATION NODES AND NETWORK NODES

(71) Applicants: Ryuji Sugizaki, Tokyo (JP); Shinkichi Ikeda, Kanagawa (JP); Keigo Aso, Kanagawa (JP); Genadi Velev, Darmstadt (DE)

(72) Inventors: Ryuji Sugizaki, Tokyo (JP); Shinkichi Ikeda, Kanagawa (JP); Keigo Aso, Kanagawa (JP); Genadi Velev, Darmstadt (DE)

(73) Assignee: PANASONIC CORPORATION, Osaka (JP)

(21) Appl. No.: 13/641,072

(22) PCT Filed: Apr. 12, 2011
(86) PCT No.: PCT/JP2011/002154

§ 371 Date: Oct. 25, 2012

(30) Foreign Application Priority Data
Apr. 14, 2010 (JP) 2010-093564
Jun. 15, 2010 (JP) 2010-136462
Aug. 9, 2010 (JP) 2010-178953

(51) Int. Cl. G06F 15/16

(52) U.S. Cl. 709/227

(57) ABSTRACT

Disclosed is a technique for reducing the number of event report messages sent from many communication nodes (MTC devices). Upon detecting an event (smoke detection by a smoke sensor), an MTC device A 100A sends an event report message to an MTC server 150. By receiving the event report message, the network recognizes the event detection by the MTC device, and sends a reverse event report message to a plurality of MTC devices by, for example, broadcasting. The reverse event report message instructs not to send a report message in a high priority mode even in the case of detecting the same event (smoke detection) or detecting another event (flame occurrence or the like) caused by an incident (fire occurrence) that causes the former event (smoke detection). This can suppress sending of a subsequent redundant event report message.

### TECHNICAL FIELD

The present invention relates to a communication node and a network node for determining message sending when a message is sent to a network, and especially relates to a communication node and a network node for determining message sending when a communication node (hereafter referred to as MTC device) in MTC (Machine Type Communications, also referred to as M2M (Machine to Machine) communications) detects an event and sends a message to a network.

### BACKGROUND ART

Technologies employed in MTC are currently standardized in 3GPP (the Third Generation Partnership Project) which is a standardization body for technologies used in mobile phones (User Equipment: UE) (see Non-patent Documents 1 and 2 listed below). MTC includes: an MTC device (e.g. a communication module incorporated in a device or a machine such as a vending machine, a street advertisement display, a smoke sensor, a security camera, a human sensor, or the like, or a generic name thereof); an MTC server which is a server that performs control and state management of communication by the MTC device and provides an application service (also referred to as MTC service); and an MTC user that performs application control and management for the MTC device and the MTC server. MTC is premised on the use of a 3GPP-based access network (hereafter referred to as communication system) such as GERAN (GSM EDGE Radio Access Network), UTRAN (Universal Terrestrial Radio Access Network), or E-UTRAN (Evolved UTRAN), for the purpose of utilizing existing features such as mobility control (also referred to as mobile control, mobility management, or location management) for conventional UE. That is, the MTC device performs communication while coexisting with the conventional UE in the communication system. It is assumed here that the UE is a mobile terminal operated by a person via a user interface, and the MTC device is not directly operated by a person but embedded in a terminal or a device and operated via the communication system. FIG. 1 shows an example of a structure of an MTC communication network.

FIG. 1 shows an example of a network structure including: an MTC device 100: a UE 105; a base station (referred to as eNB (eNode B) in E-UTRAN and NB (Node B) in UTRAN) 110 wirelessly connected to the MTC device 100 or the UE 105; an MME (Mobility Management Entity) 120 in charge of mobility management of the MTC device 100 and the UE 105 on an E-UTRAN 115; an SGW (Serving Gateway, also referred to as MAG (Mobility Anchor Gateway: mobility anchor point) or the like) 130 that controls user data delivery of the MTC device 100 and the UE 105 to the E-UTRAN 115; a PGW (Packet Gateway, also referred to as HA (Home Agent), LMA (Local Mobility Anchor), or the like) 140 that performs address assignment to the MTC device 100 and the UE 105 and user data transfer and path control between a PDN (Packet Data Network) 155 and the SGW 130; an HSS (Home Subscriber Server) 125 that manages and holds subscription data, communication contexts, and the like of the MTC device 100 and the UE 105; an MTC server 150 which is a server that performs control and state management of communication by the MTC device 100 and provides an application service; and an MTC user 160 that performs application management and control and manages application data for the MTC device 100 and the MTC server 150.

In FIG. 1, when the MTC device 100 communicates with the MTC server 150 (server for providing a service) via the communication system, the MTC device 100 establishes a PDN connection and an EPS bearer with the PGW 140 (see Non-patent Document 3 listed below). Data (e.g. sensing data such as smoke detection information in a smoke sensor) obtained by the MTC device 100 is sent to the PGW 140 via the established PDN connection and EPS bearer, and transferred from the PGW 140 to the MTC server 150. The MTC server 150 provides the data received from the MTC device 100 to the MTC user 160, at a defined timing (e.g. after receiving the data from the MTC device 100 or after receiving a request message from the MTC user 160).

The timing at which the MTC device 100 sends the obtained data to the MTC server 150 is determined by a feature (MTC feature, also referred to as feature of MTC) of the MTC device 100, an instruction from an operator of the communication system, or the contents of the MTC service. As an example, in the case where the MTC device 100 has a “time controlled” feature (time control) which is one of the MTC features defined in Non-patent Document 1, that is, in the case where a time during which the MTC device 100 performs communication is restricted, the MTC device 100 is allowed to access the MTC server 150 and send the obtained data only during a predetermined time (e.g. assigned by the operator of the communication system or set by the MTC user 160). In the case where the MTC device 100 has a “PAM (Priority Alarm Message)” feature defined in Non-patent Document 1, that is, in the case where the MTC device 100 is capable of sending a high priority message to the MTC server 150/MTC user 160, upon detection of an event (e.g. smoke detection, flame detection, theft, etc.) the MTC device 100 sends the message with higher priority than other messages, which is transferred to the MTC server 150. Since the PAM also corresponds to emergency information report, the PAM may be allowed to be sent at any timing without the constraint of the above-mentioned “time controlled” feature, according to application setting or a policy of the communication operator.

In the case where the MTC device 100 has a “group based” feature which is another MTC feature defined in Non-patent Document 1, that is, in the case where a plurality of MTC devices 100 are managed based on demand (e.g. ease of management of the MTC devices 100, IMSI (International Mobile Subscriber Identity) sharing, etc.) of the MTC server 150/MTC user 160 or the operator of the communication system, by treating the plurality of MTC devices 100 as one group (hereafter referred to as MTC group), for example the HSS 125 can manage and hold all or part of subscription data, which is normally managed and held per MTC device 100, per MTC group in an aggregate manner.

In the case where the MTC device 100 has a “low mobility” feature, that is, in the case where the MTC device 100 moves only within a limited range (e.g. moves only within a predetermined TA (Tracking Area) or cell range) or is fixed as a device such as a vending machine, a frequency of a procedure for updating location information such as TAU (Tracking Area Update) or RAU (Routing Area Update) can be reduced as compared with the UE 105. This contributes to a reduced load of mobility control on a communication node (e.g. the MME 120, the PGW 140, etc.) that performs mobility management with the MTC device 100.

Thus, the MTC device 100 can have a plurality of MTC features based on the MTC user 160's request. Moreover, the MTC features of the MTC device 100 can be activated or deactivated according to demand between the MTC device 100 and the MTC server 150/MTC user 160 (activation/deactivation of features and operations).

When compared with the conventional UEs 105, an enormous number of MTC devices 100 are expected to simultaneously perform communication via the communication system. Hence, network improvements for supporting communication by the MTC devices 100 are necessary in order not to interfere with communication by the UEs 105.

### PRIOR ART DOCUMENT

### Non-Patent Document

Non-patent Document 1: 3GPP TS 22.368 V1.1.1, November 2009

Non-patent Document 2: 3GPP TR 23.888 V0.1.1, December 2009

Non-patent Document 3: 3GPP TS 23.401 V9.3.0, December 2009

Non-patent Document 4: 3GPP TS 33.402 V9.2.0, December 2009

Non-patent Document 5: 3GPP TS 36.300 V9.2.0, December 2009

Non-patent Document 6: 3GPP TR 23.888 V0.4.1, June 2010

However, in the conventional communication system, a problem arises in the case where a plurality of MTC devices detect events and send high priority event report messages. This is described below with reference to FIG. 2.

As a scenario, consider the case where an apartment fire occurs in an environment in which a plurality of MTC devices 100 (e.g. smoke sensor, flame sensor, human sensor) having the “time controlled”, “PAM”, “group based”, and “low mobility” features among the MTC features defined in Non-patent Document 1 constitute one MTC group and monitor security of an apartment complex. An MTC device 100 (e.g. smoke sensor) detects an event (smoke) (smoke occurrence) that initiates recognition of the fire occurrence, and subsequently another MTC device 100 (e.g. human sensor) detects an event (human presence/absence).

First, an MTC device (MTC device A 100A) equipped in a smoke sensor establishes a PDN connection for communicating with the MTC server 150 (step S2001 in FIG. 2: PDN connection established). An MTC device B 100B equally establishes a PDN connection with the PGW 140 (step S2004 in FIG. 2: PDN connection established).

The MTC device A 100A (smoke sensor) detects an event (smoke) (step S2002 in FIG. 2: event detection). Upon detecting the event, the MTC device A 100A reports the smoke detection to the MTC server 150 using a PAM (step S2003 in FIG. 2: event report message @ device A).

Meanwhile, a plurality of MTC devices B 100B (other smoke sensor, flame sensor, etc.) installed at other locations also detect fire occurrence (step S2005 in FIG. 2), and reports the detection of the fire occurrence using a high priority event report message (e.g. PAM) (step S2006 in FIG. 2). For example, another smoke sensor equally detects smoke, and an MTC device B 100B equipped in the other smoke sensor reports the smoke detection using a high priority event report message (e.g. PAM). Moreover, for example, a flame sensor detects ultraviolet light emitted from flames, and an MTC device B 100B equipped in the flame sensor reports the detection of the ultraviolet light emitted from the flames to the MTC server 150 using a high priority message. The number of other smoke sensors and flame sensors installed may be enormous.

As a result, in the existing communication system, even though the MTC server 150 can already detect the fire occurrence by the PAM sent from the MC device A 100A first, the MTC server 150 needs to also receive the PAMs from many MTC devices B 100B equally detecting the fire occurrence and process all of the received PAMs. This causes an increase in processing load of the MTC server 150 and traffic load of the network. Besides, a delay or loss of an event detection (e.g. human presence/absence in the above-mentioned example) message that needs to be communicated after the detection of the fire occurrence can incur a problem such as a failure to promptly respond to the disaster.

The same problem can arise in such a scenario in which a plurality of gas sensors installed in a factory report gas leakage detection to the MTC server 150 using PAMs. An increase in redundant processing load and network traffic load ensues in this case, too.

That is, in an environment in which many MTC devices 100 are installed, there is a problem of a processing load increase because, even though an MTC device 100 reports detection of an event (smoke occurrence) to the network side with priority so that the network side can recognize from the event report that some incident (e.g. fire occurrence) occurs, the network side also needs to process event report messages (redundant event report messages) equally sent from many MTC devices 100 in a high priority mode. In addition, flows of many event report messages cause an increase of network traffic. This incurs a possibility of a delay or a failure in delivering information indicating occurrence of another event to the network side.

### SUMMARY OF THE INVENTION

To solve the problems described above, the present invention has an object of providing a communication node and a network node for reducing the load on the network side (such as the processing load on an MTC server and communication system entities (e.g. eNB, MME, SGW, PGW) and the network traffic load). The present invention also has an object of providing a communication node and a network node for reducing the processing load on an MTC server and communication system entities (e.g. eNB, MME, SGW, PGW) and the network traffic load, in a situation where an MTC device that communicates with an MTC server via a communication system detects an event in an environment in which many MTC devices are installed. The present invention further has an object of providing a communication node and a network node for reducing the processing load on an MTC server and communication system entities (e.g. eNB, MME, SGW, PGW) and the network traffic load, in the case where congestion is detected on the network side.

To achieve the stated objects, a communication node according to the present invention comprises a communication control unit configured to: receive a control message from a network, the control message being sent from an entity in the network according to a report from an other communication node or according to a state of communication with the other communication node and instructing a communication node that meets a specific condition to change a communication mode; and control to change the communication mode in the case where the specific condition is met with reference to the specific condition included in the received control message.

According to this structure, the load on the network side (such as the processing load on an MTC server and communication system entities (e.g. eNB, MME, SGW, PGW) and the network traffic load) can be reduced.

Moreover, to achieve the stated objects, a communication node according to the present invention is the communication node wherein the communication control unit includes: an operation mode control unit configured to perform control to operate in a sending mode that is either a normal mode or a high priority mode, the normal mode being a mode in which sensing data detected by a sensor for detecting an occurrence of a specific event is sent with a normal priority, and the high priority mode being a mode in which an event report message reporting that the occurrence of the specific event is detected by the sensor is sent with a priority higher than the priority in the normal mode; a sending unit configured to send, to a network node, the event report message in the high priority mode or the sensing data in the normal mode; a message receiving unit configured to receive a message sent from the network node that receives an event report message reporting detection of an occurrence of a specific event from an arbitrary communication node, the message being sent from the network node as a response to the event report message from the arbitrary communication node and instructing to have the sending mode transition to the normal mode or maintained at the normal mode; and a mode transition determination unit configured to determine whether or not to have the sending mode transition to the normal mode or maintained at the normal mode, in the case where the message is received, and wherein the operation mode control unit is configured to have the sending mode transition to the normal mode or maintained at the normal mode, in the case where the mode transition determination unit determines to have the sending mode transition to the normal mode or maintained at the normal mode.

According to this structure, the processing load on an MTC server and communication system entities (e.g. eNB, MME, SGW, PGW) and the network traffic load can be reduced in a situation where a communication node that communicates with a server (MTC server) via a communication system detects and reports an event in an environment in which many communication nodes (MTC devices) are installed.

Moreover, to achieve the stated objects, a communication node according to the present invention is the communication node wherein the communication control unit includes: a message receiving unit configured to receive a message sent from a network node in the case where congestion is detected in the network, the message including information instructing a communication node that has a time tolerant feature defined in machine type communication to suppress a connection to the network; a feature determination unit configured to determine whether or not the communication node has the time tolerant feature, in the case where the message is received; and a connection control unit configured to, in the case where the communication node is determined to have the time tolerant feature, release a connection established with the network, control data sending while maintaining the connection established with the network, or control not to make a connection request to the network in the case where the connection with the network is not established.

According to this structure, the processing load on an MTC server and communication system entities (e.g. eNB, MME, SGW, PGW) and the network traffic load can be reduced in the case where congestion is detected on the network side.

Moreover, to achieve the stated objects, a network node according to the present invention comprises a communication control unit configured to include, in a control message sent from an entity in a network according to a report from an other communication node or according to a state of communication with the other communication node, information instructing a communication node that meets a specific condition to change a communication mode, to control to change the communication mode of the communication node that meets the specific condition.

According to this structure, the load on the network side (such as the processing load on an MTC server and the network traffic load) can be reduced.

Moreover, to achieve the stated objects, a network node according to the present invention is the network node connected to a plurality of communication nodes each of which operates in a sending mode that is either a normal mode or a high priority mode, the normal mode being a mode in which sensing data detected by a sensor for detecting an occurrence of a specific event is sent with a normal priority, and the high priority mode being a mode in which an event report message reporting that the occurrence of the specific event is detected by the sensor is sent with a priority higher than the priority in the normal mode, wherein the communication control unit includes: a receiving unit configured to receive the event report message reporting the detection of the occurrence of the specific event, from any one of the plurality of communication nodes; a message generation unit configured to generate a message instructing to have the sending mode transition to the normal mode or maintained at the normal mode, as a response to the event report message; and a message sending unit configured to send the message to the plurality of communication nodes.

According to this structure, the processing load on an MTC server and communication system entities (e.g. eNB, MME, SGW, PGW) and the network traffic load can be reduced in a situation where a communication node that communicates with a server (MTC server) via a communication system detects and reports an event in an environment in which many communication nodes (MTC devices) are installed.

Moreover, to achieve the stated objects, a network node according to the present invention is the network node wherein the communication control unit includes a message generation unit configured to include, in the message, information instructing a communication node that has a time controlled feature defined in machine type information to suppress a connection to the network, in the case where congestion is detected.

According to this structure, an object of providing a communication node and a network node for reducing the processing load on an MTC server and communication system entities (e.g. eNB, MME, SGW, PGW) and the network traffic load in the case where congestion is detected on the network side is achieved.

The present invention having the structures described above has an advantageous effect of reducing the load on the network side (such as the processing load on an MTC server and communication system entities (e.g. eNB, MME, SGW, PGW) and the network traffic load). The present invention also has an advantageous effect of reducing the processing load on a server and the network traffic load in a situation where a communication node that communicates with a server (MTC server) via a communication system detects and reports an event in an environment in which many communication nodes (MTC devices) are installed. The present invention further has an advantageous effect of reducing the processing load on an MTC server and communication system entities (e.g. eNB, MME, SGW, PGW) and the network traffic load in the case where congestion is detected on the network side.

The present invention also has an advantageous effect of being able to switch a sending mode of an MTC device that sends detected information to an MTC server 150 in a normal mode during normal time, to a high priority mode during emergency (when an incident occurs).

### BRIEF DESCRIPTION OF THE DRAWINGS

FIG. 1 is a diagram showing an example of a structure of a communication system common to Embodiments 1 to 6 and 8 of the present invention and conventional art.

FIG. 2 is a sequence chart for describing an example of an operation in conventional art.

FIG. 3 is a sequence chart for describing an example of an operation of suppressing sending of a redundant event report message in Embodiment 1 of the present invention.

FIG. 4 is a sequence chart for describing an example of an operation of suppressing sending of a redundant event report message in Embodiment 2 of the present invention.

FIG. 5A is a diagram showing an example of a format of an event report message (event information) @ device A in Embodiments 2 to 7 of the present invention.

FIG. 5B is a diagram showing an example of a format of a reverse event report message (event information) in Embodiments 2 to 7 of the present invention.

FIG. 6 is a diagram showing an example of event group information in Embodiments 2 to 7 of the present invention.

FIG. 7 is a diagram showing an example of sending mode transition of an MTC device in Embodiments 2 to 7 of the present invention.

FIG. 8 is a diagram showing an example of a structure of an MTC device in Embodiment 2 of the present invention.

FIG. 9A is a flowchart showing an example of a sending process flow of the MTC device in Embodiment 2 of the present invention.

FIG. 9B is a flowchart showing an example of a receiving process flow of the MTC device in Embodiment 2 of the present invention.

FIG. 10 is a diagram showing an example of a structure of an MME in Embodiment 2 of the present invention.

FIG. 11 is a flowchart showing an example of a process flow of the MME in Embodiment 2 of the present invention.

FIG. 12 is a diagram showing an example of arrangement of each MTC device for detailed description of Embodiments 1 and 2 of the present invention.

FIG. 13 is a diagram showing an example of sending mode transition in each MTC device for detailed description of Embodiments 1 and 2 of the present invention.

FIG. 14 is a diagram showing an example of event group information held by each MTC device for detailed description of Embodiments 1 and 2 of the present invention.

FIG. 15 is a sequence chart for describing an example of an operation of suppressing sending of a redundant event report message in Embodiment 3 of the present invention.

FIG. 16 is a sequence chart for describing an example of an operation of suppressing sending of a redundant event report message in Embodiment 4 of the present invention.

FIG. 17 is a sequence chart for describing an example of an operation of suppressing sending of a redundant event report message in Embodiment 5 of the present invention.

FIG. 18 is a diagram showing an example of a structure of a communication system in Embodiment 7 of the present invention.

FIG. 19 is a diagram for describing an operation relating to a “time tolerant” feature (time tolerance) in Embodiment 8 of the present invention.

FIG. 20 is a sequence chart for describing an example of an operation of releasing a low priority PDN connection in Embodiment 8 of the present invention.

FIG. 21 is a diagram showing an example of a format of a sending control message in Embodiment 8 of the present invention.

FIG. 22 is a diagram showing an example of a structure of an MTC device in Embodiment 8 of the present invention.

FIG. 23 is a flowchart showing an example of a receiving process flow of the MTC device in Embodiment 8 of the present invention.

FIG. 24 is a flowchart showing an example of a detailed receiving process flow of the MTC device in Embodiment 8 of the present invention.

FIG. 25 is a sequence chart for describing an example of an operation in the case where an MTC device tries to establish an additional PDN connection in Embodiment 9 of the present invention.

FIG. 26 is a diagram showing an example of parameters usable as QoS information and their actions in Embodiment 9 of the present invention.

FIG. 27A is a diagram showing an example of a condition of a parameter (GBR (relative value case)) usable as QoS information and its action result in Embodiment 9 of the present invention.

FIG. 27B is a diagram showing an example of a condition of a parameter (QCI) usable as QoS information and its action result in Embodiment 9 of the present invention.

FIG. 27C is a diagram showing an example of a condition of a parameter (MBR (relative value case)) usable as QoS information and its action result in Embodiment 9 of the present invention.

FIG. 27D is a diagram showing an example of a condition of a parameter (ARP: non-roaming case) usable as QoS information and its action result in Embodiment 9 of the present invention.

FIG. 27E is a diagram showing an example of a condition of a parameter (ARP: roaming case) usable as QoS information and its action result in Embodiment 9 of the present invention.

FIG. 28 is a diagram showing an example of a format of a PDN connection release request message in Embodiment 9 of the present invention.

FIG. 29 is a diagram showing an example of a structure of an MTC device in Embodiment 9 of the present invention.

FIG. 30 is a flowchart showing an example of a process flow of the MTC device in Embodiment 9 of the present invention.

FIG. 31 is a sequence chart for describing an example of an operation in the case where an MTC device tries to establish an additional PDN connection in Embodiment 10 of the present invention.

FIG. 32 is a diagram showing an example of parameters usable as QoS information and their actions in Embodiment 10 of the present invention.

FIG. 33A is a diagram showing an example of a condition of a parameter (GBR (relative value case)) usable as QoS information and its action result in Embodiment 10 of the present invention.

FIG. 33B is a diagram showing an example of a condition of a parameter (QCI) usable as QoS information and its action result in Embodiment 10 of the present invention.

FIG. 33C is a diagram showing an example of a condition of a parameter (MBR (relative value case)) usable as QoS information and its action result in Embodiment 10 of the present invention.

FIG. 33D is a diagram showing an example of a condition of a parameter (ARP: non-roaming case) usable as QoS information and its action result in Embodiment 10 of the present invention.

FIG. 33E is a diagram showing an example of a condition of a parameter (ARP: roaming case) usable as QoS information and its action result in Embodiment 10 of the present invention.

FIG. 34 is a diagram showing an example of a format of a PDN connection establishment reject message in Embodiment 10 of the present invention.

FIG. 35 is a diagram showing an example of a structure of a communication system in Embodiments 9 and 10 of the present invention.

FIG. 36 is a sequence chart for describing an example of an operation in the case where an MTC device checks a connection destination in Embodiments 9 and 10 of the present invention.

### DESCRIPTION OF EMBODIMENTS

The following describes Embodiments 1 to 3 of the present invention with reference to drawings.

<System Structure>

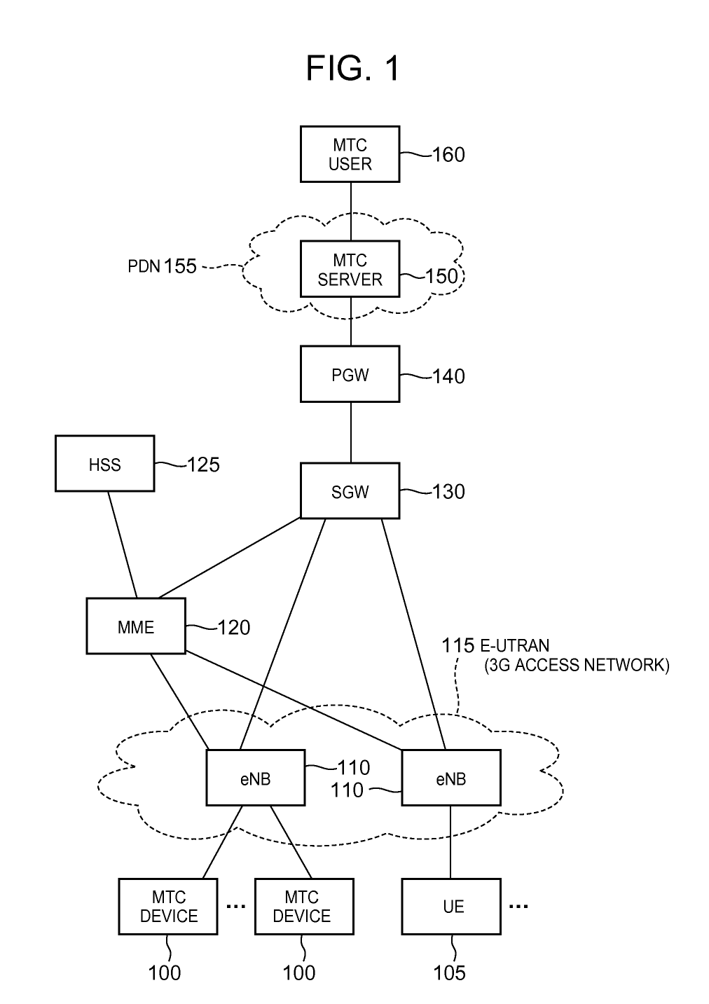

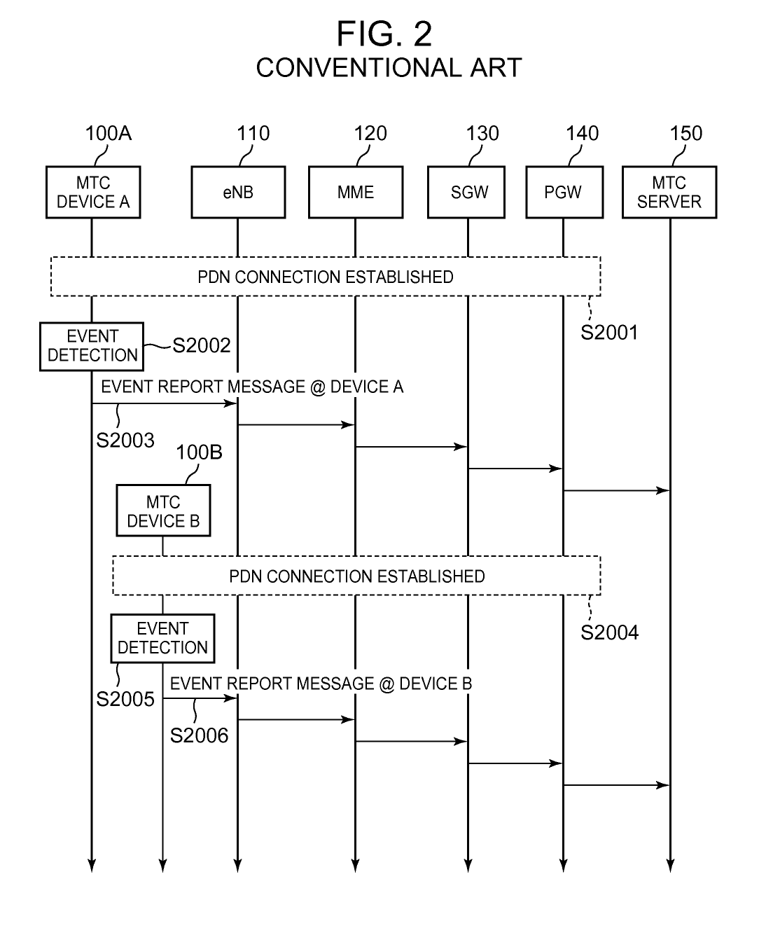

A system structure common to Embodiments 1 to 3 of the present invention is described first, with reference to FIG. 1. FIG. 1 is a diagram showing an example of the system structure common to Embodiments 1 to 3 of the present invention.

As mentioned earlier, the communication system shown in FIG. 1 at least includes: the MTC device 100: the UE 105; the base station (eNB or NB) 110 wirelessly connected to the MTC device 100 or the UE 105; the MME 120 in charge of mobility management of the MTC device 100 and the UE 105 on the E-UTRAN 115; the SGW 130 that controls user data delivery of the MTC device 100 and the UE 105 to the E-UTRAN 115; the PGW 140 that performs address assignment to the MTC device 100 and the UE 105 and user data transfer and path control between the PDN 155 and the SGW 130; the HSS 125 that manages and holds subscription data, communication contexts, and the like of the MTC device 100 and the UE 105; the MTC server 150 which is a server that performs control and state management of communication by the MTC device 100 and provides an application service; and the MTC user 160 that performs application management and control and manages application data for the MTC device 100 and the MTC server 150. The MTC user 160 may use an AAA (Authentication, Authorization and Accounting) server instead of the HSS 125. The AAA server and the HSS 125 may be physically or logically implemented in the same device.

Though the MTC server 150 is positioned within the PDN 155 in FIG. 1, the MTC server 150 may be positioned within an operator domain of the communication system. For example, the PGW 140 may have the function of the MTC server 150.

The MTC device 100 has at least one communication interface, and is able to connect to the communication system (e.g. the E-UTRAN 115). The MTC device 100 may simultaneously or exclusively connect to a network (e.g. UTRAN, WLAN (Wireless LAN) network, WiMAX network) other than the communication system shown in FIG. 1. The MTC device 100 is communicable with the MTC server 150 via the connected communication system, and the MTC server 150 is communicable with the MTC user 160.

The MTC device 100 performs communication while coexisting with the conventional UE 105 in the communication system. Though the MTC device 100 and the UE 105 connect to different eNBs 110 in FIG. 1, the eNB 110 for MTC devices is not distinguished from other eNBs, and the MTC device 100 may connect to any eNB 110. However, in the case of changing, in future, to an environment in which the MTC device 100 is only allowed to connect to the eNB 110 customized for MTC devices 100, the MTC device 100 may connect to the eNB 110 for MTC devices 100.

Each MTC device 100 is assigned an ID (hereafter referred to as device ID) for identifying the MTC device 100, like the UE 105. In the case where MTC devices 100 constitute an MTC group, each MTC device 100 is also assigned an ID (hereafter referred to as group ID) for identifying the MTC group. Each MTC device 100 is further assigned an ID (hereafter referred to as device type ID) for identifying a device type (e.g. smoke sensor). Note that the type of the MTC device 100 is determined by the type of the device equipped or connected with the MTC device 100. The type of the MTC device 100 may also be set by the MTC server, the MTC user, or the operator of the communication system.

The device type ID does not necessarily need to be used if the MTC device 100, a communication system entity (e.g. the MME 120, the PGW 140), and the MTC server 150 can identify the type of the MTC device 100 without using the device type ID (for example, by deriving the type of the MTC device 100 from a bit string (e.g. higher order bits or lower order bits) which is a part of the device ID indicating the device type). The device ID does not necessarily need to be assigned if the MTC device 100 can be uniquely identified using, for example, an IMEI (International Mobile Equipment Identity) or an IMSI (International Mobile Subscriber Identity). The group ID does not necessarily need to be assigned if the MTC group can be identified using, for example, a PDN connection ID, an EPS bearer ID, or an APN (Access Point Name) in the case of sharing a PDN connection and an EPS bearer for data transfer (e.g. in the case where a representative MTC device 100 in the MTC group has established a PDN connection and an EPS bearer with the communication system and transfers data obtained by another MTC device 100 in the same MTC group).

Each MTC device 100 may have MTC features incorporated therein by the MTC user 160 or the like beforehand (e.g. by writing to an SIM card or writing to a storage memory of the MTC device 100), and a network device (e.g. the MME 120, the MTC server 150) or the MTC device 100 itself may activate or deactivate a desired MTC feature. The above-mentioned various MTC-related information such as the device ID, the group ID, the device type ID, the MTC features, the MTC feature activation/deactivation, and the like of the MTC device 100 are registered in subscription data, communication contexts, and the like held by the HSS 125. Moreover, the MME 120 executes mobility control of the MTC device 100 in the E-UTRAN 115, as with control of the UE 105.

The MTC server 150 is managed either by the operator of the communication system or by a manager other than the operator. In either case, the MTC server 150 has an interface with the PGW 140 managed by the operator, and receives a service relating to user data transfer to/from the MTC device connected to the communication system and control of the MTC device in the communication system. In the case where the operator manages the MTC server, the MTC server and the PGW 140 may be implemented in the same device. This enables implementation of an external interface to be concealed inside the device to thereby reduce device costs.

The MTC user 160 is an entity that manages and uses data obtained by each MTC device 100, and corresponds to a business operation entity, a corporation, or a control entity (e.g. PC, server) executing data management. Supposing that the MTC device 100 is incorporated in a vending machine, the MTC user 160 is, for example, a company that performs sales aggregation and maintenance of vending machines. Supposing that the MTC device 100 is incorporated in a smoke sensor, the MTC user 160 is, for example, a fire department, a security company, an insurance company, or a company that reduces damage caused by house fire. The MTC user 160 may be regarded as an MTC user terminal used by a user who manages MTC as mentioned above, or regarded as the same device as the MTC server 150 operated by the user who manages MTC.

Data exchanged between the MTC device 100 and the MTC server 150 is typically application-level data, so that data transfer between the MTC device 100 and the PGW 140 is expected to use the U-plane (User plane). However, the use (superimposing or piggybacking application data on a signaling message) of the C-plane (Control plane) having immediacy and reliability may produce a significant advantageous effect, depending on the contents or property of the application or the service (e.g. service for emergency data transfer such as survivor confirmation), the requirement of the network operator of the communication system (e.g. when control by a network device (e.g. the MME 120) is needed (such as modification of location information of the MTC device 100 or control of the MTC group or the same device type)), or the requirement of the MTC device 100/MTC server 150 (e.g. when wishing to send/obtain data promptly or highly reliably).

The MTC device 100 that sends a high priority event report message upon event detection sends, when detecting an event from obtained data (also referred to as sensing data), a high priority event report message to the MTC server, and simultaneously or subsequently sends the obtained data (sensing data) to the MTC server.

In the communication system having the above-mentioned structure, the MTC device 100 is connected to the communication system (the E-UTRAN 115), and is communicable with the MTC server 150 via the communication system.

### Embodiment 1

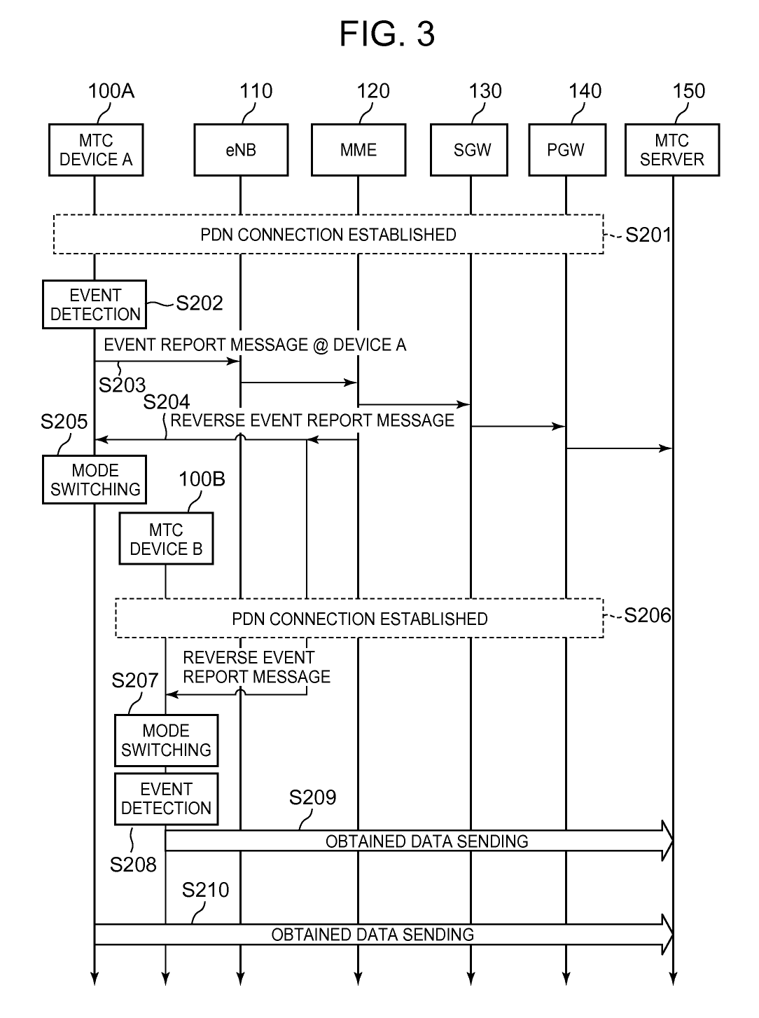

The following describes an example of a system operation in Embodiment 1 of the present invention in detail, with reference to FIG. 3. FIG. 3 is a sequence chart for describing an example (method of suppressing sending of a high priority event report message of the same event or an event caused by an incident that causes the former event, from a plurality of MTC devices 100) of the system operation in Embodiment 1 of the present invention. An example of a process sequence in the system structure shown in FIG. 1 is shown in FIG. 3.

It is assumed that the MTC device 100 has the following features, for ease of explanation of this embodiment.

The MTC device 100 has the “time controlled”, “PAM”, “group based”, and “low mobility” features defined in Non-patent Document 1. The MTC device 100 is managed as one MTC group together with other MTC devices 100. The MTC devices 100 in the MTC group include a smoke sensor, a flame sensor, and a human sensor (in actuality a communication module which is the MTC device 100 is implemented in each sensor). The smoke sensor determines that there is a high possibility of fire occurrence and sends a message with high priority (also referred to as in a high priority mode), in the case of detecting a smoke density of a predetermined level or more (or a smoke density of a predetermined level or more continuously for a predetermined time), that is, in the case of detecting an event (smoke). The flame sensor determines that there is a high possibility of fire occurrence and sends a message with high priority (in the high priority mode) like the smoke sensor, in the case of detecting an event (flame). On the other hand, the human sensor sends sensing data with normal priority (also referred to as in a normal mode), in the case of detecting an event (human presence/absence). Here, the high priority mode is a state of sending a high priority event report message upon event detection. The normal mode is a state of sending obtained data with normal priority or a state of sending an event report message with normal priority and equally sending obtained data with normal priority upon event detection, without sending a high priority event report message. Note that the message priority may be defined by a priority level or a value defined for each MTC feature, each type of MTC device 100, or each MTC service, PCC (Policy and Charging Control), an IMSI or an IMEI of the MTC device 100, an EPS bearer bandwidth (e.g. MBR (Maximum Bit Rate), AMBR (Aggregate Maximum Bit Rate)), or an EPS bearer QCI.

FIG. 3 shows an MTC device A 100A and an MTC device B 100B, to distinguish the MTC devices 100 in the MTC group. Suppose the MTC device A 100A is an MTC device (smoke sensor) that detects an event first, and the MTC device B 100B is another MTC device (smoke sensor, flame sensor, human sensor) belonging to the same MTC group as the MTC device A 100A. Though only the two MTC devices 100 (the MTC device A 100A and the MTC device B 100B) are present in FIG. 3, the same operation applies in the case where three or more MTC devices 100 are present in the same MTC group.

The sequence shown in FIG. 3 is described below. The MTC device A 100A (smoke sensor) establishes a PDN connection for communicating with the MTC server 150, with the PGW 140 based on a conventional method (e.g. attach procedure described in Non-patent Document 3) (step S201 in FIG. 3: PDN connection established). The MTC device B 100B also establishes a PDN connection with the PGW 140 based on the conventional method (e.g. attach procedure described in Non-patent Document 3) (step S206 in FIG. 3: PDN connection established).

For example, the MTC device A 100A detects an event (smoke) due to fire occurrence or the like (step S202 in FIG. 3: event detection). Upon detecting the event, the MTC device A 100A sends a message (event report message @ device A) reporting the event detection to the MTC server 150. It is estimated that there is a high possibility of fire occurrence in the case where the MTC device A 100A (smoke sensor) detects smoke, so that the MTC device A 100A reports to the MTC server 150 using a high priority message (e.g. PAM) (step S203 in FIG. 3: event report message @ device A). Hereafter, the term “high priority message” indicates a PAM, a NAS/AS message of higher priority than other NAS messages, or the like. The high priority message may also be referred to as (priority) event notification, alarm signaling, event alert, emergency signaling, event detection message, or the like.

For example, the event report message @ device A which is the high priority message sent from the MTC device A 100A may use a message used for establishing a PDN connection or an EPS bearer such as an attach request or a service request or an IKE_SA_INIT message or an IKE_AUTH request message employed in DS-MIPv6 bootstrapping based on IKEv2 defined in Non-patent Document 4, in the case of piggybacking (superimposing) on a PAM defined in Non-patent Document 1 or a location registration message such as a TAU (Tracking Area Update) request described in Non-patent Document 3 or in the case of detecting an event in a state in which a PDN connection or an EPS bearer is not established. Alternatively, a bearer modification request message may be used. This enables the event report from the MTC device 100 to be performed with little modification, without introducing a new message.

Upon receiving the high priority event report message reporting the event detection from the MTC device A 100A which belongs to the MTC group, a communication system entity (e.g. the MME 120) transfers the event report message @ device A to the MTC server 150 via the SGW 130/PGW 140. The communication system entity (e.g. the MME 120) also broadcasts, to all MTC devices 100 in the same group, a message (reverse event report message, also referred to as reverse PAM, congestion avoidance message, time tolerant indication, congestion indication, congestion prior indication, PAM reduction indication, or the like) for suppressing sending of a subsequent high priority event report message (event report message (e.g. PAM) of the same event (e.g. smoke occurrence) or an event (e.g. flame occurrence) caused by an incident (e.g. fire occurrence) that causes the former event (e.g. smoke occurrence)) (step S204 in FIG. 3: reverse event report message). The communication system entity (e.g. the MME 120) may contain a parameter indicating to stop sending of the same type of high priority report message, in the reverse report message.

The reverse event report message may be sent with higher priority than other messages or with normal priority, according to determination (e.g. presetting by the operator of the communication system) by the sender (e.g. the MME 120) of the reverse event report message. In the case of sending the reverse event report message with higher priority than other messages, the high priority reverse event report message can be sent even when the sender of the message is in an overloaded state and abandons processing of normal priority messages. Instead of using the high priority reverse event report message, the reverse event report message may be sent with normal priority. In this case, there is no particular need to set the message priority.

Alternatively, the MME 120 may send the reverse event report message in the case of receiving a predetermined number of event report messages within a predetermined time or in the case of simply receiving a predetermined number of event report messages. By anticipating that the same event report message will increase in number and sending the reverse event report message to suppress such a message based on the anticipation, the suppression message (reverse event report message) can be effectively issued to achieve efficient use of communication resources and bandwidths, as compared with the case of determination from a single event report message (in the case of determination from a single event report message, the reverse event report message is sent each time the event report message is received, causing a waste of communication resources and bandwidths).

Here, the MME 120 may determine whether or not the MTC device A 100A belongs to any MTC group and, if the MTC device A 100A belongs to any MTC group, which MTC group the MTC device A 100A belongs to, by obtaining the subscription data corresponding to the MTC device A 100A from the HSS 125 and checking whether or not the group ID is registered. As an alternative, the MME 120 may determine whether or not the MTC device A 100A belongs to any group (or which group the MTC device A 100A belongs to), based on the group ID contained in the message by the MTC device A 100A. The MME 120 may also determine whether or not the MTC device A 100A belongs to any MTC group, by referencing to the subscription data already held in the MME 120 or by a method (e.g. inquiring of an external server) other than obtaining the subscription data from the HSS 125.

In this example, the reverse event report message is sent to all MTC devices (the MTC device A 100A and the MTC device B 100B) in the MTC group to which the MTC device A 100A detecting the event belongs. However, in the case where the “group based” feature is not applied, the reverse event report message may be sent to, for example, all MTC devices 100 under the eNB 110 or the MME 120 (or a specific tracking area) to which the MTC device A 100A is connected. By doing so, the high priority event report message of the same event from each MTC device 100 located in a specific area can be avoided. There is also an advantage that the group ID or the like need not be used, because the high priority event report message can be avoided without taking the concept “MTC group” into consideration. In such a case, an ID of the eNB 110 or an address of the eNB 110 (as well as an S1-U TEID corresponding to the bearer of the device) may be used instead of the group ID. Moreover, if the MME 120 is able to recognize the message destination beforehand, the reverse event report message may be sent not by broadcasting but by multicasting or unicasting. By limiting the control range (report range) in this way, the impact on the whole system can be reduced. Note that the reverse event report message may be sent by a communication system entity (e.g. the eNB 110, the PGW 140) other than the MME 120 or by the MTC server 150.

As mentioned above, the reverse event report message is a message for suppressing a subsequent high priority event report message of the same type (event report message (e.g. PAM) of the same event or an event caused by an incident that causes the former event). In detail, the reverse event report message is a message requesting the MTC device 100 to operate in the normal mode. Upon receiving the reverse event report message, the MTC device 100 transitions to the normal mode when operating in the high priority mode, and maintains the normal mode when operating in the normal mode.

The reverse event report message may also be used other than to avoid the high priority event report message (e.g. PAM). For example, in the case where the communication system entity and the MTC device 100 are capable of recognizing a plurality of priority levels and the MTC device 100 wants to send a plurality of pieces of sensing data of different priority levels, the MTC device 100 receiving the reverse event report message may select/determine sensing data that can be sent, based on an allowable priority level indicated by the network side in the reverse event report message or application data or a context (e.g. only a message of priority level 3 or more is allowed to be sent during congestion level 3) incorporated in the MTC device 100 beforehand. Here, upon receiving the reverse event report message, the MTC device 100 may switch from a mode (e.g. normal mode) of not determining the priority of sensing data to be sent, to a mode (e.g. high priority mode) of being able to select/determine sensing data to be sent based on priority.

In the case where at least the MTC device 100 is capable of recognizing a plurality of priority levels, the MTC device 100 may, for example, perform a process of modifying the priority level of the message to be sent, according to a message sent from a network device (e.g. the MTC server 150, the MME 120) to indicate priority level modification. Thus, in a situation where the network is congested and a packet loss occurs, the MTC device 100 itself selects the message to be sent by taking the priority level of the message into consideration, as a result of which further congestion can be prevented.

Upon receiving the reverse event report message, the MTC device A 100A transitions from the high priority mode to the normal mode as shown in FIG. 7, according to the reverse event report message (step S205: mode switching). After this, the MTC device A 100A sends sensing data in the normal mode (step S210 in FIG. 3: obtained data sending). Note that the obtained data sending in step S210 in FIG. 3 is performed at an arbitrary timing after the mode switching in step S205. Though the MTC device A 100A sending the event report message first transitions from the high priority mode to the normal mode by receiving the reverse event report message in this example, the MTC device A 100A may transition to the normal mode by itself immediately after sending the event report message in the high priority mode, or the MTC device A 100A sending the event report message may continue to perform report in the high priority mode.

Upon receiving the reverse event report message, the MTC device B 100B transitions from the high priority mode to the normal mode as shown in FIG. 7 according to the reception of the reverse event report message, even in the case where the MTC device B 100B is an MTC device (e.g. other smoke sensor or flame sensor) that reports, upon event detection, the event detection to the MTC server 150 using a high priority event report message (e.g. PAM) (step S207 in FIG. 3: mode switching). After this, even when detecting an event (step S208 in FIG. 3: event detection), the MTC device B 100B does not send a high priority event report message (e.g. PAM) (step S207 in FIG. 3: mode switching), but sends sensing data in the normal mode (step S209 in FIG. 3: obtained data sending). In the case where the MTC device B 100B is an MTC device such as a human sensor that sends sensing data to the MTC server 150 in the normal mode during normal time, the sending mode is maintained at the normal mode. When detecting an event after the mode transition from the high priority mode to the normal mode in step S207, the MTC device B 100B may send an event report message with not high priority but normal priority and then send sensing data.

As described above, the MTC device 100 (e.g. smoke sensor, flame sensor) that, upon event detection, reports the event detection to the MTC server 150 using the high priority event report message transitions to the normal mode by reception of the reverse event report message. Such an MTC device 100 may, for example, transition from the normal mode back to the high priority mode after a predetermined time (e.g. a lifetime value is reported by the reverse event report message) or upon reception of a message (e.g. NAS message) from the MME 120 or the MTC server 150. This enables the MTC device 100 to return to the same operation as conventional, after one event ends (not shown in FIG. 3).

### Embodiment 2

According to the solution method of Embodiment 1, the object of the present invention of suppressing sending of a redundant event report message can be achieved, but there is an instance where sending of a necessary event report message of high priority is suppressed, too. For example, in the case where a smoke sensor detects smoke occurrence, all MTC devices 100 (e.g. flame sensor) transition to the normal mode according to the reverse event report message. As a result, even when the flame sensor detects flames after smoke occurrence, the flame sensor is unable to send a high priority event report message (e.g. PAM).

Besides, for example in an environment in which security of a complex of multiple apartments is monitored as mentioned earlier, normally (when there is no disaster) no emergency is required of a human sensor, and so the human sensor sends a detected event or obtained data to the MTC server 150 in the normal mode on a regular basis or at a predetermined timing. However, in an environment in which a smoke sensor detects smoke, there is a high possibility of fire occurrence, where information about human presence/absence increases in importance. This being so, information about human presence/absence detected by the human sensor needs to be reported not with normal priority (in the normal mode) but using a high priority event report message (e.g. PAM). Thus, there is a demand to enable an MTC device 100 (human sensor) that normally sends human presence/absence information in the normal mode, to report event detection (human presence/absence information) with a high priority event report message (e.g. PAM) according to an event detected by an MTC device 100 belonging to the same MTC group or a neighboring MTC device 100.

In an environment in which the smoke sensor detects smoke and there is a high possibility of fire occurrence, people are expected to run simultaneously to escape. Here, the human sensor may be configured to send a high priority event report message when, for example, a predetermined human walking speed and density are exceeded. Moreover, the MTC device 100 may be configured to send a high priority event report message when receiving a predetermined number of messages or more from neighboring MTC devices 100 in an environment in which communication between MTC devices 100 is possible (e.g. when transferring a predetermined number of packets or more within a predetermined time in en environment such as an ad hock network), according to the requirement of the operator of the communication system, the MTC server 150, the MTC user 160, or the like.

Note that whether the MTC device 100, upon event detection, sends only an event report message, sends only obtained data, or sends both an event report message and a message for sending obtained data is determined by the MTC device 100 itself, the operator of the communication system, the MTC server 150, the MTC user 160, or the like.

In the solution method in Embodiment 1 (method in which, after receiving a high priority event report message from an MTC device 100 detecting an event, the communication system entity or the MTC server 150 sends a message for suppressing a high priority event report message which is likely to be sent from a plurality of MTC devices 100 belonging to the target MTC group), all devices are simultaneously instructed to stop sending. Accordingly, in the above-mentioned cases, a necessary event report message (e.g. a PAM from a flame sensor or a human sensor after a smoke sensor sends a PAM) cannot be received. In view of this, an improvement on Embodiment 1 is described in Embodiment 2.

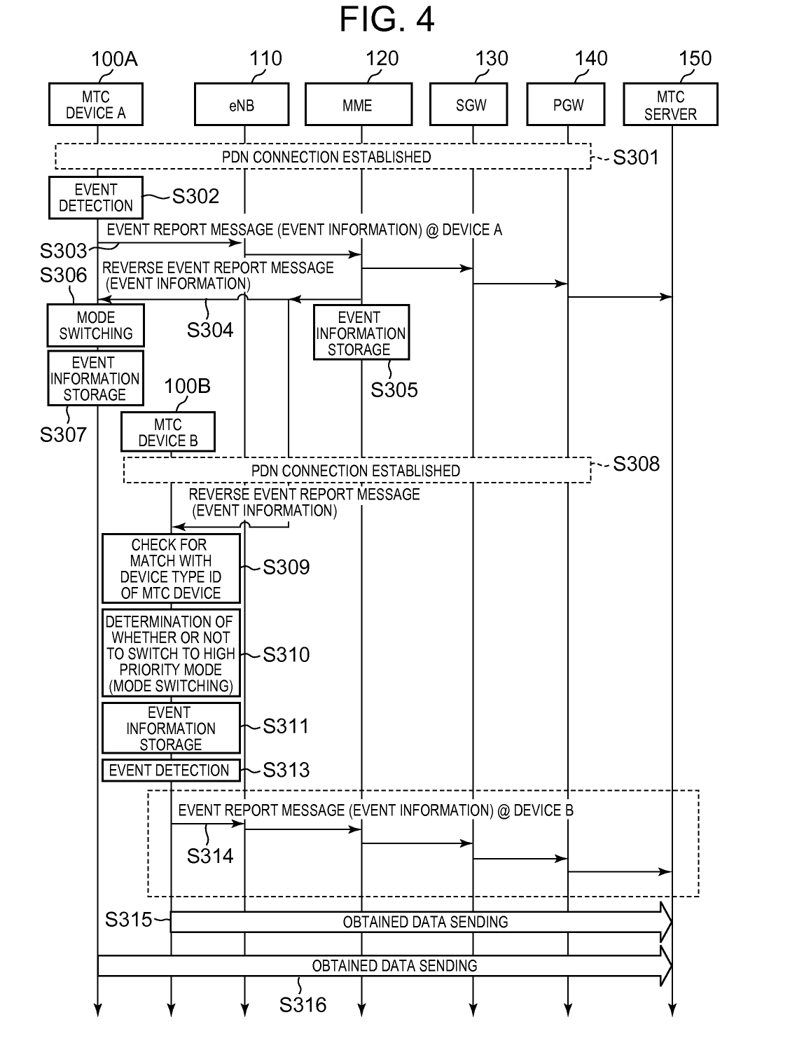

The following describes an example of a system operation in Embodiment 2 of the present invention in detail, with reference to FIG. 4. FIG. 4 is a sequence chart for describing an example (method of suppressing sending of a high priority event report message of the same event or an event caused by an incident that causes the former event, from a plurality of MTC devices 100) of the system operation in Embodiment 2 of the present invention. An example of a process sequence in the system structure shown in FIG. 1 is shown in FIG. 4.

It is assumed that the MTC device 100 has the following features, for ease of explanation of this embodiment.

The MTC device 100 has the “time controlled”, “PAM”, “group based”, and “low mobility” features defined in Non-patent Document 1. The MTC device 100 is managed as one MTC group together with other MTC devices 100. The MTC devices 100 in the MTC group include a smoke sensor, a flame sensor, and a human sensor. The smoke sensor determines that there is a high possibility of fire occurrence and sends a message with high priority (in the high priority mode), in the case of detecting an event (smoke). The flame sensor determines that there is a high possibility of fire occurrence and sends a message with high priority (in the high priority mode) like the smoke sensor, in the case of detecting an event (flame). On the other hand, the human sensor sends sensing data in the normal mode, in the case of detecting an event (human presence/absence).

FIG. 4 shows the MTC device A 100A and the MTC device B 100B, to distinguish the MTC devices 100 in the MTC group. Suppose the MTC device A 100A is an MTC device (smoke sensor) that detects an event first, and the MTC device B 100B is another MTC device (smoke sensor, flame sensor, human sensor) belonging to the same MTC group as the MTC device A 100A.

The sequence shown in FIG. 4 is described below. The MTC device A 100A (smoke sensor) establishes a PDN connection for communicating with the MTC server 150, with the PGW 140 based on a conventional method (e.g. attach procedure described in Non-patent Document 3) (step S301 in FIG. 4: PDN connection established). The MTC device B 100B also establishes a PDN connection with the PGW 140 based on the conventional method (e.g. attach procedure described in Non-patent Document 3) (step S308 in FIG. 4: PDN connection established).

For example, the MTC device A 100A detects an event (smoke) due to fire occurrence or the like (step S302 in FIG. 4: event detection). Upon detecting the event, to report the event detection to the MTC server 150, the MTC device A 100A generates an event report message containing detected event information (e.g. smoke occurrence flag, device type ID), and sends the event report message (event report message (event information) @ device A) to the MTC server 150 (step S303 in FIG. 4: event report message (event information) @ device A). It is estimated that there is a high possibility of fire occurrence in the case where the MTC device A 100A (smoke sensor) detects smoke, so that the MTC device A 100A reports to the MTC server 150 using a high priority message. Here, the MTC device A 100A may contain sensing data (smoke density) in the event report message.

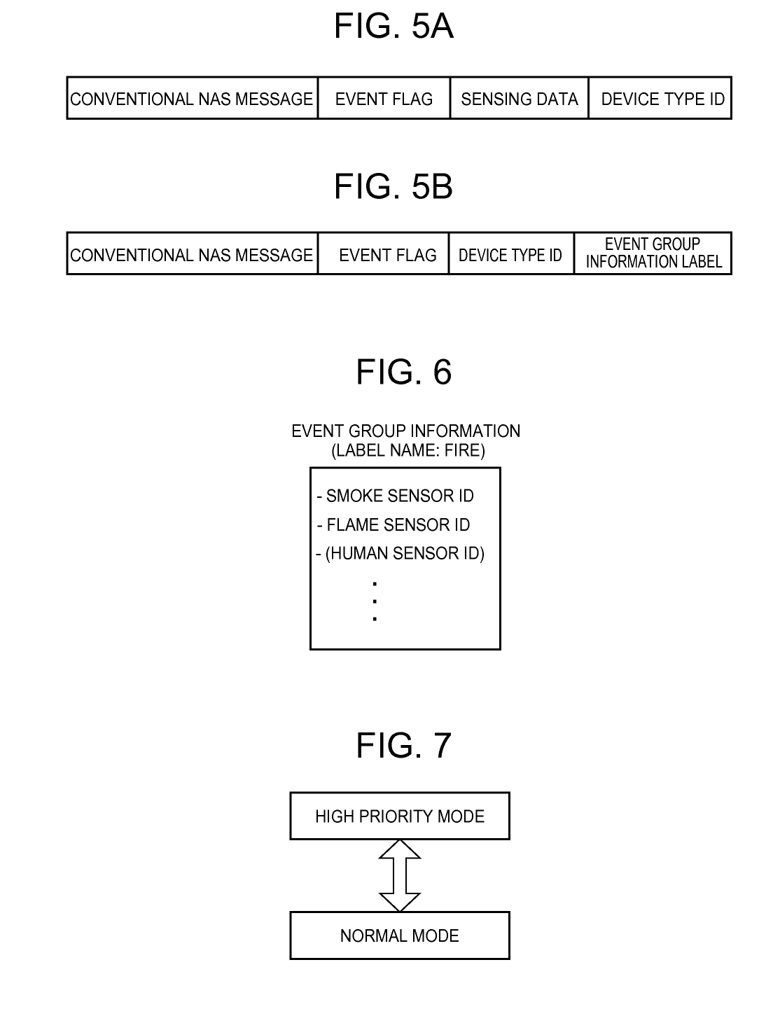

FIG. 5A is a diagram showing an example of a format of the event report message (event information) @ device A, as an example of the message sent from the MTC device A 100A to the MTC server 150 via the communication system in step S303 in FIG. 4.

For example, the MTC device A 100A adds at least an event flag field to a conventional NAS message field. The event flag field is a field for indicating that the MTC device A 100A detects an event (e.g. smoke occurrence flag in the case where the MTC device A 100A is a smoke sensor). The type of the detected event may be included, too. The MTC device A 100A may also add a sensing data field and a device type ID field. The sensing data field is a field for containing data (e.g. smoke density in the case where the MTC device A 100A is a smoke sensor) which the MTC device A 100A wants to send to the MTC server 150 early (i.e. with the event report) upon event detection. The device type ID field is a field for containing information for identifying the type of the MTC device A 100A detecting the event. For example, in the case where the MTC device A 100A is a smoke sensor, information for identifying the smoke sensor is contained (e.g. determination from a bit string indicating the device type in the NEI). The event flag field, the sensing data field, and the device type ID field added to the conventional NAS message may be embedded in the NAS message field. Alternatively, a message (e.g. message for MTC) other than the conventional NAS message may be used.

Though it is assumed in this embodiment that the event report message (event information) @ device A is sent on the C-plane, in the case of sending on the U-plane, an arbitrary field of a conventional message sent on the U-plane may be used. In the case where the MTC device A 100A or the MTC server 150/MTC user 160 can recognize that the MTC device 100 detects the event without using the information in the event flag field, for example, in the case where, when the MTC device 100 to which the “time controlled” feature is applied accesses the MME 120 outside an assigned time period, the MME 120 can determine that the MTC device 100 detects an event to be reported in the high priority mode, the event flag field may be omitted. In the case where there is no sensing data which the MTC device A 100A wants to send to the MTC server 150 early (i.e. with event report), the sensing data field may be omitted. In the case where the device type can be derived from the device ID contained in the conventional NAS message field, the device type ID field may be omitted. In the case where it can be determined, from the information contained in the device type ID field, that the MTC device A 100A detects the event (e.g. the containment of the device type ID indicating the smoke sensor simultaneously reports the smoke detection event), the event flag field may be omitted.

For example, the event report message (event information) @ device A which is the high priority message sent from the MTC device A 100A may use a message obtained by modifying a message used for establishing a PDN connection or an EPS bearer such as an attach request or a service request or an IKE_SA_INIT message or an IKE_AUTH request message employed in DS-MIPv6 bootstrapping based on IKEv2 defined in Non-patent Document 4, in the case of piggybacking (superimposing) on a PAM defined in Non-patent Document 1 or a location registration message such as a TAU (Tracking Area Update) request described in Non-patent Document 3 or in the case of detecting an event in a state in which a PDN connection or an EPS bearer is not established. Alternatively, a bearer modification request message may be used. This enables the event report from the MTC device 100 to be performed with little modification, without introducing a new message.

Upon receiving the event report message (event information @ device A, the communication system entity (e.g. the MME 120) extracts necessary information (e.g. event flag, sensing data, device type ID) from the received message, contains the extracted information in a conventional update bearer request message or the like, and transfers the event report message (event information) @ device A to the MTC server 150 via the SGW 130/PGW 140. At this time, the MME 120 extracts the event information (event flag/device type ID) from the event report message (event information) @ device A, contains the extracted event information in a reverse event report message (event information) (also referred to as reverse PAM, congestion avoidance message, time tolerant indication, congestion indication, congestion prior indication, PAM reduction indication, or the like), and sends the message to all MTC devices 100 in the MTC group to which the MTC device A 100A belongs (step S304 in FIG. 4: reverse event report message (event information)).

The reverse event report message may be sent with higher priority than other messages or with normal priority, according to determination (e.g. presetting by the operator of the communication system) by the sender (e.g. the MME 120) of the reverse event report message. In the case of sending the reverse event report message with higher priority than other messages, the high priority reverse event report message can be sent even when the sender of the message is in an overloaded state and abandons processing of normal priority messages. Instead of using the high priority reverse event report message, the reverse event report message may be sent with normal priority. In this case, there is no particular need to set the message priority.

Alternatively, the MME 120 may send the reverse event report message in the case of receiving a predetermined number of event report messages within a predetermined time or in the case of simply receiving a predetermined number of event report messages. By anticipating that the same event report message will increase in number and sending the reverse event report message to suppress such a message based on the anticipation, the suppression message (reverse event report message) can be effectively issued to achieve efficient use of communication resources and bandwidths, as compared with the case of determination from a single event report message (in the case of determination from a single event report message, the reverse event report message is sent each time the event report message is received, causing a waste of communication resources and bandwidths).

Here, the MME 120 may determine whether or not the MTC device A 100A belongs to any MTC group and, if the MTC device A 100A belongs to any MTC group, which MTC group the MTC device A 100A belongs to, by obtaining the subscription data corresponding to the MTC device A 100A from the HSS 125 and checking whether or not the group ID is registered. As an alternative, the MME 120 may perform the determination based on the group ID or the like contained in the event report message (event information) @ device A in step S303 (not shown in FIG. 5A). If the MME 120 can determine whether or not the MTC device A 100A belongs to any MTC group by referencing to the subscription data already held in the MME 120 or by a method (e.g. inquiring of an external server) other than obtaining the subscription data from the HSS 125, the MME 120 does not need to inquire of the HSS 125.

In this example, the reverse event report message is sent to all MTC devices (the MTC device A 100A and the MTC device B 100B) in the MTC group to which the MTC device A 100A detecting the event belongs. However, in the case where the “group based” feature is not applied, the reverse event report message may be sent to all MTC devices 100 under the eNB 110 to which the MTC device A 100A is connected. By doing so, the high priority event report message of the same event from each MTC device 100 located in a specific area can be suppressed. There is also an advantage that the group ID or the like need not be used, because the high priority event report message can be suppressed without taking the concept “MTC group” into consideration. In such a case, an eNB ID or an eNB address (as well as an S1-U TEID corresponding to the EPS bearer of the MTC device 100) may be used instead of the group ID. Moreover, if the MME 120 is able to recognize the message destination beforehand, the reverse event report message may be sent not by broadcasting but by multicasting or unicasting. By limiting the control range (report range) in this way, the impact on the whole system can be reduced.

When sending the reverse event report message (event information) to all MTC devices 100 in the MTC group, the MME 120 stores reverse event report message (event information) sending completion information indicating that the reverse event report message (event information) is sent, together with the group ID of the MTC group as the destination of the reverse event report message (event information) and the device type ID. The stored reverse event report message (event information) sending completion information is used as a parameter for determination of the MTC device 100 so that the same reverse event report message (event information) is not sent again when an event report message (event information) of the same event or an event caused by an incident that causes the former event is received from an MTC device 100 of the same device type in the same MTC group. When receiving the event report message (event information), it is desirable to send the reverse event report message (event information) again if the received message can be determined as an event report message (event information) from the same MTC device type in the same MTC group. In this case, the reverse event report message (event information) sending completion information does not necessarily need to be stored. Here, the MME 120 can identify the type of the MTC device 100 as mentioned earlier (for example, the type of the MTC device 100 can be identified from the device ID of the MTC device (e.g. the type of the MTC device 100 can be derived from a bit string (e.g. higher order bits or lower order bits) which is a part of the device ID indicating the device type, or the device type ID can be obtained by reporting the device ID to an external server), or the device type ID is contained in the event report message (event information) @ device A as shown in FIG. 5A).

In the case where the MTC device 100 holds a plurality of pieces of event group information, the MME 120 sends the reverse event report message (event information) containing an event group information label (information associated with event group information to indicate which of the plurality of pieces of event group information is used). Examples of a method whereby the MME 120 determines which event group information is used include the use of information (e.g. information having a pair of event information and event group information) registered in the subscription data, and the determination based on preset MTC service specifications, registration information, or configuration information by the MTC server 150/MTC user 160. The above-mentioned determination (which event group information is used) by the MME 120 may be performed after the MTC device 100 reports, by the event report message (event information), that the plurality of pieces of event group information are held.

The reverse event report message (event information) is described below, with reference to FIG. 5B. FIG. 5B is a diagram showing an example of a format of the reverse event report message (event information), as an example of the message broadcast from the MME 120 to all MTC devices 100 (including the MTC device B 100B) in the MTC group to which the MTC device A 100A belongs in step S304 in FIG. 4.

The MME 120 sends a message in which an event flag field, a device type ID field, and an event group information label field are added to a conventional NAS response message field. The event flag field is a field for indicating that the MTC device 100 detects an event. The event flag field is also used as a field for identifying the message as a reverse event report message. The device type ID field is a field for containing information (e.g. smoke sensor) of the type of the MTC device 100 detecting the event. For example, information for identifying the type of the MTC device 100 as the sender of the event report message which triggers the reverse event report message to be sent is contained in the device type ID field. The information contained in the device type ID field needs to be associated with information registered in the event group information (see FIG. 6) described later. If the association with the information registered in the event group information can be clearly specified, information (e.g. event ID) other than the device type ID may be used. The event group information label field is a field used, for example, when the MTC device 100 holds a plurality of pieces of event group information. An event group information label (e.g. fire, earthquake, robbery, building collapse, landslide, etc.) is contained in the event group information label field by the MME 120 so that the MTC device 100 determines which event group information is used.

Though it is assumed in this embodiment that the reverse event report message (event information) is sent on the C-plane, in the case of sending on the U-plane, an arbitrary field of a conventional message sent on the U-plane may be used. In the case where the MTC device 100 can recognize that an MTC device 100 in the same MTC group or in the neighborhood detects an event without using the information in the event flag field in the reverse event report message (event information) sent from the MME 120 (e.g. recognizable from message reception outside a time period assigned in the “time controlled” feature), the event flag field may be omitted. In the case where the MME 120 already recognizes that the MTC device 100 holds only one piece of event group information or the MME 120 does not perform detailed mode transition management using event group information, there is no need to identify event group information, and so the event group information label field may be omitted. As an example, by containing only the device type ID in the reverse event report message sent from the network device (e.g. the MME 120) without containing the event group information label, it is possible to suppress only an event report message from the same type of MTC device 100 as the MTC device 100 sending the event report message first.

The event flag field, the device type ID field, and the event group information label field added to the conventional NAS message may be embedded in the NAS response message field.

As the reverse event report message (event information) sent from the MME 120, for example, a paging message or a bearer modification request message described in Non-patent Document 3 or 5, a PAM defined in Non-patent Document 1, a TAU accept message described in Non-patent Document 3, or an IKE_SA_INIT message or an IKE_AUTH response message employed in DS-MIPv6 bootstrapping based on IKEv2 defined in Non-patent Document 4 may be extended and put to use.

The entity that references to the event information contained in the event report message (event information) @ device A and broadcasts the reverse event report message (event information) containing the referenced event information may be the PGW 140 or the MTC server 150, instead of the MME 120. The device type ID contained in the event report message (event information) @ device A and the device type ID contained in the reverse event report message (event information) do not necessarily need to match, so long as their association is ensured. In this case, however, the association between the information contained in the reverse event report message (event information) and the information (e.g. device type ID) registered in the event group information needs to be ensured. If the device type ID contained in the reverse event report message (event information) can be recognized based on not the device type ID but information, such as the IP address or the device ID, for identifying the MTC device 100 included in the conventional NAS message or the event information, the device type ID contained in the event report message (event information) @ device A does not need to be used.

The MTC device 100 (corresponding to the MTC device B 100B in FIG. 4) in the MTC group receiving the reverse event report message (event information) extracts the device type ID contained in the reverse event report message (event information), and checks whether or not the device type ID matches the device ID/device type ID of the MTC device B 100B (step S309 in FIG. 4: check for match with device type ID of MTC device). In the case where the device type ID extracted from the reverse event report message (event information) and the device ID/device type ID of the MTC device B 100B match as a result of the check, the MTC device 100 transitions to the normal mode (maintains the normal mode when currently operating in the normal mode). The device type ID extracted from the reverse event report message (event information) indicates the type of the MTC device 100 (the MTC device A 100A in this example) which is the sender of the event report message (event) that triggers the reverse event report message to be sent. That is, the MTC device B 100B determines whether or not an event report message is sent from the same type of MTC device 100 as the MTC device B 100B and, in the case of determining that an event report message has been already sent from the same type of MTC device 100 as the MTC device B 100B, operates in the normal mode so as not to send an event report message in the high priority mode.

The MTC device B 100B determines whether or not to switch to the high priority mode based on the device type ID included in the received reverse event report message (event information) and, in the case of determining that the MTC device B 100B needs to switch to the high priority mode, the MTC device B 100B switches to the high priority mode (or maintains the high priority mode when currently operating in the high priority mode) (step S310 in FIG. 4: determination of whether or not to switch to high priority mode (mode switching)). The determination of whether or not to switch to the high priority mode is made, for example, based on whether or not the device type ID extracted from the reverse event report message (event information) is included in event group information (FIG. 6) held by the MTC device B 100B. In the case where the MTC device B 100B holds a plurality of pieces of event group information, the MTC device B 100B extracts the event group information label from the reverse event report message (event information), and performs the determination using event group information corresponding to the extracted event group label information.

FIG. 6 is a diagram showing an example of event group information used by the MTC device 100 to determine whether or not to switch the mode based on the device type ID/event group information label included in the received reverse event report message (event information). A plurality of device type IDs (which need not match device type IDs if their correspondence relations are clear) are registered in the event group information, where the device type IDs are set statically or dynamically. Upon receiving the reverse event report message (event information), the MTC device B 100B checks whether or not the device type ID extracted from the reverse event report message (event information) is registered in the event group information.

FIG. 6 shows an example of the event group information held by the MTC device B 100B (human sensor). A smoke sensor ID and a flame sensor ID are included in the event group information in FIG. 6. When receiving the reverse event report message (event information) including the smoke sensor ID or the flame sensor ID, the MTC device B 100B (human sensor) holding this event group information switches to the high priority mode (or maintains the high priority mode) to operate in the high priority mode. That is, information indicating to transition to or maintain the high priority mode when a specific reverse event report message (event information) is received is registered in the event group information.

Which device type ID is registered in the event group information is preferably set based on, for example, a suitable operation upon event occurrence. As an example, suppose the following operation is an optimum operation: even in the case where the smoke sensor sends the high priority event report message (event information) to the network side upon fire occurrence and the reverse event report message (event information) is broadcast to the MTC group, the flame sensor continues to operate in the high priority mode to detect flames and the human sensor transitions to the high priority mode to promptly check whether or not there is nobody left. Such an optimum operation can be realized by, for example, registering the smoke sensor ID and the human sensor ID in the event group information held by the flame sensor, registering the flame sensor ID and the human sensor ID in the event group information held by the smoke sensor, and registering the smoke sensor ID and the flame sensor ID in the event group information held by the human sensor. The device type ID registered in the event group information and the operation of each MTC device 100 will be described in detail later.

Various methods can be employed for the determination in steps S309 and S310, depending on how the event group information is held by each MTC device 100 (whether separate event group information is held by each MTC device 100 or the same event group information is held by a plurality of MTC devices 100), how the information included in the event group information is configured (e.g. whether or not the device type ID of the MTC device 100 having the event group information is included in the event group information), and the like. However, the basic concept of the present invention does not limit the method of determination in steps S309 and S310. It is important in the present invention that the MTC device 100 receiving the reverse event report message can determine whether or not the event report message has been already sent from the same type of device as the MTC device 100, and determine whether or not to transition to the high priority mode (or maintain the current mode) in the case where the event report message is sent from a different type of device from the MTC device 100.

As mentioned above, the event group information held by the MTC device B 100B (human sensor) is shown in FIG. 6. The ID of the human sensor itself (human sensor ID) may be included in this event group information. In the determination in steps S309 and S310 described as an example here, the MTC device B 100B (human sensor) does not check whether or not the device type ID of the MTC device B 100B (human sensor ID) is included in the event group information held by the MTC device B 100B. However, it is also possible to generate common event group information by registering, as the event group information, a list of device type IDs of MTC devices 100 that operate in the high priority mode exceptionally even when receiving the reverse event report message (event information). In detail, to operate the smoke sensor, the flame sensor, and the human sensor in the high priority mode upon fire occurrence, the event group information whose event group label information is “fire” and in which the smoke sensor, the flame sensor, and the human sensor are registered may be commonly held by the smoke sensor, the flame sensor, and the human sensor. By executing the determination in steps S309 and S310 in a manner different from the above-mentioned operation, it is possible to provide a method for achieving detailed mode transition management according to the present invention even in the case where all MTC devices 100 hold common event group information.

When receiving the reverse event report message (event information), the MTC device 100 in the MTC group stores the device type ID (e.g. smoke sensor) contained in the reverse event report message (event information) (step S311 in FIG. 4: event information storage). The stored event information is used as a parameter for determining, when the MTC device 100 receives another reverse event report message (event information (e.g. human sensor ID)) from the MME 120 again, not to send a high priority event report message (i.e. not to switch to the high priority mode). For example, after the MTC device A 100A (smoke sensor) detects an event and sends a high priority event report message (event information), each MTC device 100 belonging to the same MTC group as the MTC device A 100A receives a reverse event report message (event information) having the device type ID “smoke sensor”. The MTC device B 100B (smoke sensor) of the same device type as the MTC device A 100A transitions from the high priority mode to the normal mode, and stores information indicating the reception of the reverse event report message (event information) having the device type ID “smoke sensor”. Subsequently, when the MTC device B 100B (human sensor) in the same MTC group detects an event and sends a high priority message (event information), each MTC device 100 in the MTC group receives a reverse event report message (event information) having the device type ID “human sensor”, following the reverse event report message (event information) having the device type ID “smoke sensor”. Since the MTC device A 100A stores the previously received reverse event report message (event information) having the device type ID “smoke sensor”, the MTC device A 100A uses this stored information (reception history) as a parameter, and operates not to transition from the normal mode to the high priority mode and send a high priority event report message (event information) again. Thus, the MTC device 100 that has once transitioned from the high priority mode to the normal mode when the same event (e.g. fire) occurs can be controlled not to return to the high priority mode again. Note that this parameter for determining mode switching may be information other than the device type ID indicating the type of the MTC device 100.

The device type ID determination step of step S309 to the event information storage step of step S311 may be performed in any order.

After this, the MTC device B 100B (e.g. human sensor) detects an event (e.g. human presence) (step S313 in FIG. 4: event detection). Upon detecting the event, the MTC device B 100B checks the mode for sending data upon event detection, and reports to the MTC server 150 in the sending mode. In the case where the MTC device B 100B is in the high priority mode and sends a high priority message, the MTC device B 100B sends an event report message containing the detected event information and the like, to the MTC server 150 (step S314 in FIG. 4: event report message (event information) @ device B). In the case where the MTC device B 100B sends data not in the high priority mode but in the normal mode, on the other hand, the MTC device B 100B sends the event report message (event sending) (the dotted region) in step S314 in the normal mode or does not send the event report message, and sends sensing data to the MTC server 150 (step S315 in FIG. 4: obtained data sending). The event report message sending in step S314 and the obtained data sending in step S315 may be performed sequentially or simultaneously.

The MTC device A 100A sending the event report message (event information) first also receives the reverse event report message (event information), transitions from the high priority mode to the normal mode as shown in FIG. 7 according to the reverse event report message (event information) (step S306 in FIG. 4: mode switching), and stores information indicating the reception of the reverse event report message (event information) (step S307 in FIG. 4: event information storage). The MTC device A 100A subsequently sends sensing data in the normal mode (step S316 in FIG. 4: obtained data sending). The obtained data sending in step S316 in FIG. 4 may be performed at an arbitrary timing after the sending of the event report message (event information) @ device A in step S303. Though the MTC device A 100A sending the event report message first transitions from the high priority mode to the normal mode by reception of the reverse event report message (event information) in this example, the MTC device A 100A may spontaneously transition to the normal mode immediately after sending the event report message (event information) in the high priority mode, or the MTC device A 100A sending the event report message (event information) may continue to perform report in the high priority mode.

For example, the MTC device 100 (e.g. flame sensor) that sends the high priority event report message to the MTC server 150 upon event detection may transition from the normal mode back to the high priority mode after a predetermined time (e.g. a lifetime value is reported by the reverse event report message) or upon reception of a message (e.g. NAS message) from the MME 120 or the MTC server 150. In the same manner, the MTC device 100 (e.g. human sensor) that once transitions to the high priority mode and then returns to the normal mode and operates in the normal mode may return to the original state (state of being able to transition from the normal mode to the high priority mode when receiving the reverse event report message). This enables the MTC device 100 to return to the same operation as usual, after one event ends (not shown in FIG. 3).

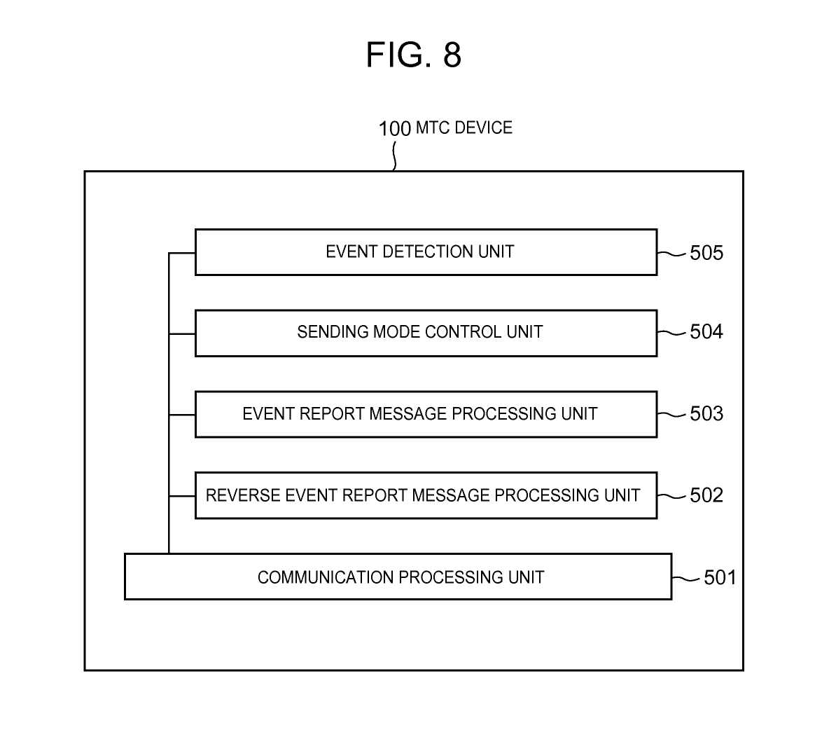

The following describes a structure of the MTC device 100 in Embodiment 2 of the present invention, with reference to FIG. 8. FIG. 8 is a diagram showing an example of the structure of the MTC device 100 in Embodiment 2 of the present invention.

In FIG. 8, the MTC device 100 at least includes: a communication processing unit 501 that is connected to the communication system (e.g. E-UTRAN or UTRAN) and performs communication processing in a lower layer and packet communication processing of IP or the like in a higher layer; a reverse event report message processing unit 502 that determines whether or not a received message is a reverse event report message, stores event information contained in the received reverse event report message, checks whether or not a device type ID contained in the reverse event report message matches a device type ID of the MTC device 100, and further checks whether or not the device type ID contained in the reverse event report message is registered in held event group information; a sending mode control unit 504 that checks a current sending mode of the MTC device 100 when receiving the reverse event report message, holds information used for checking the sending mode, and switches the sending mode of the MTC device 100; an event detection unit 505 that detects a specific event (event monitored by the MTC device 100); and an event report message processing unit 503 that determines whether or not to send a high priority message upon event detection. For example, in the case where the event report message processing unit 503 has the function of the sending mode control unit 504, the sending mode control unit 504 may be omitted. Likewise, in the case where one functional unit includes at least one other functional unit mentioned above, the other functional unit may be omitted. Conversely, for example, the function of storing the event information contained in the received reverse event report message and the function of determining whether or not to send the high priority message upon event detection, which are the functions of the event report message processing unit 503, may be separated from each other.

The above-mentioned components of the MTC device 100 operate to realize: a function as an operation mode control unit configured to perform control to operate in a sending mode that is either a normal mode or a high priority mode, where sensing data detected by a sensor for detecting an occurrence of a specific event is sent in the normal mode with a normal priority, and an event report message reporting that the occurrence of the specific event is detected by the sensor is sent in the normal mode or in the high priority mode with a priority higher than the priority in the normal mode; a function as a sending unit configured to send, to a network node, the event report message in the high priority mode or the sensing data in the normal mode; a function as a message receiving unit configured to receive a message sent from the network node that receives an event report message reporting detection of an occurrence of a specific event from an arbitrary communication node, the message being sent from the network node as a response to the event report message from the arbitrary communication node and instructing to have the sending mode transition to the normal mode or maintained at the normal mode; a function as a mode transition determination unit configured to determine whether or not to have the sending mode transition to the normal mode or maintained at the normal mode, in the case where the message is received, and the like.

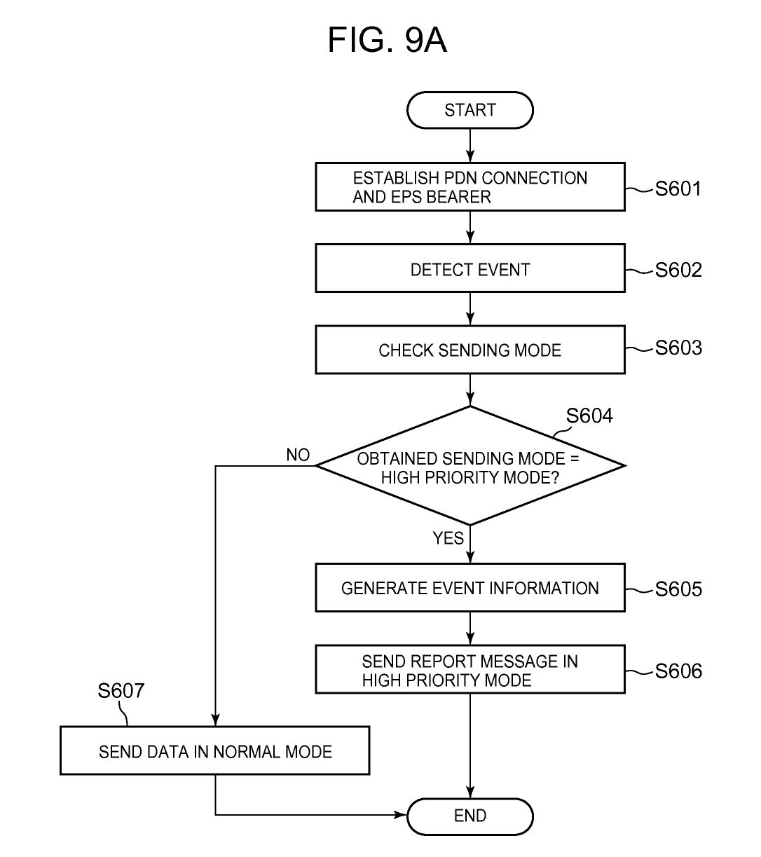

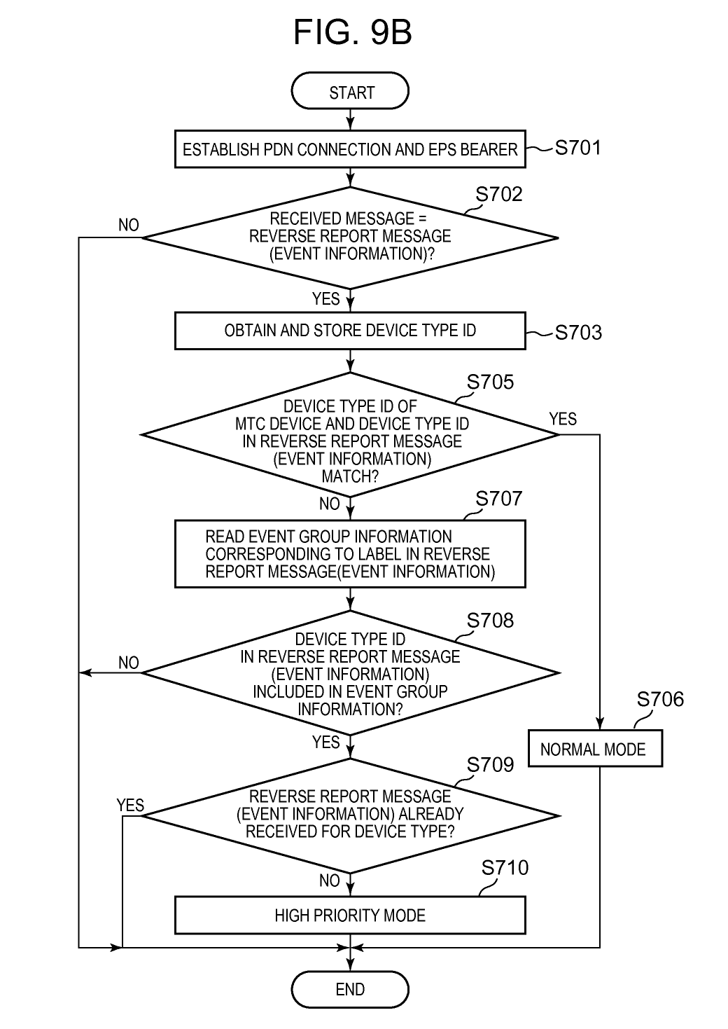

The MTC device 100 having the structure shown in FIG. 8 is described in detail below while mainly focusing on characteristic processing in the present invention, with reference to FIGS. 9A and 9B. FIG. 9A is a flowchart showing an example of a process flow of the MTC device 100 that performs a process of sending to the MTC server 150 in the normal mode or the high priority mode upon event detection in Embodiment 2 of the present invention. FIG. 9B is a flowchart showing an example of a process flow of the MTC device 100 that receives a reverse event report message from the network side (e.g. the MME 120) in Embodiment 2 of the present invention.

The process flow in the case where the MTC device 100 sends to the MTC server 150 in the normal mode or the high priority mode upon event detection is described first, with reference to FIG. 9A.

The MTC device 100 establishes a PDN connection and an EPS bearer with the PGW 140, to communicate with the MTC server 150 (step S601 in FIG. 9A).

Here, the MTC device 100 detects an event in the event detection unit 505 (step S602 in FIG. 9A). The event detection is, for example, smoke detection in the case of a smoke sensor, flame detection in the case of a flame sensor, human detection in the case of a human sensor, or the like. After the event detection, the MTC device 100 obtains information about the sending mode (step S603 in FIG. 9A), and determines in the event report message determination unit 503 whether or not to send a high priority message to the MTC server 150 (step S604 in FIG. 9A).

In the case where the sending mode is the high priority mode and the MTC device 100 determines to report to the MTC server 150 with a high priority event report message, the MTC device 100 generates, for example, an event flag (e.g. smoke occurrence), sensing data, and a device type ID in the communication processing unit 501 (step S605 in FIG. 9A), and sends an event report message (event information) @ device A containing the generated event information to the MTC server 150 via the communication system (step S606 in FIG. 9A).

As mentioned earlier, for example in the case where, when the MTC device 100 to which the “time controlled” feature is applied accesses outside an assigned time period, the network side (e.g. the MME 120) can determine that the MTC device 100 detects an event to be reported in the high priority mode, the MTC device 100 does not need to contain the event flag in the event report message (event information) @ device A. If the network side can recognize that the MTC device 100 detects the event by using means other than the above, the event flag may equally be omitted. Likewise, for example if the network side can identify the type of the MTC device 100 by deriving the type of the MTC device 100 from a bit string (e.g. higher order bits or lower order bits) which is a part of the device ID indicating the device type, the MTC device 100 does not need to contain the device type ID in the event report message (event information) @ device A.

In the case where the sending mode is the normal mode and the MTC device 100 determines to send the detected event (e.g. smoke occurrence) and sensing data to the MTC server 150 with normal priority, on the other hand, the MTC device 100 sends the event report message (event information) @ device A and the obtained sensing data from the communication processing unit 501 as usual (step S607 in FIG. 9A).

Note that the MTC device 100 may return from the high priority mode to the normal mode or from the normal mode to the high priority mode after a predetermined time (e.g. a lifetime value reported by a reverse event report message) or upon reception of a message (e.g. NAS message) from the MME 120 or the MTC server 150, as mentioned above (not shown in FIG. 9A).

The process flow in the case where the MTC device 100 receives a reverse event report message from the network side (e.g. the MME 120) is described next, with reference to FIG. 9B.

The MTC device 100 establishes a PDN connection and an EPS bearer with the PGW 140, to communicate with the MTC server 150 (step S701 in FIG. 9B).

When receiving a message from the communication system, the MTC device 100 determines in the reverse event report message processing unit 502 whether or not the received message is a reverse event report message (event information) (step S702 in FIG. 9B). In the case of determining that the received message is not a reverse event report message (event information), the MTC device 100 performs another process suitable for the message (not shown in FIG. 9B).

In the case of determining that the received message is a reverse event report message (event information), the MTC device 100 extracts a device type ID from the reverse event report message (event information), and stores the extracted device type ID in the reverse event report message processing unit 502 in order to specify the case where a reverse event report message (event information) containing the same device type ID is received again (step S703 in FIG. 9B).

Following this, the MTC device 100 checks in the reverse event report message processing unit 502 whether or not the device ID/device type ID of the MTC device 100 and the device type ID contained in the reverse event report message (event information) match (step S705 in FIG. 9B). In the case where the device ID/device type ID of the MTC device 100 and the device type ID contained in the reverse event report message (event information) match, it can be determined that an event report message has been already sent from an MTC device 100 of the same type as the MTC device 100. The MTC device 100 accordingly operates in the normal mode (step S706 in FIG. 9B). In step S706, the MTC device 100 transitions to the normal mode when the MTC device 100 is currently in the high priority mode, and maintains the normal mode when the MTC device 100 is currently in the normal mode.

In the case where the device ID/device type ID of the MTC device 100 and the device type ID contained in the reverse event report message (event information) do not match, on the other hand, the MTC device 100 reads, in the reverse event report message processing unit 502, event group information corresponding to an event group information label contained in the reverse event report message (event information) (step S707 in FIG. 9B), and checks whether or not the device type ID extracted from the reverse event report message (event information) is registered in the event group information (step S708 in FIG. 9B). In the case where the device type ID extracted from the reverse event report message (event information) is not registered in the event group information, it can be determined that the received reverse event report message is a reverse event report message (event information) of an event unrelated to the MTC device 100. The MTC device 100 accordingly ends the process. Here, instead of the event group information in which a device type ID list is registered, information indicating whether or not the device type of the MTC device 100 is associated with the label may be held in the MTC device 100. In such a case, the MTC device 100 only needs to check whether or not the device type of the MTC device 100 and the label name (e.g. “fire”) are associated with each other in step S708.

In the case where the device type ID extracted from the reverse event report message (event information) is registered in the event group information, on the other hand, it can be determined that the received reverse event report message (event information) is a reverse event report message (event information) of an event related to the MTC device 100. The MTC device 100 accordingly checks the device type ID stored in the reverse event report message processing unit 502, to determine whether or not a reverse event report message (event information) corresponding to an event report message (event information) sent from the same type of MTC device 100 has been already received (step S709 in FIG. 9B). In the case where a reverse event report message (event information) corresponding to an event report message (event information) sent from the same type of MTC device 100 has been already received, the MTC device 100 ends the process. In the case where a reverse event report message (event information) corresponding to an event report message (event information) sent from the same type of MTC device 100 is received first, on the other hand, the MTC device 100 operates in the high priority mode (step S710 in FIG. 9B). In step S710, the MTC device 100 maintains the high priority mode when the MTC device 100 is currently in the high priority mode, and transitions to the high priority mode when the MTC device 100 is currently in the normal mode, in the sending mode control unit 504. The sending mode determined in this way is referenced to in the sending mode check process shown in FIG. 9A (step S603 in FIG. 9A).

The timing of checking whether or not the device type ID in the reverse event report message (event information) matches the device type ID of the MTC device 100 in step S705, the timing of checking whether or not the device type ID extracted from the reverse event report message (event information) is registered in the event group information in step S708, and the timing of checking whether or not a reverse event report message (event information) from the same device type has been already received may be in different order.

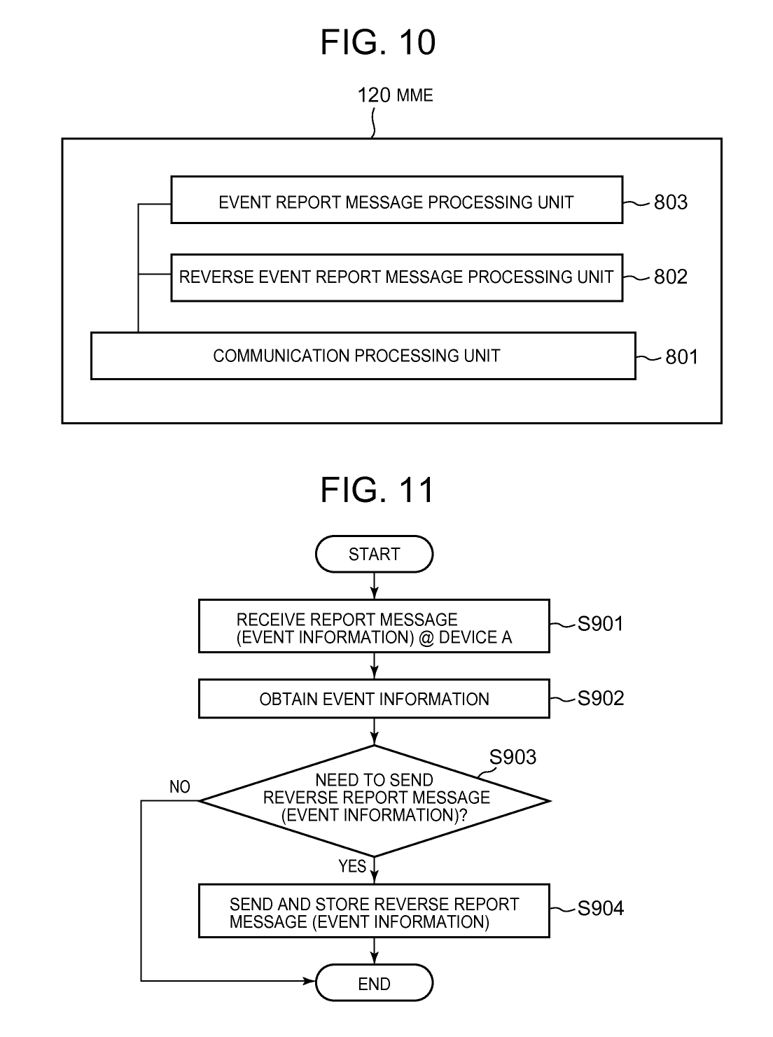

The following describes a structure of the MME in Embodiment 2 of the present invention, with reference to FIG. 10. FIG. 10 is a diagram showing an example of the structure of the MME 120 in Embodiment 2 of the present invention.

In FIG. 10, the MME 120 at least includes: a communication processing unit 801 that performs communication processing on the communication system (e.g. E-UTRAN, UTRAN) and performs packet communication processing of IP or the like; an event report message processing unit 803 that determines whether or not a received message is an event report message sent with high priority, obtains event information, and stores the obtained event information; and a reverse event report message processing unit 802 that determines whether or not to broadcast a reverse event report message containing the event information obtained from the event report message in order to suppress reception of a redundant event report message of the same event or an event caused by the former event. For example, in the case where the reverse event report message processing unit 802 has the function of the event report message processing unit 803, the event report message processing unit 803 may be omitted. Likewise, in the case where one functional unit includes at least one other functional unit mentioned above, the other functional unit may be omitted.

The above-mentioned components of the MME 120 operate to realize: a function as a receiving unit configured to receive the event report message reporting the detection of the occurrence of the specific event, from the MTC device 100; a function as a message generation unit configured to generate a message instructing to have the sending mode transition to the normal mode or maintained at the normal mode, as a response to the event report message; and a function as a message sending unit configured to send the message to the MTC device 100.

The MME 120 having the structure shown in FIG. 10 is described in detail below while mainly focusing on characteristic processing in the present invention, with reference to FIG. 11. FIG. 11 is a flowchart showing an example of a process flow of the MME 120 in Embodiment 2 of the present invention.

Suppose the MME 120 receives a message sent from the MTC device A 100A, and determines in the event report message processing unit 803 that the received message is an event report message (event information) @ device A of high priority (step S901 in FIG. 11). When determining whether or not the received message is the event report message (event information) @ device A, the MME 120 may reference to an event flag field of the event report message (event information) @ device A.

The MME 120 then obtains event information from the received event report message (event information) @ device A in the event report message processing unit 803 (step S902 in FIG. 11). The MME 120 determines in the reverse event report message processing unit 802 whether or not to send a reverse event report message (event information) to each MTC device 100 in the MTC group, in order to suppress sending of a redundant event report message of the same event or an event caused by an incident that causes the former event (step S903 in FIG. 11). When determining whether or not to send the reverse event report message (event information) (or which label is to be added to the reverse event report message to request an operation in the high priority mode), the MME 120 may use event group information held in the reverse event report message processing unit 802, or inquire of the HLR/HSS 125 about information (e.g. subscription data) of the MTC device 100.

In the case of determining to send the reverse event report message (event information), for example the MME 120 broadcasts the reverse event report message (event information) containing the device type ID obtained from the event report message (event information) @ device A, to all MTC devices (including the MTC device B 100B) in the MTC group to which the MTC device A 100A belongs (step S904 in FIG. 11). To determine whether or not the MTC device A 100A belongs to the MTC group, the MME 120 may use the group ID (not shown in FIG. 5A) contained in the event report message (event information) @ device A or the subscription data held by the HSS 125. Moreover, when sending the reverse event report message (event information), the MME 120 desirably stores, for example in the reverse event report message processing unit 802, the device type ID extracted from the event report message (event information) @ device A, in order to use it as a parameter for determining whether or not to send the reverse event report message (event information) when receiving the event report message (event information) @ device A again. Though the device type ID extracted from the event report message (event information) @ device A may be information other than the ID for identifying the type of the MTC device 100, it needs to be associated with the information registered in the event group information held by each MTC device 100, as mentioned earlier.

In the case of adding the event group information label to the reverse event report message (event information), the MME 120 may add a specific label name set beforehand (e.g. “fire”) for an event report message from a specific device (e.g. smoke sensor or flame sensor). The MME 120 may also determine an event group information label name to be added, from event information included in an event report message, sensing data, or other information. Moreover, in the case where the MME 120 sends a reverse event report message to which an event group information label (e.g. “fire”) is added according to an event report message (event information) received from an MTC device 100 (e.g. smoke sensor), the MME 120 may, upon receiving an event report message from an MTC device 100 (e.g. flame sensor) of another device type associated by event group information or the like within a predetermined time, add the same label name (e.g. “fire”) to a corresponding reverse event report message (event information).

After a predetermined time or based on specifications, registration information, configuration information, or the like set beforehand by the MTC server 150/MTC user 160, the MME 120 may send a message (e.g. NAS message to return the sending mode of the MTC device 100 to the ordinary state (from the high priority mode to the normal mode or from the normal mode to the high priority mode)) for releasing information held by the MTC device 100 or the MME 120 (not shown in FIG. 11).

Though the above describes the case where the MME 120 sends the reverse event report message (event information), the MTC server 150 may send the reverse event report message (event information). A structure of the MTC server 150 in the case where the MTC server 150 sends the reverse event report message (event information) in Embodiment 2 of the present invention is the same as the structure of the MME 120 shown in FIG. 10, and so its description is omitted here.

Likewise, a process flow of the MTC server 150 in Embodiment 2 of the present invention is the same as the process flow of the MME 120 shown in FIG. 10 (i.e. process flow shown in FIG. 11), and so its description is omitted here.

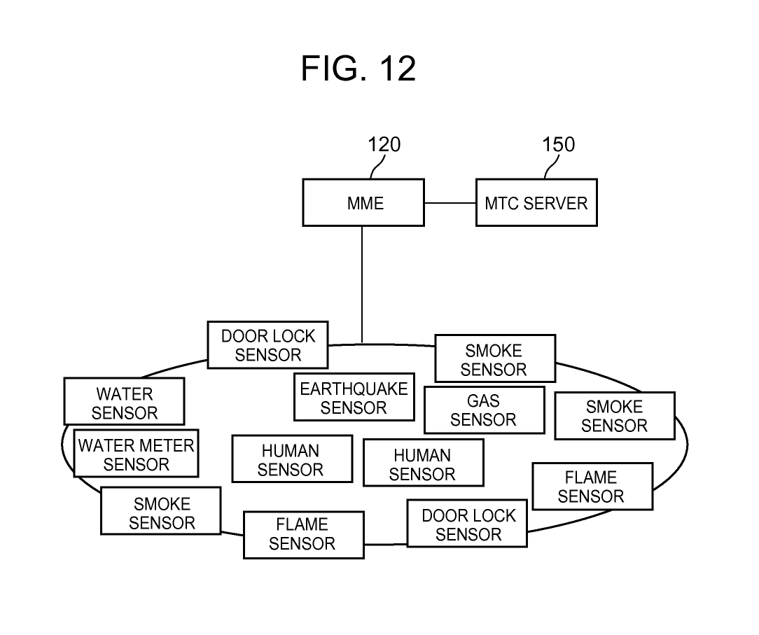

The following describes the operation of each MTC device 100 and the event group information in Embodiments 1 and 2 of the present invention described above using a specific example, with reference to FIGS. 12 to 14.

FIG. 12 is a diagram showing an example of arrangement of each MTC device 100 for describing a specific example in Embodiments 1 and 2 of the present invention. FIG. 12 schematically shows a state in which many different MTC devices 100 (e.g. smoke sensor, flame sensor, human sensor, gas sensor, water sensor, water meter sensor, earthquake sensor, door lock sensor, etc.) are arranged in an MTC group. As shown in FIG. 12, for example by placing many MTC devices 100 in one facility, an event (e.g. accident or disaster) that can occur in the facility is monitored. The following describes the operation according to the present invention in detail, by focusing on two smoke sensors, two flame sensors, two human sensors, one door lock sensor, and one water sensor from among many MTC devices 100 in the same MTC group.

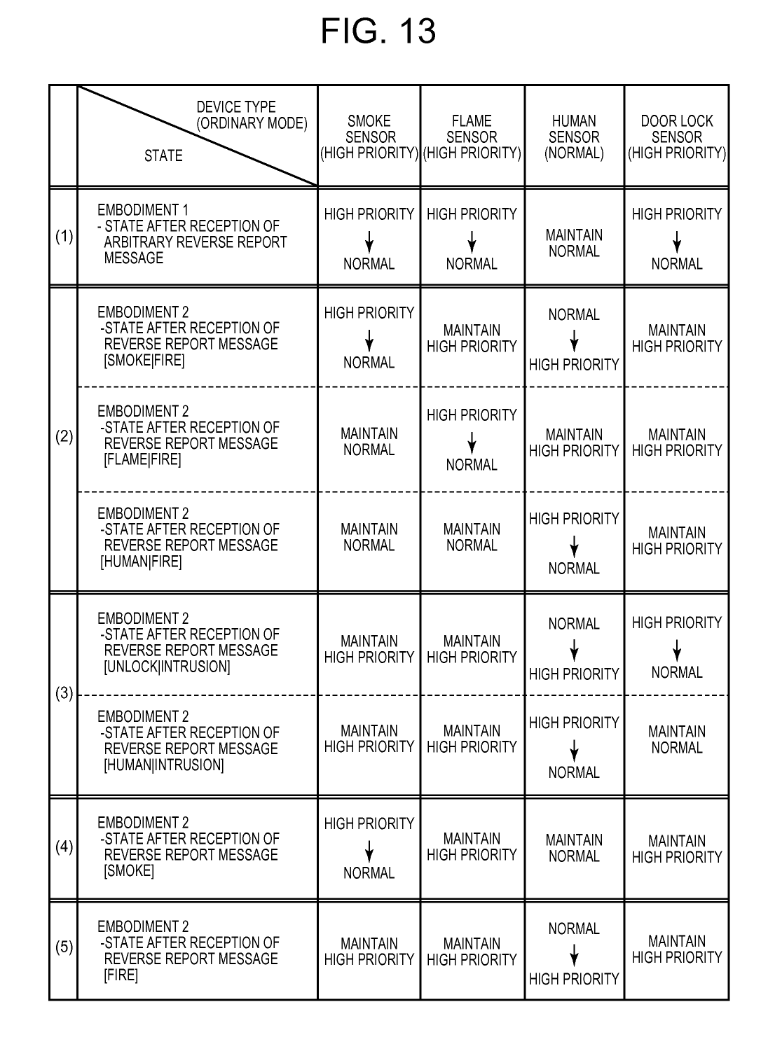

A smoke sensor is configured to ordinarily operate in the high priority mode, and send a high priority event report message upon detecting smoke occurrence. A flame sensor is configured to ordinarily operate in the high priority mode, and send a high priority event report message upon detecting flame occurrence (heat detection). A human sensor is configured to ordinarily operate in the normal mode, and send human presence/absence information as sensing data in the normal mode. A door lock sensor is configured to ordinarily operate in the high priority mode, and send a high priority event report message upon detecting unlocking of a locked door. A water meter sensor is configured to ordinarily operate in the normal mode, and send a water meter value (meter reading value) as sensing data in the normal mode.

<(1) in FIG. 13>

According to Embodiment 1 of the present invention, for example when a smoke sensor detects smoke occurrence and sends an event report message to the MTC server 150, a reverse event report message is sent from the MME 120 to all MTC devices 100 in the MTC group.

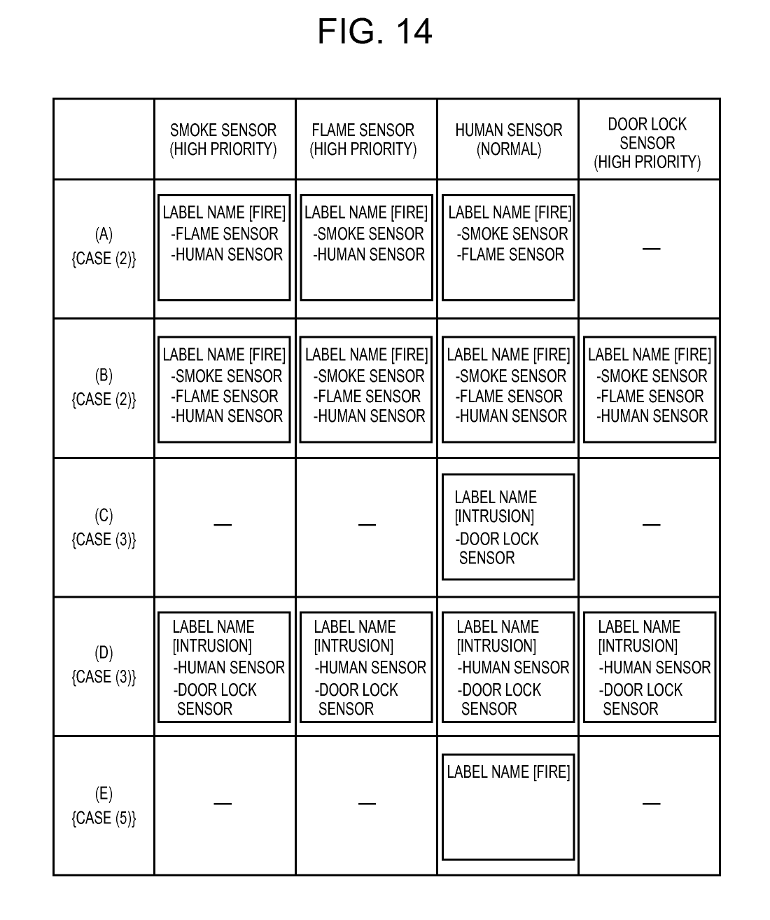

In this case, each MTC device 100 receiving the reverse event report message (i.e. all MTC devices 100 in the MTC group) transitions to the normal mode (maintains the normal mode in the case where the MTC device 100 is currently in the normal mode). In detail, as shown in (1) in FIG. 13, the smoke sensor, the flame sensor, and the door lock sensor transition from the high priority mode to the normal mode, while the human sensor maintains the normal mode. All other MTC devices 100 (e.g. earthquake sensor, water sensor, etc.) are also controlled to operate in the normal mode.

<(2) in FIG. 13, (A) and (B) in FIG. 14>

According to Embodiment 2 of the present invention, for example when a smoke sensor detects smoke occurrence and sends an event report message (event information) to the MTC server 150, a reverse event report message (event information) is sent from the MME 120 to all MTC devices 100 in the MTC group. In this case, all MTC devices 100 in the MTC group receive the reverse event report message [smoke|fire] including the device type ID “smoke sensor” and the event group information label name “fire”.

By receiving the reverse event report message [smoke|fire], the smoke sensor recognizes that the event report message (event information) is sent from the same device type, and transitions to the normal mode. Meanwhile, the flame sensor recognizes that the event report message (event information) is sent from a different device type, and maintains the high priority mode. By receiving the reverse event report message (event information) including the label name “fire”, the human sensor transitions from the normal mode to the high priority mode. The door lock sensor recognizes that the reverse event report message (event information) is unrelated to the door lock sensor, and maintains the high priority mode.

Further, when a flame sensor detects flame occurrence and sends an event report message (event information) to the MTC server 150, a reverse event report message (event information) is sent from the MME 120 to all MTC devices 100 in the MTC group. In this case, all MTC devices 100 in the MTC group receive the reverse event report message [flame|fire] including the device type ID “flame sensor” and the label name “fire”.

By receiving the reverse event report message [flame|fire], the flame sensor recognizes that the event report message (event information) is sent from the same device type, and transitions to the normal mode. Meanwhile, the smoke sensor has already transitioned to the normal mode by receiving the reverse event report message (i.e. the reverse event report message [smoke|fire]) of the event caused by the same incident (fire occurrence), and accordingly maintains the normal mode. The human sensor has already transitioned to the high priority mode by receiving the reverse event report message (i.e. the reverse event report message [smoke|fire]) of the event caused by the same incident (fire occurrence), and accordingly maintains the high priority mode. The door lock sensor recognizes that the reverse event report message (event information) is unrelated to the door lock sensor, and maintains the high priority mode.

Further, when a human sensor detects human presence and sends an event report message to the MTC server 150, a reverse event report message (event information) is sent from the MME 120 to all MTC devices 100 in the MTC group. In this case, all MTC devices 100 in the MTC group receive the reverse event report message [human|fire] including the device type ID “human sensor” and the label name “fire”.

By receiving the reverse event report message [human|fire], the human sensor recognizes that the event report message is sent from the same device type, and transitions to the normal mode. Meanwhile, each of the smoke sensor and the flame sensor has already transitioned to the normal mode by receiving the reverse event report message (i.e. the reverse event report message [smokelfire] and the reverse event report message [flame|fire]) of the event caused by the same incident (fire occurrence), and accordingly maintains the normal mode. The door lock sensor recognizes that the reverse event report message is unrelated to the door lock sensor, and maintains the high priority mode.

The operation such as (2) in FIG. 13 can be realized, for example, in such a manner that the smoke sensor holds event group information with the label name “fire” (in which the device type IDs of the flame sensor and the human sensor are registered), the flame sensor holds event group information with the label name “fire” (in which the device type IDs of the smoke sensor and the human sensor are registered), and the human sensor holds event group information with the label name “fire” (in which the device type IDs of the flame sensor and the smoke sensor are registered), as shown in (A) in FIG. 14. Meanwhile, the unrelated MTC device 10 such as the door lock sensor holds no event group information with the label name “fire”, or holds event group information with the label name “fire” in which no device type ID is registered.

In the above-mentioned manner of holding the event group information as in (A) in FIG. 14, each individual device type holds different event group information. As another method, it is also possible to set common (same) event group information in all MTC devices 100. In this case, the operation according to the present invention can be realized by, for example, not only determining whether or not the device type ID included in the reverse event report message (event information) is included in the event group information but also determining whether or not the device type ID of the MTC device 100 itself is included in the event group information in step S708 in FIG. 9B. Meanwhile, the unrelated MTC device 100 such as the door lock sensor may hold no event group information with the label name “fire” in this case, too.

In the case where each individual MTC device 100 holds different event group information as in (A) in FIG. 14, more detailed mode transition management can be carried out. As an example, by changing the event group information with the label name “fire” in the human sensor to a state in which only the smoke sensor is registered, the human sensor can be configured to transition to the high priority mode when receiving a reverse event report message (event information) including the device type ID of the smoke sensor but maintains the normal mode when receiving a reverse event report message (event information) including the device type ID of the flame sensor. In the case where such a situation is not assumed (in the case where each MTC device 100 having a related label transitions to the high priority mode whenever an event report message is sent from an MTC device 100 of any device type upon occurrence of a specific event), the MTC device 100 only needs to check whether or not the device type ID of the MTC device 100 is associated with the label name. That is, the MTC device 100 does not need to hold event group information in which the device type ID of each MTC device 100 is registered, but only needs to hold information indicating whether or not the device type ID of the MTC device 100 is associated with the label name (e.g. “fire”). In the case where the common event group information is set in each MTC device 100 as shown in (B) in FIG. 14, on the other hand, the event group information can be distributed to all MTC devices 100 at once and held by the MTC devices 100, without taking into consideration which MTC device 100 needs to hold which event group information.

<(3) in FIG. 13, (C) and (D) in FIG. 14>

According to Embodiment 2 of the present invention, the mode transition of the MTC device 100 can be changed for each event (each label name) by setting a plurality of pieces of event group information. For example, when a door lock sensor detects door unlocking (possibility of intrusion of a suspicious person) and sends an event report message (event information) to the MTC server 150, a reverse event report message (event information) is sent from the MME 120 to all MTC devices 100 in the MTC group. In this case, all MTC devices 100 in the MTC group receive the reverse event report message [unlock|intrusion] including the device type ID “door lock sensor” (written as “unlock” here) and the label name “intrusion”.

Here, suppose each human sensor alone makes the mode transition (from the normal mode to the high priority mode) by receiving the reverse event report message [unlock|intrusion] and, subsequently when a human sensor detects human presence and sends an event report message (event information) to the MTC server 150, the other human sensor is returned from the high priority mode to the normal mode, as in (3) in FIG. 13.

In the method of setting event group information separately for each MTC device, such an operation can be realized by the human sensor holding event group information with the label name “intrusion” (in which the device type ID of the door lock sensor is registered) as in (C) in FIG. 14. In the method of setting common event group information to all MTC devices 100, on the other hand, such an operation can be realized by all MTC devices 100 holding event group information with the label name “intrusion” (in which the device type IDs of the human sensor and the door lock sensor are registered) as shown in (D) in FIG. 14. In this case, at least the human sensor holds a plurality of pieces of event group information of different label names.

<(4) in FIG. 13>

According to Embodiment 2 of the present invention, a reverse event report message (event information) that includes both a device type ID and an event group information label (label name) as event information is sent, as an example. Alternatively, a reverse event report message including only a device type ID may be sent without using an event group information label (label name), as a structure having no detailed setting by event group information. This method can be regarded as a method whereby the instruction to transition to the normal mode, which is made by a reverse event report message in Embodiment 1, is issued to only the same type of MTC device as the MTC device 100 sending an event report message. This method can also be regarded as a method that omits steps S707 to S709 from the operation in FIG. 9B (the operation in Embodiment 2 of the present invention).

For example, when a smoke sensor detects smoke occurrence and sends an event report message to the MTC server 150, a reverse event report message (event information) including the device type ID “smoke sensor” is sent from the MME 120 to all MTC devices 100 in the MTC group.

In this case, all MTC devices 100 in the MTC group receive the reverse event report message including the device type ID “smoke sensor”, but only the same type of MTC device (i.e. each smoke sensor) as the device type ID included in the reverse event report message makes the mode transition (to the normal mode), as shown in (4) in FIG. 13.

<(5) in FIG. 13, (E) in FIG. 14>

According to Embodiment 2 of the present invention, a reverse event report message (event information) that includes both a device type ID and an event group information label (label name) as event information is sent, as an example. Alternatively, only an event group information label (label name) may be added to a reverse event report message (event information) without inserting a device type ID. This method can be regarded as a method that omits step S705 from the operation in FIG. 9B (the operation in Embodiment 2 of the present invention).

For example, when a smoke sensor detects smoke occurrence and sends an event report message to the MTC server 150, a reverse event report message including the label name “fire” is sent from the MME 120 to all MTC devices 100 in the MTC group.

Here, suppose only the human sensor holds information indicating that its device type is associated with the label name “fire”, as shown in (E) in FIG. 14. (E) in FIG. 14 shows that the human sensor holds event group information with the label name “fire”, but the information may be held in any form so long as the information can indicate to make the mode transition upon receiving a reverse event report message including the label name “fire”.

All MTC devices 100 in the MTC group receive the reverse event report message [fire], but the MTC devices 100 such as the smoke sensor, the flame sensor, and the door lock sensor are not associated with the label name “fire” and so do not make the mode transition. Meanwhile, the human sensor is associated with the label name “fire”, and so makes the mode transition (to the high priority mode) upon receiving the reverse event report message [fire].

In the example of (5) in FIG. 13 and (E) in FIG. 14, the current mode of each MTC device 100 other than the human sensor is maintained while the human sensor transitions to the high priority mode, so that sending of an event report message from these MTC devices 100 is not suppressed. However, this method is useful in that, as a result of an event report message being sent from an MTC device 100, the sending mode of the MTC device 100 (e.g. human sensor) which ordinarily operates in the normal mode can be changed to the high priority mode. In other words, the MTC device 100 (human sensor) which ordinarily operates in the normal mode can promptly transition to the high priority mode according to need.

### Embodiment 3

According to the solution method of each of the above embodiments, the event report message sent from the MTC device 100 and the reverse event report message sent from the MME 120 are both exchanged on the C-plane. However, there is also an instance where the U-plane is used for the event report message sent from the MTC device 100 and the C-plane is used for the reverse event report message by the network device (e.g. the MME 120, the MTC server 150, the PGW 140). For example, in the case where each message in the MTC service is set to be basically exchanged on the U plane based on the MTC service specifications, registration information, configuration information, or the like statically or dynamically set by the operator of the communication system, the MTC server 150, or the MTC user 160, the MTC device 100 that detects an event (e.g. smoke occurrence) sends the event report message to the PGW 140/MTC server 150 using the U-plane. Here, there is a possibility that, though the network device (e.g. the PGW 140/MTC server 150) wants to send the reverse event report message in response to the event report message using the U-plane based on the MTC service specifications, registration information, configuration information, or the like, the network device needs to send the reverse event report message via the MME 120 (such as when the MME 120 needs to update management information of the MTC device 100 using event information (e.g. device ID/device type ID) contained in the event report message). Embodiment 4 of the present invention corresponds to such a case.

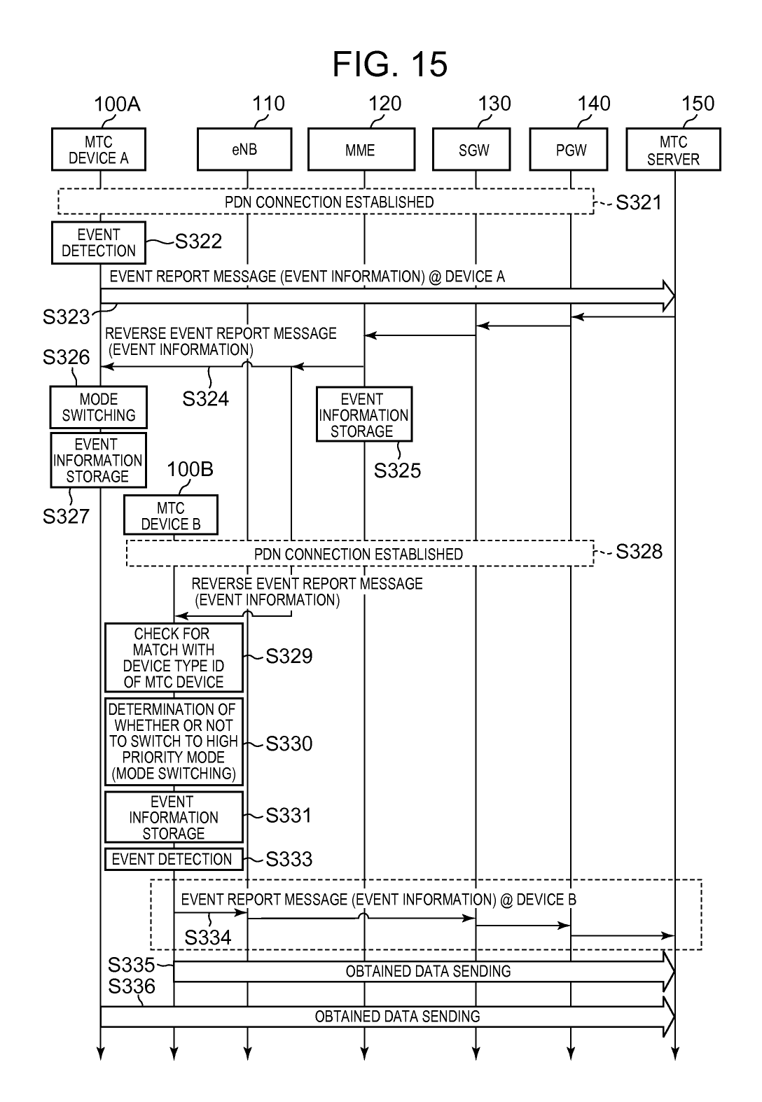

The following describes an example of a system operation in Embodiment 3 of the present invention in detail, with reference to FIG. 15. FIG. 15 is a sequence chart for describing an example (method of suppressing sending of a high priority event report message of the same event or an event caused by an incident that causes the former event, from a plurality of MTC devices 100) of the system operation in Embodiment 3 of the present invention. An example of a process sequence in the system structure shown in FIG. 1 is shown in FIG. 15. The features of the MTC device 100 are the same as those in Embodiment 2 of the present invention, and so their description is omitted here.

The sequence shown in FIG. 15 is described below. Steps S321 to S322 are the same as steps S301 to S302 in Embodiment 2 of the present invention (see FIG. 4), and so their description is omitted here.

Following this, the MTC device A 100A sends an event report message (event information) containing detected event information (e.g. smoke sensor ID) to the MTC server 150 on the U-plane (step S323: event report message (event information) @ device A). That is, the event report message (event information) @ device A sent from the MTC device A 100A is transferred in the order of the eNB 110, the SGW 130, the PGW 140, and the MTC server 150. Though the MTC server 150 is the report destination of the event report message (event information) in this example, the destination of the event report message (event information) may be another network device (e.g. the PGW 140) based on the specifications, registration information, configuration information, or the like set by the operator of the communication system, the MTC server 150, or the MTC user 160.

Next, the MTC server 150 extracts the event information from the received event report message (event information), and contains the event information in a reverse event report message. The MTC server 150 sends the reverse event report message to the MME 120, in order to suppress sending of an event report message of the same event (e.g. smoke occurrence) or an event (e.g. flame occurrence) caused by an incident (e.g. fire occurrence) that causes the former event (e.g. smoke occurrence). The MME 120 then broadcasts the reverse event report message to each MTC device 100 belonging to the MTC group using the C-plane (step S324: reverse event report message (event information)). Though the reverse event report message is generated by the MME 120 here, the reverse event report message may be generated by another network device (e.g. the MTC server 150, the PGW 140). In this case, the reverse event report message may be broadcast by a network device (the MTC server 150 or the PGW 140) other than the MME 120.

The MME 120 sending the reverse event report message extracts the event information (e.g. device ID) contained in the reverse event report message, and stores the event information for use when determining whether or not to broadcast a reverse event report message again (step S325: event information storage). The process from step S326 is the same as the process from step S306 in Embodiment 2 of the present invention, and so its description is omitted here.

By using the U-plane for the event report message sent from the MTC device 100 and the C-plane for the reverse event report message sent from the network device (e.g. the MME 120, the MTC server 150, the PGW 140) as in Embodiment 3 of the present invention, it is possible to respond to the case where, in an environment in which each message in the MTC service is set to be basically sent using the U-plane, the network device (e.g. the PGW 140, the MTC server 150) needs to send the reverse event report message via the MME 120 (C-plane) (such as when the MME 120 needs to update management information of the MTC device 100 using event information (e.g. device ID/device type ID) contained in the event report message).

### Embodiment 4

Embodiment 4 of the present invention relates to the case where the C-plane is used for the event report message sent from the MTC device 100 and the U-plane is used for the reverse event report message sent from the network device (e.g. the MTC server 150, the PGW 140). Suppose the MTC device 100 detects an event (e.g. smoke occurrence), in an environment in which each message in the MTC service is set to be basically sent using the U-plane based on the MTC service specifications, registration information, configuration information, or the like statically or dynamically set by the operator of the communication system, the MTC server 150, or the MTC user 160. The MTC device 100 should normally send the event report message to the PGW 140/MTC server 150 using the U-plane, but there is an instance where the MTC device 100 determines to send the event report message using the C-plane based on the specifications, registration information, or configuration information set by the operator of the communication system, the MTC server 150, or the MTC user 160 beforehand in the case where there is information necessary for the MME 120 to manage the MTC device 100 (such as when the MTC device 100 is a movable smoke sensor (e.g. mobile robot capable of detecting smoke occurrence) and the location information of the MTC device 100 is reported in addition to the event information, or when the MTC service is an MTC service of reporting the event information to which the location information of the MTC device 100 is added (e.g. service in which location information is additionally sent upon event detection, where the MTC device 100 is installed in a car or the like)).

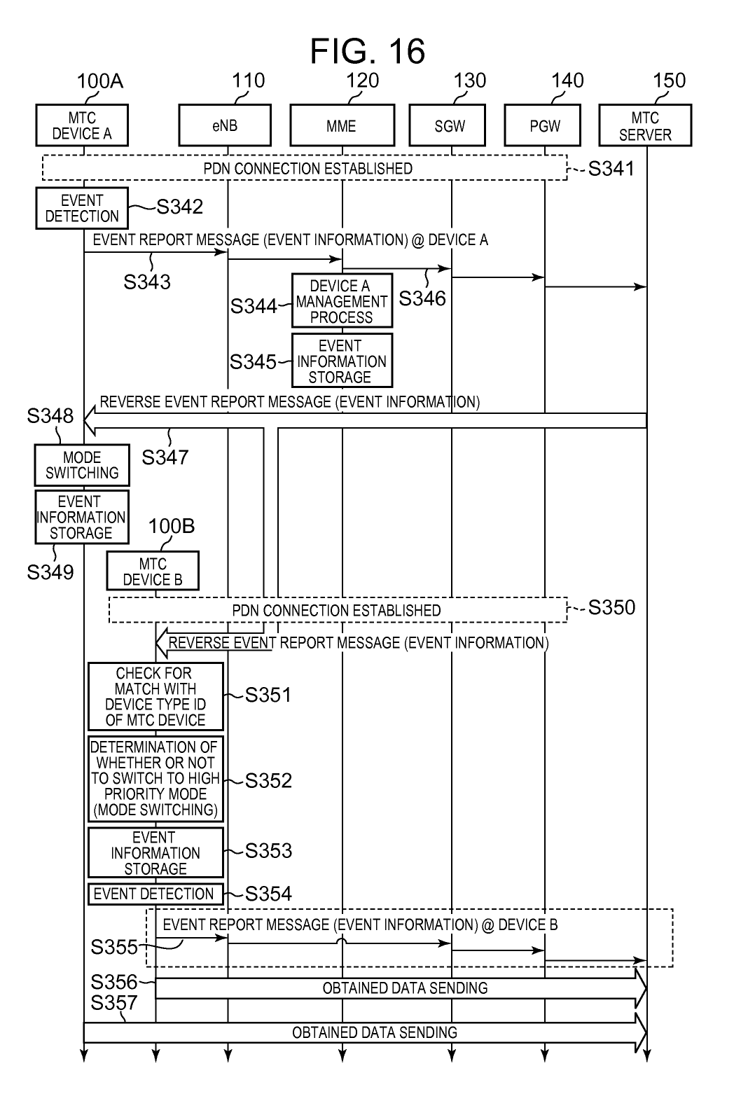

The following describes an example of a system operation in Embodiment 4 of the present invention in detail, with reference to FIG. 16. FIG. 16 is a sequence chart for describing an example (method of suppressing sending of a high priority event report message of the same event or an event caused by an incident that causes the former event, from a plurality of MTC devices 100) of the system operation in Embodiment 4 of the present invention. An example of a process sequence in the system structure shown in FIG. 1 is shown in FIG. 16. The features of the MTC device 100 are the same as those in Embodiment 2 of the present invention, and so their description is omitted here.

The sequence shown in FIG. 16 is described below. Steps S341 to S342 are the same as steps S301 to S302 in Embodiment 2 of the present invention (see FIG. 4), and so their description is omitted here.

Following this, the MTC device A 100A sends an event report message (event information) containing detected event information (e.g. smoke sensor ID) to the MME 120 on the C-plane (step S343: event report message (event information) @ device A).

The MME 120 receives the event report message (event information) @ device A from the MTC device A 100A, extracts necessary information (e.g. location information and device ID of the MTC device A 100A), and performs a management process of the MTC device A 100A (e.g. update of context information or location information of the MTC device A 100A) (step S344: device A management process).

The MME 120 also extracts the event information (e.g. device ID, device type ID) contained in the event report message (event information) @ device A, and stores the event information for use when determining whether or not to broadcast a reverse event report message again (step S345: event information storage).

The MME 120 then transfers the received event report message (event information) to the MTC server 150 (step S346). Here, based on the specifications, registration information, or configuration information set by the operator of the communication system, the MTC server 150, or the MTC user 160, the MME 120 directly transfers the received event report message (event information) @ device A to the MTC server 150, or sends only necessary information (e.g. event information) to the MTC server 150. Though the MTC server 150 is the report destination of the event report message (event information) in this example, the destination of the event report message (event information) may be another network device (e.g. the PGW 140) based on the specifications, registration information, configuration information, or the like set by the operator of the communication system, the MTC server 150, or the MTC user 160. The device A management process in step S344 to the event report message (event information) @ device A transfer process in step S346 may be performed in any order.

Next, the MTC server 150 extracts the event information from the received event report message (event information), and contains the event information in a reverse event report message. The MTC server 150 broadcasts the reverse event report message (event information) to each MTC device 100 in the MTC group using the U-plane, in order to suppress sending of an event report message of the same event (e.g. smoke occurrence) or an event (e.g. flame occurrence) caused by an incident (e.g. fire occurrence) that causes the former event (e.g. smoke occurrence) (step S347: reverse event report message (event information)). The process from step S348 is the same as the process from step S306 in Embodiment 2 of the present invention, and so its description is omitted here.

By using the C-plane for the event report message sent from the MTC device 100 and the U-plane for the reverse event report message sent from the network device (e.g. the MTC server 150, the PGW 140) as in Embodiment 4 of the present invention, it is possible to respond to the case where, in an environment in which each message in the MTC service is set to be basically sent using the U-plane, the MTC device 100 needs to send the event report message via the MME 120 (C-plane) (such as when the MME 120 needs to update the management information of the MTC device 100 using the location information of the MTC device 100 or the event information (e.g. device ID/device type ID) contained in the event report message).

### Embodiment 5

Embodiment 5 of the present invention relates to the case where the U-plane is used for the event report message sent from the MTC device 100 and the U-plane is equally used for the reverse event report message sent from the network device (e.g. the MTC server 150, the PGW 140). That is, Embodiment 5 of the present invention relates to the case where the event report message (event information) sent from the MTC device 100 and the reverse event report message (event information) sent from the network device (e.g. the MTC server 150, the PGW 140) are both exchanged on the U-plane. An example environment is that each message in the MTC service is set to be sent using the U-plane based on the MTC service specifications, registration information, configuration information, or the like statically or dynamically set by the operator of the communication system, the MTC server 150, or the MTC user 160. In detail, the event report message (event information) @ device A sent from the MTC device A 100A is transferred in the order of the eNB 110, the SGW 130, the PGW 140, and the MTC server 150, and the reverse event report message (event information) sent from the MTC server 150 is transferred in the order or the PGW 140, the SGW 130, the eNB 110, and the MTC device 100. Thus, the MTC service messages are exchanged not via the MME 120. For instance, Embodiment 5 of the present invention corresponds to an environment in which all messages (e.g. event detection information, sensing data, etc.) in the MTC service except messages (e.g. TAU, RAU, paging, etc.) for updating the location information of the MTC device 100 and the like are interpreted as application information, and need to be exchanged not on the C-plane for mobility control of the MTC device 100 and the UE 105, PDN connection/EPS bearer management, and QoS management but only on the U-plane for transferring user data (application information).

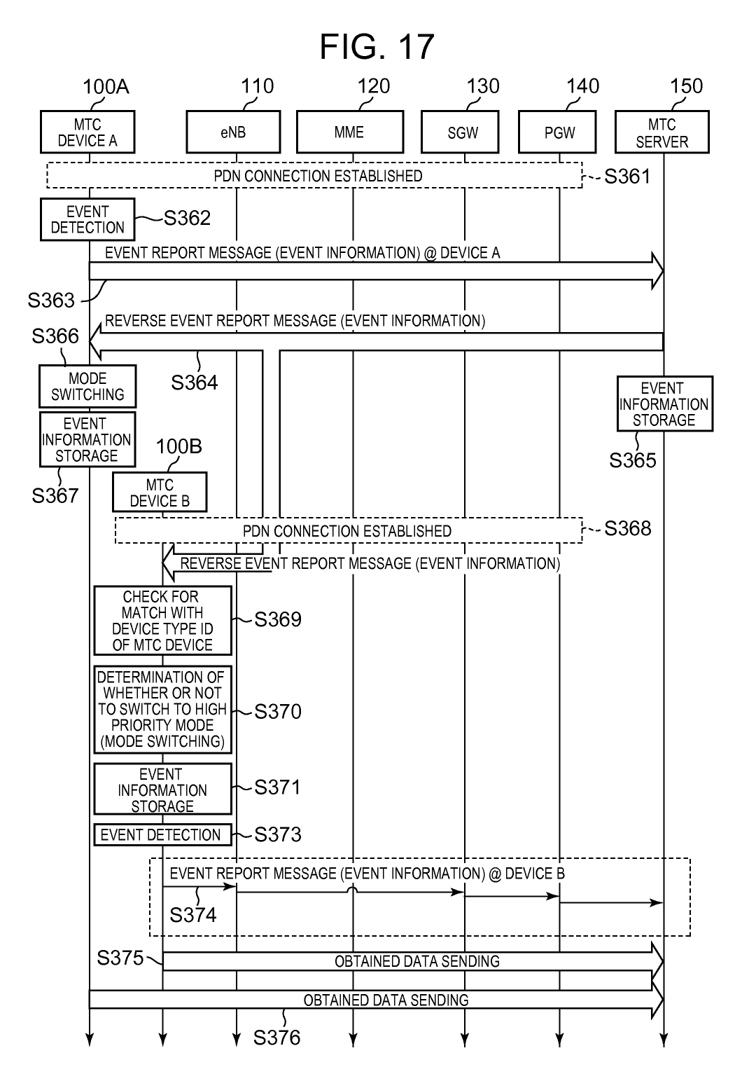

The following describes an example of a system operation in Embodiment 5 of the present invention in detail, with reference to FIG. 17. FIG. 17 is a sequence chart for describing an example (method of suppressing sending of a high priority event report message of the same event or an event caused by an incident that causes the former event, from a plurality of MTC devices 100) of the system operation in Embodiment 6 of the present invention. An example of a process sequence in the system structure shown in FIG. 1 is shown in FIG. 17. The features of the MTC device 100 are the same as those in Embodiment 2 of the present invention, and so their description is omitted here.

The sequence shown in FIG. 17 is described below. Steps S361 to S362 are the same as steps S301 to S302 in Embodiment 2 of the present invention, and so their description is omitted here.

Following this, the MTC device A 100A sends an event report message (event information) containing detected event information (e.g. smoke sensor ID) to the MTC server 150 on the U-plane (step S363: event report message (event information) @ device A). That is, the event report message (event information) @ device A sent from the MTC device A 100A is transferred in the order of the eNB 110, the SGW 130, the PGW 140, and the MTC server 150. Though the MTC server 150 is the report destination of the event report message (event information) in this example, the destination of the event report message (event information) may be another network device (e.g. the PGW 140) based on the specifications, registration information, configuration information, or the like set by the operator of the communication system, the MTC server 150, or the MTC user 160.

The MTC server 150 contains the event information (e.g. device ID, device type ID) in the received event report message (event information), in a reverse event report message. The MTC server 150 broadcasts the reverse event report message (event information) to each MTC device 100 in the MTC group using the U-plane (step S364: reverse event report message (event information)).

The MTC server 150 then stores the event information (e.g. device ID, device type ID) contained in the event report message (event information) @ device A, in order to suppress sending of an event report message of the same event (e.g. smoke occurrence) or an event (e.g. flame occurrence) caused by an incident (e.g. fire occurrence) that causes the former event (e.g. smoke occurrence) (step S365: event information storage). The process from step S366 is the same as the process from step S306 in Embodiment 2 of the present invention, and so its description is omitted here.

By using the U-plane for both the event report message sent from the MTC device 100 and the reverse event report message sent from the network device (e.g. the MTC server 150, the PGW 140) as in Embodiment 5 of the present invention, it is possible to respond to an environment in which all messages in the MTC service (e.g. event detection information, sensing data, etc.) except messages (e.g. TAU, RAU, paging, etc.) for updating the location information of the MTC device 100 and the like are interpreted as application information and need to be exchanged not on the C-plane for mobility control of the MTC device 100 and the UE 105, PDN connection/EPS bearer management, and QoS management but on the U-plane for transferring user data (application information).

### Embodiment 6

Each of the above embodiments describes an example of using an EPS (Evolved Packet System) architecture with the PGW 140 as a data gateway. However, it should be clear for a person skilled in the art that the present invention can also be implemented in a GPRS (General Packet Radio Service) architecture, a UMTS (Universal Mobile Telecommunications System) architecture, or a mixed structure of these architectures.

For example, in a structure based on the GPRS architecture or the UMTS architecture, an SGSN (Serving GPRS Support Node) has the above-mentioned role of the MME 120 and the SGW 130, and performs the corresponding process. Likewise, a GGSN (Gateway GPRS Support Node) has the role of the PGW 140, and performs the corresponding process. Moreover, a PDP context is used as a logic communication path equivalent to a PDN connection. Though there may be slight differences in description, signaling procedure, and message order for some messages, such differences are insignificant in implementation of the present invention. The present invention can be equally implemented in other communication systems (e.g. local communication system such as WLAN, wide area communication system such as WiMAX, cellular system such as 3GPP2, and other private communication system).

### Embodiment 7

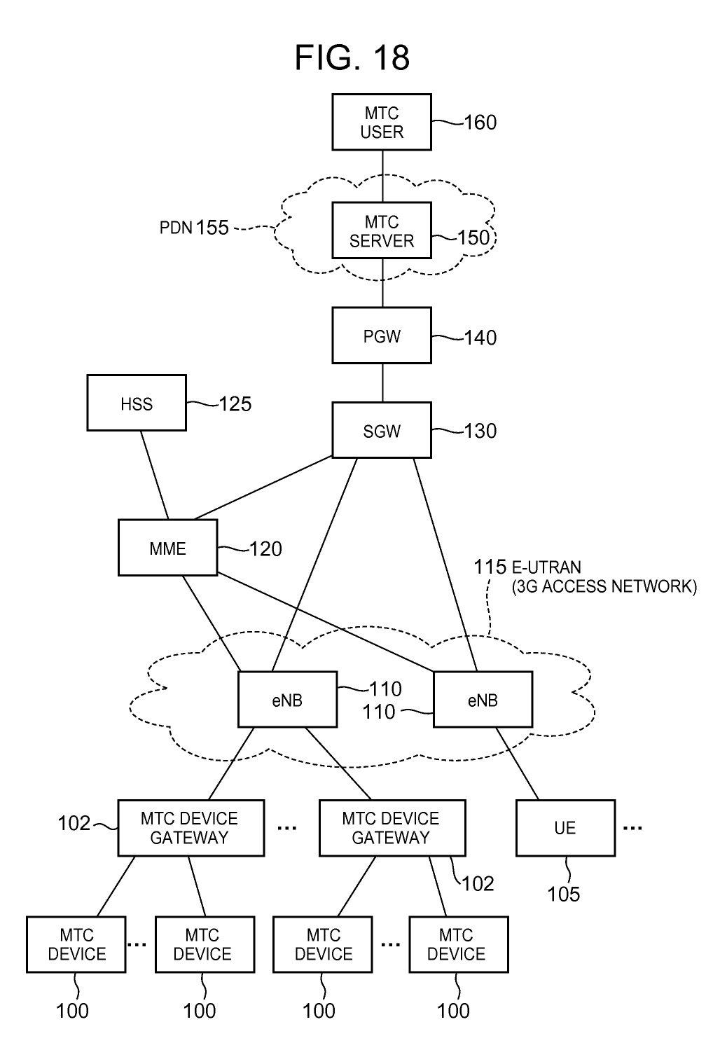

Each of the above embodiments describes an example of using an architecture in which, in the structure of the MTC communication network shown in FIG. 1, the plurality of MTC devices 100 are grouped as one MTC group, and each MTC device holds a communication interface to the 3G access network (e.g. E-UTRAN 115) and sends a detected event or sensing data to the MTC server 150 via the 3G access network. However, it is clear that the present invention can also be implemented in, for example, an architecture in which an MTC device gateway is provided between the MTC device 100 and the 3G access network and the MTC device gateway transfers a message sent from the MTC device. FIG. 18 shows an example of a structure of an MTC communication network in Embodiment 7 of the present invention.

FIG. 18 differs from FIG. 1 in that an MTC device gateway 102 is present between the MTC device 100 and the eNB 110 (3G access network).

In FIG. 18, the MTC device gateway 102 has at least one communication interface for communicating with the 3G access network 115. The MTC device gateway 102 also has a communication interface (e.g. a communication interface to a communication bus, a communication interface such as a wired LAN, a wireless communication protocol such as Zigbee (registered trademark) or a wireless LAN) for communicating with a plurality of MTC devices 100.

The MTC device 100 does not need to have a communication interface to the 3G access network, unlike the MTC device 100 in each of the above embodiments. That is, the MTC device 100 does not need to be able to directly send detected event information or sensing data to the MTC server 150 via the 3G access network. Instead, the MTC device 100 sends detected event information or sensing data to the MTC device gateway 102, which transfers the event information or the sensing data to the network device (e.g. the MME 120, the PGW 140, the MTC server 150) via the 3G access network. Since the MTC device gateway 102 sends data obtained by each MTC device 100 in an integrated manner, it becomes unnecessary for the operator of the communication system, the MTC server 150, or the MTC user 160 to manage each MTC device 100 individually. This leads to a reduction in processing load and resource use. Moreover, integrating each device that communicates with the 3G access network into the MTC device gateway 102 eliminates the need to equip every MTC device 100 with an expensive 3G access communication interface, which contributes to reduced costs. Embodiment 6 of the present invention can be considered as a realistic embodiment for managers of systems for monitoring apartments, buildings, condominiums, and so on.

As described in Embodiment 1, in the case where at least the MTC device gateway 102 is capable of recognizing priority levels of data sent from a plurality of MTC devices 100, the MTC device gateway 102 can transfer only high priority data (transfer low priority data later (e.g. after congestion is eliminated)) to the network side by selecting the transfer data while checking the priority level (for example, comparing the allowable priority level indicated by the network side with the priority level contained in the data transferred from the MTC device 100, or checking the priority level included in application data or a context (e.g. context in which such a rule that allows only a message of priority level 3 or more to be sent during congestion level 3 is registered) incorporated in the MTC device 100 or the MTC device gateway 102 beforehand), when congestion occurs on the network side (e.g. overflow of the eNB 110, the MME 120, or the PGW 140), when the MTC user 160 has a special contract (e.g. contract to perform data transfer with priority by establishing a high usage fee charging rule) with the operator of the communication system, or when an instruction to transfer data using a predetermined priority level is distributed according to an operator policy (e.g. when data transfer of priority level 3 or more is allowed). In this way, even in the case where congestion occurs on the network side, the MTC user 160 or the MTC server 150 can receive data collected with priority.

The MTC device 100 may have the role of the MTC device gateway 102. In such a case, the load of the MTC device 100 that serves as the MTC device gateway 102 is expected to increase, which raises the need for load distribution. For example, the load distribution can be achieved by each MTC device 100 in the MTC group acting as the MTC device gateway 102 in turn (e.g. at time intervals).

### Embodiment 8

In each of the above embodiments, the reverse event report message is sent from the network device (e.g. the eNB 110, the MME 120, the SGW 130, the PGW 140, the MTC server 150) before congestion occurs on the network side, thereby suppressing sending of a redundant event report message from each MTC device 100 and avoiding congestion on the network side. However, in the case where a high priority emergency message (referred to as emergency request or emergency message), data (application message), or a PDN connection establishment request is sent from the UE 105 or the like when congestion already occurs on the network side or congestion begins to occur upon reception of a message (e.g. PDN connection establishment request, transfer data), more resources (both the U-plane and the C-plane) become necessary. Examples of such resources include processing capacity resources (e.g. processes in data transfer) in communication system entities (e.g. the eNB 110, the MME 120, the SGW 130, the PGW 140), and communication resources or bandwidth resources assigned to the MTC device 100 or the UE 105. To solve this problem, resources for a request, a message, or an application of a high priority level are secured by selectively releasing an already established PDN connection using a priority level (e.g. priority level assigned to the UE 105 or the MTC device 100, priority level of data to be sent, QCI, ARP) held by the UE 105, the MTC device 100, or the network entity (e.g. the eNB 110, the MME 120, the SGW 130, the PGW 140, the MTC server 150) or by controlling new PDN connection establishment. Embodiment 8 of the present invention is a realistic embodiment that can be seen in areas having many MTC devices 100 or UEs 105.

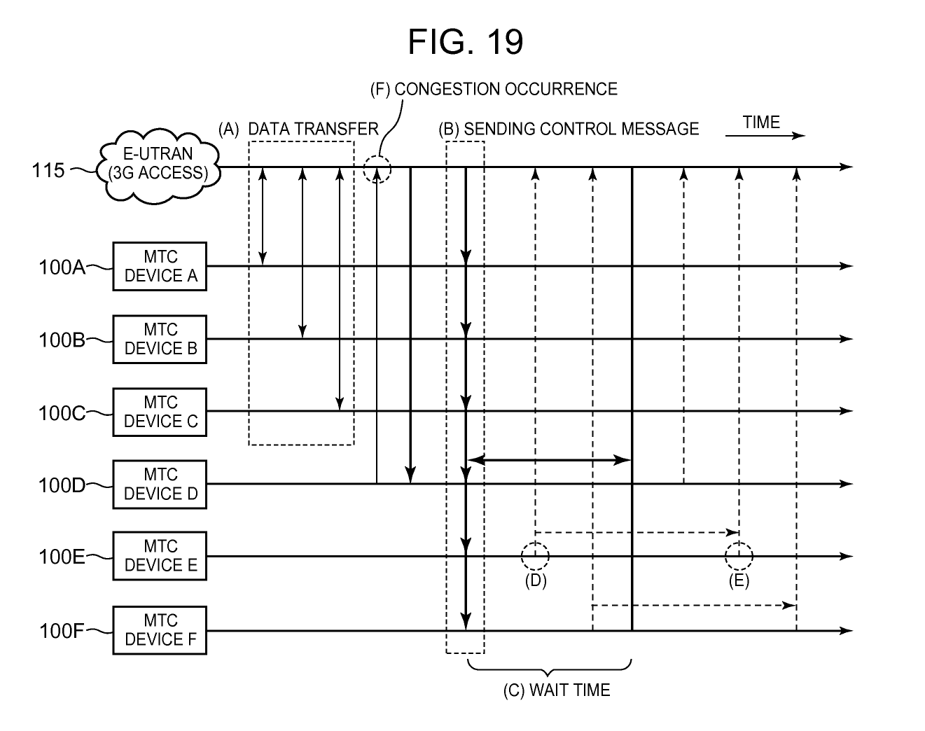

The following describes Embodiment 8 of the present invention with reference to FIGS. 19 to 24.

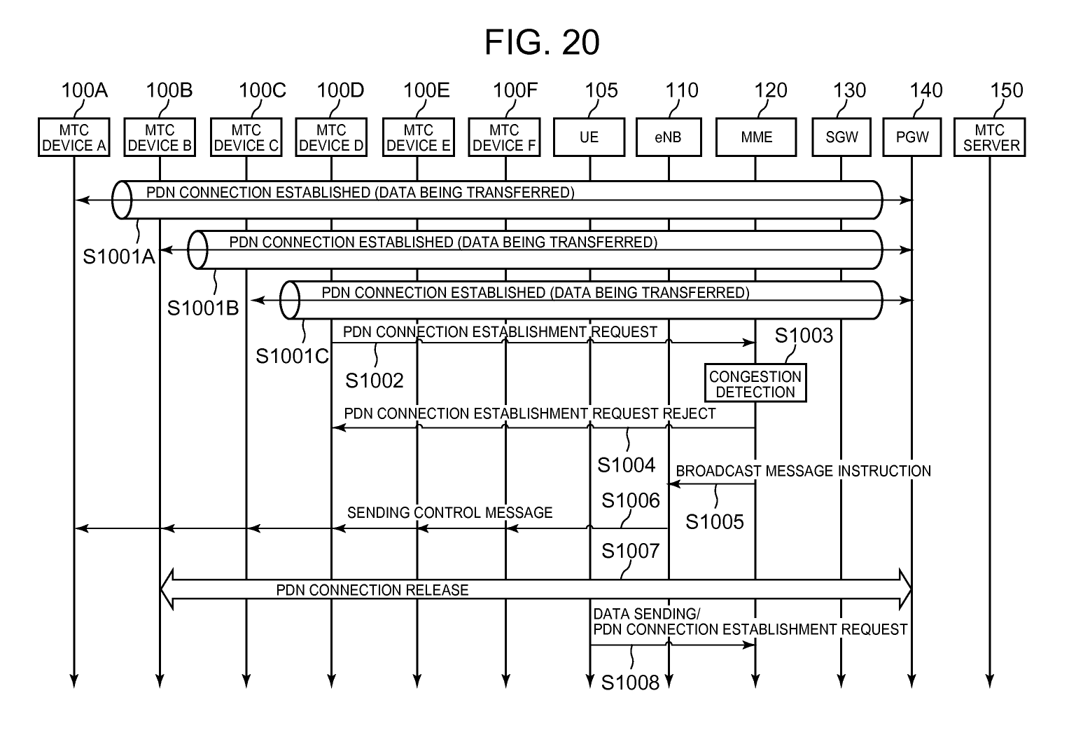

It is assumed that an MTC device B, an MTC device D, an MTC device E, and an MTC device F shown in FIGS. 19 and 20 have the “time tolerant” feature (time tolerance) defined in Non-patent Document 1, for ease of explanation of Embodiment 8 of the present invention.

The MTC device 100 having the “time tolerant” feature is capable of delaying the timing of sending a message (e.g. PDN connection establishment request, data transfer) in the case where the network is congested, according to an operator policy, or the like. The “time tolerant” operation is described below, with reference to FIG. 19. FIG. 19 shows a situation where each of an MTC device A, the MTC device B, and an MTC device C has already established a PDN connection and is transferring data to the 3G access network side ((A) data transfer in FIG. 19), and the MTC device D, the MTC device E, and the MTC device F are about to establish PDN connections and transfer data to the 3G access network side in sequence (i.e. the MTC devices A to C are in a connected mode and the MTC devices D to F are about to transition from an idle mode to the connected mode in sequence). Suppose congestion occurs on the 3G access network side when the MTC device D tries to establish a PDN connection (e.g. the allowable traffic load on the 3G access network side is exceeded) ((F) congestion occurrence in FIG. 19). In this case, after sending a PDN connection establishment reject message indicating to reject the PDN connection establishment of the MTC device D to the MTC device D, the 3G access network side broadcasts a message reporting congestion on the 3G access network side ((B) sending control message in FIG. 19) to each target MTC device 100 (the MTC devices A to F in Embodiment 8 of the present invention (in an actual environment, for example, each MTC device 100 connected to a specific APN, each MTC device 100 belonging to a specific MTC group, each MTC device 100 belonging to a specific operator, or a specific area (e.g. each MTC device connected to a specific eNB 110 or MME 120))). The timing at which the network recognizes congestion is not limited to when the PDN connection establishment request of the MTC device D is received as mentioned above. In the case where congestion occurs or is likely to occur due to data sent from an MTC device that has already established a PDN connection, the sending control message is broadcast to the area to which each target MTC device belongs. For example, a value (e.g. wait time) indicating how long a message (e.g. PDN connection establishment request) sent from the MTC device 100 is delayed is contained in the (B) sending control message ((C) wait time in FIG. 19). Upon receiving the (B) sending control message containing the wait time, the MTC device 100 checks whether or not the MTC device 100 has the “time tolerant” feature.

The MTC device 100 with the “time tolerant” feature can delay the message sending timing based on the value (e.g. wait time) indicated by the 3G access network, after receiving the (B) sending control message (e.g. (D) to (E) in FIG. 19). Though the message sending timing is delayed based on the value (wait time) indicated by the 3G access network in this example, the MTC device may calculate the value (wait time), or inquire of an external server such as the MTC server 150 about the value (wait time).

In the case where the MTC device 100 or the UE 105 without the “time tolerant” feature receives the (B) sending control message, the message sending timing cannot be delayed, so that the MTC device 100 or the UE 105 sends the message (e.g. PDN connection establishment request, application data, emergency request, emergency message) during the (C) wait time. Since the message sent by the MTC device 100 or the UE 105 without the “time tolerant” feature cannot be resent after the (C) wait time (the message sending timing cannot be delayed), the message is sent as a message from a high priority MTC device 100 or UE 105. To enable the network side to accept the message sent from the high priority MTC device 100 or UE 105, resources (both the C-plane and the U-plane) are secured by releasing a PDN connection established by a (low priority) MTC device 100 (MTC device 100 with the “time tolerant” feature) that can delay the message sending timing (i.e. the message is sent after the (C) wait time).

In the case where the MTC device 100 or the UE 105 without the “time tolerant” feature can wait for a predetermined time (e.g. not the value (wait time) contained in the (B) sending control message but a wait time (fixed value) incorporated in the MTC device 100 or the UE 105 beforehand) when receiving the (B) sending control message, the MTC device 100 with the “time tolerant” feature can delay message sending for a longer time than the MTC device 100 without the “time tolerant” feature.

The following describes an example of a system operation in Embodiment 8 of the present invention in detail, with reference to FIG. 20. FIG. 20 is a sequence chart for describing an example (method of securing resources for a request or an application of a high priority level by releasing an already established PDN connection using a priority level (e.g. priority level assigned to the UE 105 or the MTC device 100, priority level of data to be sent, QCI, ARP) held by the UE 105, the MTC device 100, or the network entity (e.g. the eNB 110, the MME 120, the SGW 130, the PGW 140, the MTC server 150)) of the system operation in Embodiment 8 of the present invention. An example of a process sequence in the system structure shown in FIG. 1 is shown in FIG. 20.

Each of the MTC device A 100A, the MTC device B 100B, and the MTC device C 100C has already established a PDN connection, and is transferring data (steps S1001A, S1001B, S1001C in FIG. 20: PDN connection established). Next, the MTC device D 100D sends a PDN connection establishment request to the MME 120, to transfer data (step S1002 in FIG. 20: PDN connection establishment request).

Upon receiving the PDN connection establishment request, the network entity (e.g. the eNB 110, the MME 120) detects congestion (detects the need to secure resources) by checking, for example, whether or not the allowable processing capacity level (threshold) is exceeded (step S1003 in FIG. 20: congestion detection). Though the network entity (e.g. the eNB 110, the MME 120) detects congestion by receiving the PDN connection establishment request from the MTC device D 100D in this example, the network entity may detect congestion by, for example, an increase in size of data (total amount of data being sent) sent from the MTC devices 100 which are transferring data (the MTC devices A to C in Embodiment 8 of the present invention).

Though the above describes the case where the MME 120 detects congestion for ease of explanation of this embodiment, another entity (e.g. the eNB 110, the SGW 130, the PGW 140, the MTC server 150) may detect congestion. In this case, the entity may directly report the congestion to the MTC device D 100D, or indirectly report the congestion by reporting to the MME 120, the eNB 110, or the like (e.g. the PGW 140 reports the congestion to the MME 120 upon congestion detection, and the MME 120 reports the congestion to the MTC device 100 when the PD connection establishment request is sent from the MTC device D 100D).

Upon detecting congestion, the MME 120 sends a PDN connection establishment request reject message to the MTC device D 100D to report that the PDN connection cannot be established (step S1004 in FIG. 20: PDN connection establishment request reject). Following this, the eNB 110 broadcasts a sending control message to each target MTC device 100 (e.g. each MTC device connected to a specific APN, each MTC device belonging to a specific MTC group, each MTC device belonging to a specific operator, or a specific area (e.g. each MTC device connected to a specific eNB 110 or MME 120)) (steps S1005, S1006 in FIG. 20: sending control message). The determination of each target MTC device 100 may be instructed from the MME 120 to the eNB 110 by a broadcast message instruction in step S1005. Here, the MME 120 may inquire of the eNB 110, the SGW 130, the PGW 140, or the MTC server 150 about the instruction.

When broadcasting to each target MTC device 100, the eNB 110 may use a paging message (paging) or MBMS (Multimedia Broadcast and Multicast Service) in conventional art. Though the MME 120 issues the broadcast message instruction to the eNB 110 and the eNB 110 broadcasts to each target device in this example for ease of explanation of this embodiment, another entity may issue the broadcast message instruction for broadcasting (e.g. the PGW 140 issues the broadcast message instruction to the eNB 110 and the eNB 110 performs broadcasting).

The message sending processes by the MME 120 (steps S1004 and S1005) may be performed in reverse order. Moreover, step S1004 may be omitted if, by broadcasting the sending control message in step S1005, it is possible to report that the PDN connection establishment request of the MTC device D 100D is rejected.

Upon receiving the sending control message, the MTC device 100 checks whether or not the MTC device 100 has the “time tolerant” feature. In the case where the MTC device 100 has the “time tolerant” feature, the MTC device 100 delays the timing of sending a PDN connection establishment request, based on a wait time contained in the sending control message. The MTC device 100 without the “time tolerant” feature cannot delay the message sending timing, and so sends a PDN connection establishment request even when congestion occurs on the network side.

Thus, by avoiding the sending of the PDN connection establishment request from the MTC device 100, the processing load on the communication system can be reduced, and C-plane resources can be secured. However, available U-plane resources are not attained until the data transfer of the MTC device (the MTC device A 100A to the MTC device C 100C) which has already established the PDN connection is completed. There is also an instance where, as a result of the UE 105 or the like sending an emergency message (emergency request or emergency message) or an application message of high priority, more resources (both the U-plane and the C-plane) for the UE 105 or the MTC device 100 of a high priority level become necessary, as mentioned above.

Hence, U-plane resources for a PDP connection establishment request or application data of a high priority level are secured by selectively releasing an already established PDN connection using the priority level of the MTC device 100. To determine the priority level, for example, the MTC device 100 checks whether or not the MTC device 100 has the “time tolerant” feature.

Accordingly, a parameter instructing “the MTC device 100 with the “time tolerant” feature to release the already established PDN connection” is contained in the sending control message broadcast from the eNB 110. The MTC device 100 with the “time tolerant” feature releases the already established PDN connection, for example after receiving the sending control message broadcast from the eNB 110. After a predetermined time (such as a value (e.g. wait time) indicated by the 3G access network) elapses from the sending control message, the MTC device 100 may establish the PDN connection again and transfer data.

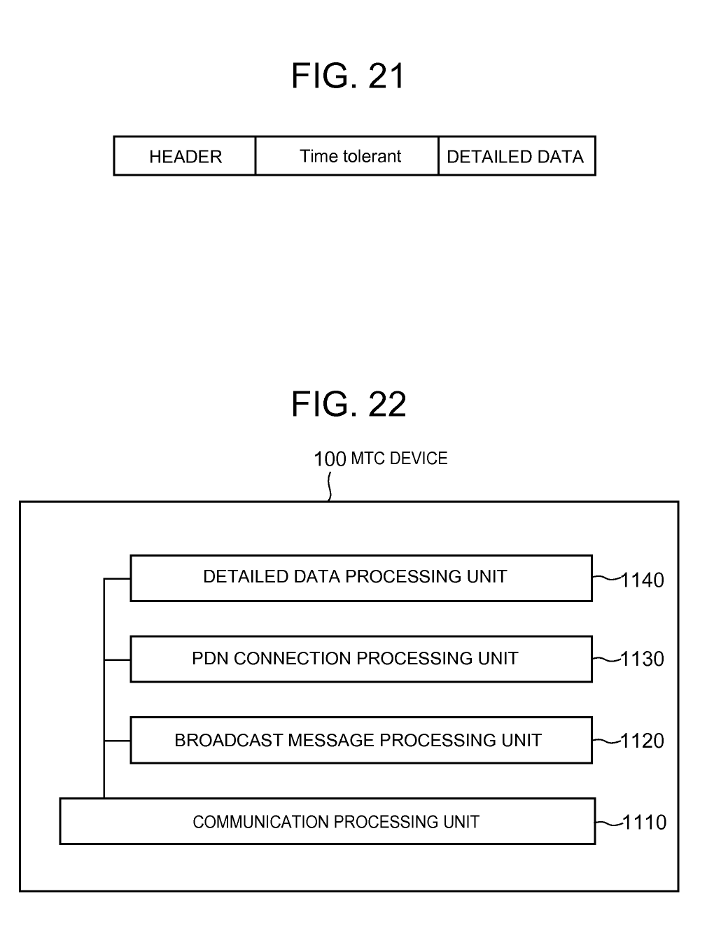

FIG. 21 is a diagram showing an example of a format of the sending control message broadcast from the eNB 110 to each target MTC device 100 in step S1006 in FIG. 20, as an example structure of the message containing a parameter instructing “the MTC device 100 with the “time tolerant” feature to release the already established PDN connection” and a parameter indicating “additional detailed condition”.

The message shown in FIG. 21 includes: a header field necessary for broadcasting; a time tolerant field indicating “the MTC device 100 with the “time tolerant” feature to release the already established PDN connection”; and a detailed data field containing a detailed condition (detailed data) used when determining whether to maintain or release the PDN connection using more detailed information. The detailed data field can contain a remaining amount of data (data remaining amount) transferred using the already established PDN connection, an expected completion time (expected completion time of day), a remaining time, a QCI (QoS Class Indicator) or an ARP (Allocation and Retention Priority) of a PDN connection (EPS bearer), a data transfer start time (hereafter also referred to as “before time”), an MTC feature (e.g. MTC device 100 with a “mobile originated only” feature of being capable of only reception defined in Non-patent Document 1), and the like, in addition to an APN, location information (e.g. eNB ID, eNB address), a group ID for identifying the MTC group, and a PLMN ID for identifying the connected network operator in conventional art. As the condition for determining whether to maintain or release the already established PDN connection, the MTC device 100 can use not only the condition of whether or not the MTC device 100 has the “time tolerant” feature, but also the detailed condition contained in the detailed data field. This can be explained using logic operations as follows. Through the use of the detailed data field, whether to maintain or release the already established PDN connection can be determined based on the result of “(MTC device 100 with the “time tolerant” feature) AND (detailed data)”, “(MTC device 100 with the “time tolerant” feature) OR (detailed data)”, or “(MTC device 100 with the “time tolerant” feature) EXOR (detailed data)”. In the case where the MTC device 100, the UE 105, or the communication system entity is capable of recognizing a parameter (e.g. low priority indicator) indicating a low priority MTC device 100 or application, a parameter indicating “the MTC device 100 with the “low priority” feature to release the already established PDN connection” may replace the above-mentioned parameter (i.e. may be used instead).

For example, it may be defined to release only the PDN connection established by the MTC device 100 which is “MTC device 100 with the “time tolerant” feature” and “MTC device 100 with the “mobile originated only” feature”, release only the PDN connection established by the MTC device 100 which is “MTC device 100 with the “time tolerant” feature” or “MTC device 100 with the “mobile originated only” feature”, or release the PDN connection established by the MTC device which is “MTC device 100 with the “time tolerant” feature” and “MTC device 100 with the “mobile originated only” feature” and the PDN connection established by the MTC device 100 which is neither “MTC device 100 with the “time tolerant” feature” nor “MTC device 100 with the “mobile originated only” feature”.

By containing the before time in the detailed data field, for example, it may be defined to release the already established PDN connection in the case where the MTC device 100 has the “time tolerant” feature and established the PDN connection or started the data transfer after the value (time) indicated by the before time. Here, the before time may indicate a value (time) such as “AM 11:00”. The before time may also indicate “MTC device establishing the PDN connection within the value (time) indicated by the before time, or the time elapsed from data transfer start”. In this case, the before time may indicate a value (time) such as “one minute”.

By containing the remaining amount of data (data remaining amount) to be transferred in the detailed data field, for example, it may be defined to release the already established PDN connection in the case where the MTC device 100 has the “time tolerant” feature and the remaining amount of data to be sent from the MTC device 100 exceeds the data remaining amount indicated by the network side. In this case, the data remaining amount may indicate a value such as “1 Mbyte”.

By containing the expected completion time (remaining time) in the detailed data field, for example, it may be defined to release the already established PDN connection in the case where the MTC device 100 has the “time tolerant” feature and the expected data sending completion time (remaining time) expected by the MTC device 100 exceeds the expected completion time (remaining time) contained in the sending control message broadcast from the eNB 110. In this case, the expected completion time may indicate a value such as “AM 11:15”, and the remaining time may indicate a value such as “one minute”. Information that can be obtained from an application showing a time to data download completion or the like may be used for the expected completion time or the remaining time.

By containing the QCI or the ARP in the detailed data field, for example, it may be defined to release the PDN connection in the case where the MTC device 100 has the “time tolerant” feature and the QCI or the ARP of the PDN connection or the EPS bearer used in the currently sent data is equal to or less than the value indicated by the detailed data field. The QCI or the ARP contained in the detailed data field by the communication system entity (e.g. the eNB 110, the MME 120, the SGW 130, the PGW 140) or the MTC server 150 may be determined using, for example, the subscription data, the context in which the information of the MTC device 100 is registered, or data obtained from a PCRF (Policy and Charging Rules Function, not shown in FIG. 1) for managing charging rules and the like. For example, the MME 120 may obtain the subscription data of the MTC device 100 which is the destination of the sending control message from the HSS 125, derive an average QCI or ARP of established PDN connections, and determine the QCI or the ARP contained in the detailed data field in view of the current congestion state.

To use the detailed PDN connection release condition contained in the detailed data field described above, the MTC device 100 needs to perform the following. In the case where the before time is contained, in order to use the before time, the MTC device 100 may store the data transfer start time or the PDN connection establishment time or activate a timer from such a time and measure the time to the reception of the broadcast sending control message.

In the case where the remaining amount of data (data remaining amount) is contained in the detailed data field, the MTC device 100 needs to recognize the remainder of the currently sent data. For example, the MTC device may calculate the data remaining amount by storing the total amount of data to be sent (e.g. 50 Mbytes) and the amount of data already sent.

In the case where the expected completion time (expected completion time of day) or the remaining time is contained in the detailed data field, the MTC device 100 needs to recognize the expected completion time of the currently sent data or the time required for sending completion. For example, the MTC device 100 may recognize the amount of data to be sent (e.g. 50 Mbytes), the sending rate (e.g. 1 Mbps), and the amount of data already sent (e.g. 40 Mbytes) beforehand, and estimate the expected completion time of data transfer (AM 1:01:20 when the current time is AM 11:00, as (50 Mbytes−40 Mbytes)×8 bits/1 Mbps=80 seconds) or the remaining time (80 seconds). Though an example of a simple equation is used here, an equation that takes into consideration a packet loss rate in an actual environment and the like may be used. Alternatively, the expected completion time or the remaining time may be obtained from an application being activated.

In the case where the QCI or the ARP is contained in the detailed data field, the MTC device 100 needs to recognize the QCI or the ARP of the currently used PDN connection. For example, the MTC device 100 may obtain the QCI or the ARP from the network entity (e.g. the eNB 110, the MME 120, the SGW 130, the PGW 140, the HSS 125) when the PDN connection (EPS bearer) is established (e.g. during an attach procedure or a bearer modification procedure), and compare it with the QCI or the ARP contained in the sending control message broadcast from the network side.

In the case where the MTC feature is contained in the detailed data field, the MTC device 100 needs to recognize each MTC feature which the MTC device 100 is provided with. For example, the MTC device 100 may have an MTC device 100 context, and register all MTC features of each MTC device 100 in the context. Alternatively, when the MTC device 100 establishes the PDN connection with the 3G access network (e.g. during an attach procedure), the MTC device 100 may recognize each MTC feature of the MTC device 100 by receiving, from the network side, report of each MTC feature that can be held by the MTC device 100 or each MTC feature designated by the MTC server/user.

Note that the detailed data field may be omitted from the format shown in FIG. 21, in the case of determining whether to maintain or release the PDN connection using only the time tolerant field without using the detailed data field.

To report “the MTC device 100 with the “time tolerant” feature to release the already established PDN connection”, an SIB (System Information Block) and paging in conventional art may be used. For instance, “the MTC device 100 with the “time tolerant” feature to release the already established PDN connection” may be reported by newly providing an SIB for MTC or modifying an existing SIB and instructing the MTC device 100 to read the SIB. Moreover, MBMS (Multimedia Broadcast and Multicast Service) in conventional art may be used to report to each MTC device 100.

The MTC device 100 receiving the report “the MTC device 100 with the “time tolerant” feature to release the already established PDN connection” checks whether or not the MTC device 100 has the “time tolerant” feature.

In the case where the MTC device 100 has the “time tolerant” feature and has already established the PDN connection, the MTC device 100 releases the PDN connection (step S1007 in FIG. 20: PDN connection release). Though the PDN connection is immediately released in the case where the MTC device 100 has the “time tolerant” feature and has already established the PDN connection in this example, the release timing may be set based on the policy of the MTC device and the communication system, the application specifications, or the like. Besides, when releasing the PDN connection, instead of completely releasing the PDN connection the MTC device 100 and the communication system entity (e.g. the eNB 110, the MME 120, the SGW 130, the PGW 140) may each hold the previous state (e.g. IP address, IMSI, IMEI, key information of the MTC device 100) for a predetermined time for reuse in order to reduce the time and processing load when establishing the PDN connection again.

In the example shown in FIG. 20, the MTC device B 100B is the MTC device 100 that has the “time tolerant” feature and has already established the PDN connection. Accordingly, upon receiving the sending control message in step S1006, the MTC device B 100B releases the already established PDN connection. Here, the MTC device B 100B may use a procedure in conventional art such as a UE-initiated detach procedure or a UE requested bearer resource modification procedure defined in Non-patent Document 3, to release the established PDN connection.

Meanwhile, the MTC device 100 that does not have the “time tolerant” feature and has established the PDN connection (the MTC device A 100A and the MTC device C 100C in the example shown in FIG. 20) maintains the PDN connection. The MTC device 100 that has the “time tolerant” feature”, has no PDN connection, and is about to send a message (e.g. PDN connection establishment request) (the MTC device E 100E and the MTC device F 100F) delays the message sending timing as described above (e.g. (D) to (E) in FIG. 19).

There is an instance where subsequently a high priority emergency message (emergency request or emergency message) or application message is sent from the UE 105 or the like, or a PDN connection establishment request for message sending is sent from the UE 105 or the like (step S1008 in FIG. 20: data sending/PDN connection establishment request). Here, the UE 105 is able to send the message. Since resources (both the C-plane and the U-plane) are secured as a result of the MTC device B releasing the already established PDN connection in step S1007, the network side can accept the data or the PDN connection establishment request from the UE in step S1008.

Embodiment 8 of the present invention is not limited to only the MTC device 100 with the “time tolerant” feature, which may also be used in combination with the APN, the MTC group ID, the PLMN ID (Public Land Mobile Network ID) for identifying the network operator, the device type ID, the device ID, and the like.

Though Embodiment 8 of the present invention describes the case where the MTC device 100 releases the already established PDN connection after receiving the sending control message, the PDN connection may be released by the communication system entity (e.g. the eNB 110, the MME 120, the SGW 130, the PGW 140) or the MTC server 150 if the communication system entity (e.g. the eNB 110, the MME 120, the SGW 130, the PGW 140) or the MTC server 150 is capable of recognizing the PDN connection to be released (specific PDN connection) based on the subscription data, the context specific to the MTC device 100, or the information during message exchange (e.g. attach procedure). Here, a procedure in conventional art such as a PDN GW initiated bearer deactivation procedure or an MME-initiated detach procedure defined in Non-patent Document 3 may be used. For example, the communication system entity (e.g. the eNB 110, the MME 120, the SGW 130, the PGW 140) or the MTC server 150 may compare the PDN connection release condition (e.g. the MTC device 100 having the “time tolerant” feature and corresponding to the value indicated by the before time) calculated or obtained to secure resources for the high priority UE 105 or MTC device 100 with the stored time of PDN connection establishment by the MTC device 100, to determine the PDN connection to be released.

The following describes a structure of the MTC device 100 in Embodiment 8 of the present invention, with reference to FIG. 22. FIG. 22 is a diagram showing an example of the structure of the MTC device 100 in Embodiment 8 of the present invention.

In FIG. 22, the MTC device 100 at least includes: a communication processing unit 1110 that is connected to the communication system (e.g. E-UTRAN or UTRAN) and performs communication processing in a lower layer and packet communication processing of IP or the like in a higher layer; a broadcast message processing unit 1120 that processes a time tolerant field and a detailed data field of a sending control message broadcast from the network side; and a PDN connection processing unit 1130 that maintains or releases an already established PDN connection based on the result of the broadcast message processing unit 1120.

The MTC device 100 may also include a detailed data processing unit 1140 in the case where information is contained in the detailed data field of the sending control message. For example, in the case where the PDN connection is released based on the data sending start time using the before time, the detailed data processing unit 1140 has a function of storing the data sending start time in the MTC device 100 or a timer function. The detailed data processing unit 1140 may be incorporated in an existing processing unit (e.g. the broadcast message processing unit 1120).

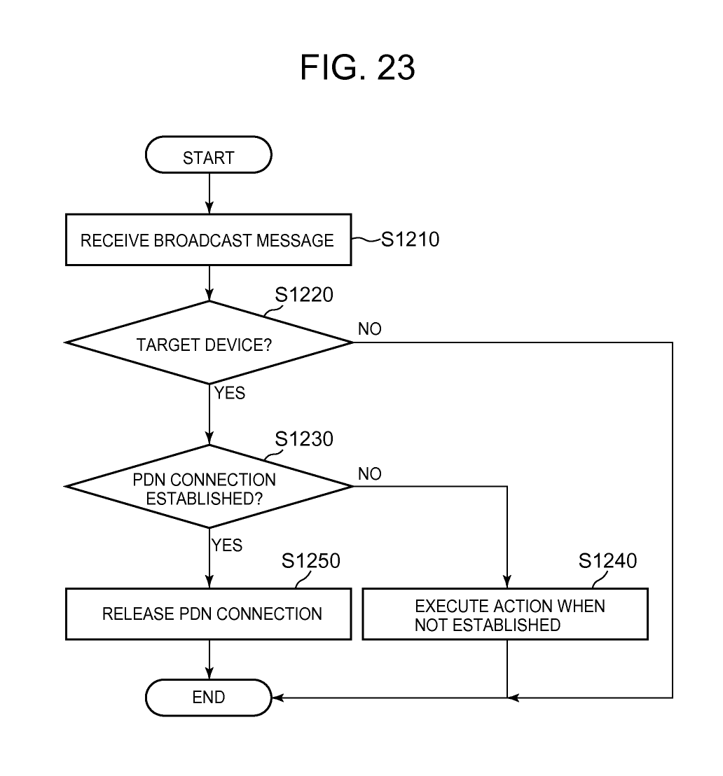

The MTC device 100 having the structure shown in FIG. 22 is described in detail below while mainly focusing on characteristic processing in the present invention, with reference to FIG. 23.

In FIG. 23, the MTC device 100 receives a message (sending control message) broadcast from the eNB 110 (step S1210 in FIG. 23). The MTC device 100 obtains information contained in the time tolerant field and the detailed data field of the broadcast message (sending control message) in the broadcast message processing unit 1120, to check whether or not the MTC device 100 is an MTC device 100 to release a PDN connection (step S1220 in FIG. 23).

In the case of determining that the MTC device 100 is not included in the target of the received broadcast message, the MTC device 100 ends the process without performing any special process.

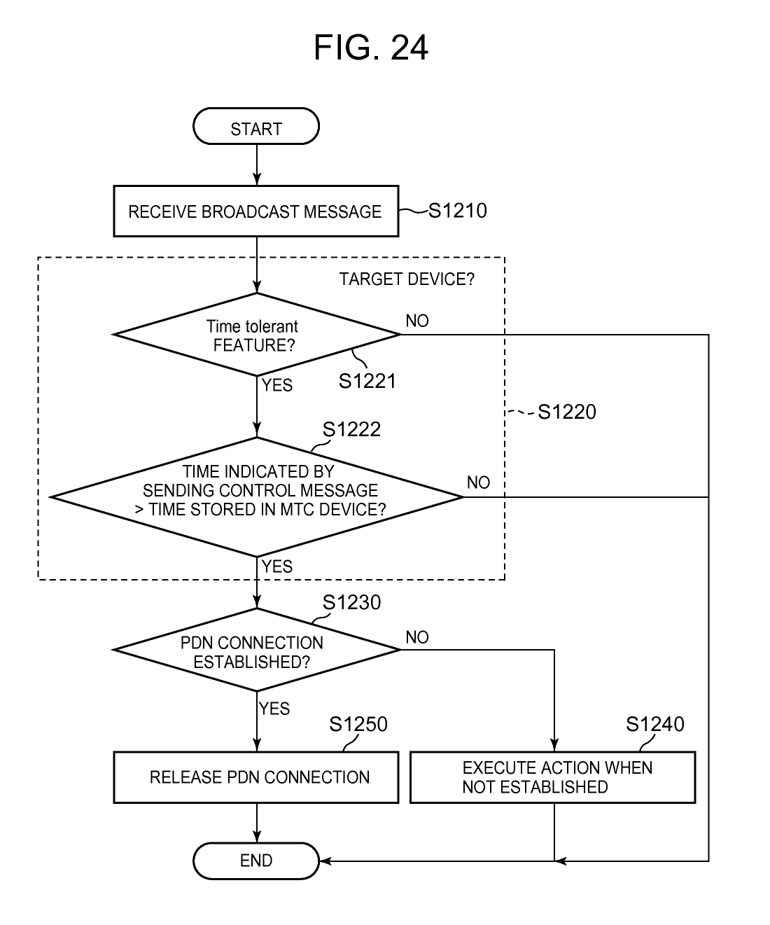

In the case of determining that the MTC device 100 is included in the target of the received broadcast message, on the other hand, the MTC device 100 further checks whether or not a PDN connection has been established between the MTC device 100 and the communication system (step S1230 in FIG. 23). A process flow of determining whether or not the MTC device 100 is included in the target of the broadcast message (step S1220 in FIG. 23) will be described in detail later (see FIG. 24).

In the case where the PDN connection has not been established between the MTC device 100 and the communication system, the MTC device 100 executes an operation corresponding to when the PDN connection is not established (e.g. the MTC device 100 with the “time tolerant” feature delays the PDN connection establishment request sending timing) (step S1240 in FIG. 23), before ending the process.

In the case where the PDN connection has been already established between the MTC device 100 and the communication system, on the other hand, the MTC device 100 releases the already established PDN connection in the PDN connection processing unit 1130 through the use of, for example, a UE-initiated detach procedure or a UE requested bearer resource modification procedure defined in Non-patent Document 3 (step S1250 in FIG. 23).

The following describes the detailed flow when maintaining or releasing the PDN connection using the value contained in the detailed data field. An example where the before time indicating the time elapsed from the data transfer start is contained in the detailed data field is described in detail below, with reference to FIG. 24. FIG. 24 is a flowchart for detailed description of step S1220 in FIG. 23.

In FIG. 24, the MTC device 100 receives a message (sending control message) broadcast from the eNB 110 (step S1210 in FIG. 24). The MTC device 100 checks the time tolerant field of the broadcast message (sending control message), to check whether or not the MTC device 100 is an MTC device 100 to release a PDN connection (step S1221 in FIG. 24). Here, the MTC device 100 may check whether or not the MTC device 100 has the “time tolerant” feature, from information set at the time of manufacture (e.g. MTC device 100 context in which a list of MTC features is registered), information reported from the network side during an attach procedure (e.g. MTC features set by the operator of the communication system or MTC features set by the MTC user), or the like.

In the case of determining that the MTC device 100 does not have the “time tolerant” feature, the MTC device 100 ends the process without performing any special process.

In the case of determining that the MTC device 100 has the “time tolerant” feature, on the other hand, the MTC device 100 further obtains the value (time) of the before time in the detailed data field of the sending control message. It is assumed here that the MTC device 100 has already established the PDN connection, and the MTC device 100 stores the PDN connection establishment time or the start time of data transfer on the established PDN connection or activates a timer and measures the time to reception of the sending control message.

The MTC device 100 compares the value (time) of the before time in the detailed data field of the sending control message with the stored (or measured) value (time), to determine whether or not to release the PDN connection (step S1222 in FIG. 24). For example, in the case where the value (time) of the before time in the detailed data field of the sending control message is “AM 11:00” and the value (time) stored (or measured) by the MTC device 100 is “AM 10:55” (the condition “(time indicated by sending control message)>(time stored (measured) in MTC device 100)” is not met), the MTC device 100 determines that the MTC device 100 is not included in the target of the sending control message because the MTC device 100 has started communication before the value (time) determined by the network side. As a result, the MTC device 100 maintains the PDN connection without performing any special process. Note that the present invention is not limited to the form such as “AM 11:00”, and the form such as “one minute ago” may instead be used.

In the case where the condition “(time indicated by sending control message)>(time stored (measured) in MTC device 100)” is met, on the other hand, the MTC device 100 determines that the MTC device 100 is included in the target of the sending control message because the MTC device 100 has started communication after the value (time) determined by the network side. As a result, the MTC device 100 releases the established PDN connection (steps S1230 and S1240 in FIG. 24).

Though the PDN connection release using the detailed data field is described using the before time as an example, the same process is performed for other conditions such as the data remaining amount and the remaining time (e.g. the use of the before time in step S1222 in FIG. 24 is changed to the condition “(data remaining amount indicated by sending control message)>(data remaining amount calculated in MTC device)”). Combining the before time and the data remaining amount can provide a more detailed condition for determining whether to maintain or release the PDN connection. For example, after narrowing down the range by determining whether or not to release the PDN connection using the before time, whether or not to release the PDN connection may be further determined depending on the data remaining amount.

When Embodiment 8 of the present invention is combined with the low priority indicator defined in Non-patent Document 6, it is possible to achieve stepwise PDN connection release such that, when the network is congested, the PDN connection established by the MTC device 100 having the low priority indicator is released first and the PDN connection established by the MTC device 100 having the “time tolerant” feature is released next. This enables stepwise securing of resources, so that excessive PDN connection release can be prevented. As an example, the above-mentioned process may be realized in such a manner that the communication system entity (e.g. the eNB 110, the MME 120, the SGW 130, the PGW 140, the HSS) recognizes the MTC device 100 sending the PDN connection establishment request containing the low priority indicator by registering it in the MTC device context or in the subscription data. By recognizing the MTC device 100 having the low priority indicator, the communication system entity may designate only the MTC device 100 having the low priority indicator as the destination of the sending control message sent by broadcasting.

The PDN connection to be realized may also be determined using a low priority indicator field instead of the time tolerant field, rather than combining the time tolerance field with the low priority indicator. Here, the low priority indicator field may be used in combination with the detailed data field.

For example, when the MME 120 detects congestion, the MME 120 first sends an instruction to release the PDN connection established by the MTC device 100 having the low priority indicator to the eNB 110, and the eNB 110 broadcasts the sending control message to each target MTC device 100. The MTC device 100 that receives the sending control message and has the low priority indicator releases the established PDN connection.

At this time, if it is determined that secured resources are insufficient (e.g. a threshold for congestion is exceeded), the MME 120 reports to the eNB 110 that the already established PDN connection is to be released using the time tolerant field (e.g. “with the “time tolerant” feature”) and the detailed data field (e.g. “mobile originated only”), and the eNB 110 broadcasts the sending control message to each target MTC device 100. The MTC device 100 that receives the sending control message and has the “time tolerant” and “mobile originated only” features releases the established PDN connection. This enables stepwise securing of resources, so that excessive PDN connection release can be prevented.

Though Embodiment 8 of the present invention is based on the premise that part of the MTC devices 100 (the MTC device B 100B, the MTC device D 100D, the MTC device E 100E, and the MTC device F 100F) have the “time tolerant” feature, the present invention is also applicable in the case where all MTC devices 100 have the “time tolerant” feature.

In the case where all MTC devices 100 have the “time tolerant” feature, the PDN connection release cannot be determined depending on whether or not the MTC device 100 has the “time tolerant” feature. Accordingly, the PDN connection release is determined using the condition contained in the detailed data field in FIG. 21. For example, in an environment in which all MTC devices 100 have the “time tolerant” feature, the broadcast message to release the PDN connection established by the MTC device 100 having the “time tolerant” feature and having the “mobile originated only” feature corresponds to the sending control message to release the PDN connection established by the MTC device 100 having the “mobile originated only” feature. Likewise, in an environment in which all MTC devices 100 have the “time tolerant” feature, the sending control message to release the PDN connection established by the MTC device 100 having the “time tolerant” feature and meeting the condition “(time indicated by sending control message)>(time stored in MTC device 100)” corresponds to the sending control message to release the PDN connection established by the MTC device 100 meeting the condition “(time indicated by sending control message)>(time stored in MTC device 100)”. Therefore, the time tolerant field in FIG. 21 for identifying the MTC device 100 having the “time tolerant” feature can be omitted from the sending control message broadcast by the eNB 110.

As described above, according to Embodiment 8 of the present invention, in view of the problem that more resources (both the U-plane and the C-plane) become necessary in the case where a high priority emergency message (emergency request or emergency message) or application message is sent from the UE 105 or the like when congestion already occurs on the network side or congestion begins to occur upon reception of a message (e.g. PDN connection establishment request, transfer data), an already established PDN connection is maintained or released according to a message broadcast from the network side, based on whether or not the MTC device 100 has the “time tolerant” feature and based on a value (e.g. time elapsed from data transfer start indicated by “before time”) in the detailed data field. Thus, resources for a request or an application of a high priority level can be secured.

Moreover, by broadcasting the message from the network side (e.g. the eNB 110, the MME 120, the SGW 130, the PGW 140, the MTC server 150) to each target MTC device 100 (e.g. each MTC device 100 connected to a specific APN, each MTC device 100 belonging to a specific MTC group, each MTC device 100 belonging to a specific operator, or a specific area (e.g. each MTC device 100 connected to a specific eNB 110 or MME 120)), it is possible to avoid a message (e.g. PDN connection establishment request) which the MTC device 100 is about to be sent. This contributes to a reduced processing load and traffic of the network entity (e.g. the eNB 110, the MME 120, the SGW 130, the PGW 140, the MTC server 150).

In the above embodiments, the network entity (e.g. the eNB 110, the MME 120, the SGW, the PGW, the MTC server 150) broadcasts the message (e.g. the reverse event report message in Embodiments 1 to 7 of the present invention, the sending control message in Embodiment 8 of the present invention). There is an instance where the network entity (e.g. the eNB 110, the MME 120, the SGW 130, the PGW 140, the MTC server 150) contains, in the broadcast message, a wait time (referred to as stop time, barring time, backoff time, or wait time) for delaying a message sent by the MTC device 100, as defined in Non-patent Document 6. The MTC device 100 is unable to send data or a message such as a PDN connection establishment request during the wait time (e.g. the MTC device 100 transitions from the normal mode to a data sending suppression mode, regulation mode, or restriction mode). Though message sending is suppressed by the network side, in the case of detecting an event of a high priority level or in the case of an emergency, the MTC device 100 can transition to a mode (e.g. normal mode) of being able to send data or a PDN connection establishment request. The wait time may be used in combination with the PDN connection maintenance/release condition (e.g. before time) contained in the detailed data field. For example, by setting the wait time to “three minutes”, it is possible to suppress a message (e.g. PDN connection establishment request) from an MTC device of a low priority level for three minutes while simultaneously instructing to release an established PDN connection within three minutes. In such a case, the detailed data field can be omitted, with it being possible to reduce the processing load on the communication entities and the MTC device 100 and the network traffic load.

In the above embodiments (Embodiment 8 in particular), in the case where the MTC device 100 and the network entity are capable of recognizing different priority levels (e.g. data of application A has priority level A and a message from the UE 105 has priority level B), the network entity (e.g. the eNB 110, the MME 120, the SGW 130, the PGW 140, the MTC server 150) may suppress message sending according to priority level. As an example, the eNB 110 contains a parameter indicating to “suppress only priority level B” in the sending control message to be broadcast. Upon receiving the sending control message, the MTC device 100 delays/stops sending of only a message of priority level B, or changes the priority level of the message and sends the message. The parameter indicating to “suppress only priority level B” may be used in combination with a parameter indicating to “exclude the MTC device 100 belonging to MTC group A”. Moreover, not only the priority level but also, for example, an access class in conventional art may be used to suppress a message sent from the MTC device 100.

Though the MTC device 100 in the above embodiments (Embodiments 1 to 8 in particular) belongs to one MTC group, one APN, or one PLMN operator, the MTC device 100 may belong to a plurality of MTC groups, a plurality of APNs, or a plurality of PLMN operators. In the case where the MTC device 100 is connected to two APNs (APN-1 and APN-2), the communication system can suppress a message sent from the MTC device 100 in a stepwise manner. For example, the network entity (e.g. the eNB 110, the MME 120, the SGW 130, the PGW 140, the MTC server 150) contains a parameter indicating to “suppress sending message using APN-1”, in the sending control message or the reverse event report message to be broadcast. As a result, the MTC device 100 is forbidden to perform message sending using APN-1, but allowed to perform message sending using APN-2.

Though Embodiment 8 of the present invention mainly describes the case of releasing the already established PDN connection using the “time tolerant” field and the detailed data field for ease of explanation, instead of determining to release the already established PDN connection, the already established PDN connection may be determined to be “maintained” depending on the policy of the operator of the communication system, the policy of the MTC server or the MTC user, the policy of the application, or the policy of the MTC device.

Though Embodiment 8 of the present invention describes the case where the MTC device 100 having the “time tolerant” feature and meeting the condition designated in the detailed data field releases the PDN connection in the case where the MTC device 100 has already established the PDN connection (steps S1221, S1222, S1230, S1250 in FIG. 24), only the data sending may be controlled (e.g. stop, data rate change, data size change, etc.) without releasing the PDN connection (i.e. while maintaining the PDN connection). This enables U-plane resources to be secured in a stepwise manner. In addition, since the PDN connection is not released, there is no need to establish the PDN connection again, which contributes to a reduced processing load on the communication system entities (e.g. the eNB 110, the MME 120, the SGW 130, the PGW 140) (e.g. address assignment, binding update).

Though Embodiment 8 of the present invention describes the case where the communication system entity broadcasts the message to each target MTC device 100 to release the PDN connection for securing resources for the high priority UE 105 or MTC device 100, the message may be sent not by broadcasting but by unicasting or multicasting.

In Embodiment 8 of the present invention, as a result of the MTC device D 100D sending the PDN connection establishment request to the network side (step S1002 in FIG. 20), the network becomes congested (step S1003 in FIG. 20), so that the sending control message is sent to each MTC device (step S1006 in FIG. 20), as described with reference to FIGS. 19 and 20. That is, the sending control message is used to avoid a message (e.g. PDN connection establishment request) from the MTC device 100 of the low priority level and request to release the already established PDN connection when the network is congested. The sending control message may further be used to reject or delay another PDN connection establishment request which is likely to be newly sent from the MTC device 100 that has already established the PDN connection. In the case of using the sending control message to delay the new PDN connection establishment request, upon congestion detection the communication system entity broadcasts the sending message including the wait time to each target MTC device. This wait time contained as parameter information in the sending control message broadcast from the network side is used as information instructing to delay the timing of sending the additional PDN connection establishment message from the MTC device 100 that has already established the PDN connection (the MTC device A 100A, the MTC device B 100B, the MTC device C 100C, the MTC device D 100D). Upon receiving the sending control message, in the case where the MTC device 100 has the already established PDN connection and wants to newly establish another PDN connection, the MTC device 100 determines to delay the sending of the PDN connection establishment request until the wait time elapses. For example, in the case where the MTC device 100 that has already established one PDN connection is about to newly establish an additional PDN connection, the MTC device 100, as a result of receiving the sending control message, delays sending an establishment request for the second PDN connection until after the wait time.

Moreover, the MTC device 100 that has already established the PDN connection may be kept from sending the additional PDN connection establishment request as a result of receiving the sending control message that does not contain the wait time. For example, the sending of the additional PDN connection establishment request by the MTC device 100 can be avoided by containing a parameter indicating to “forbid additional establishment” in the sending control message.

In the case where the MTC device 100 that has already established the PDN connection receives the sending control message that does not contain the wait time but contains a parameter for the PDN connection to be added by the MTC device 100 (e.g. maximum number of PDN connections establishable by each MTC device 100, QoS assignable to the additional PDN connection, etc.), the MTC device 100 sends the PDN connection establishment request according to this information when establishing the additional PDN connection.

Suppose the maximum number of simultaneously establishable PDN connections is included in the parameter information. The MTC device 100 compares the number of PDN connections which the MTC device 100 wants to establish with the maximum number of simultaneously establishable PDN connections contained in the sending control message and, in the case where the number of PDN connections which the MTC device 100 wants to establish exceeds the number of simultaneously establishable PDN connections, establishes the new PDN connection after the already established PDN connection ends. In detail, when the MTC device 100 that wants to establish the second PDN connection receives parameter information indicating that the number of simultaneously establishable PDN connections is one, the PDN device 100, after the communication using the already established first PDN connection ends, releases the first PDN connection and then newly establishes the second PDN connection. In the case of establishing the third PDN connection, the MTC device 100, after the communication using the second PDN connection ends, releases the second PDN connection and then newly establishes the third PDN connection. As an alternative, the MTC device 100 may determine to immediately release the already established PDN connection when the need to establish the new PDN connection arises. Instead of the number of simultaneously establishable PDN connections, information indicating that additional PDN connection establishment is limited may be included in the sending control message as the parameter information. The MTC device 100 receiving this information sends the request to establish the new PDN connection after releasing the already established PDN connection, in the case of establishing the new PDN connection.

This has an advantageous effect that, in the case where the MTC device 100 needs to establish a plurality of PDN connections (e.g. the MTC device 100 is connected to a plurality of MTC servers 150, a plurality of APNs, or a plurality of MTC users 160 and is required to use different PDN connections due to the MTC users' information security levels or contractual relationships), band occupancy caused by simultaneously establishing a plurality of PDN connections can be prevented by limiting the number of simultaneously establishable PDN connections.

In the case where the wait time is contained in addition to the parameter for the PDN connection to be added by the MTC device 100 (e.g. maximum number of PDN connections establishable by each MTC device 100, QoS assignable to the additional PDN connection, etc.), using the wait time as a duration of application (valid time) of the parameter for the PDN connection to be added by the MTC device 100 (e.g. maximum number of PDN connections establishable by each MTC device 100, QoS assignable to the additional PDN connection, etc.) enables resource management to be performed in accordance with the network congestion state that varies in real time. Suppose the wait time (e.g. “one minute”) and the information indicating that “the number of PDN connections establishable by each MTC device 100 is one” are contained in the sending control message broadcast from the network side. In the case of sending the new PDN connection establishment request within one minute after reception of the sending control message, the MTC device 100 that receives the sending control message releases the already established PDN connection and then establishes the additional PDN connection. After the wait time, the information indicating that “the number of PDN connections establishable by each MTC device 100 is one” need not be used for additional PDN connection establishment because its duration of application expired. The MTC device 100 that receives the sending control message containing the additional PDN connection-related parameter may, when establishing the additional PDN connection, determine whether to withdraw from establishing the additional PDN connection and maintain the already established PDN connection or release the already established PDN connection and establish the additional PDN connection, for example based on the application specifications or the context (e.g. static information or request from the MTC server 150 or the MTC user 160) held by the MTC device 100.

The information indicating that “the number of PDN connections establishable by each MTC device 100 is one” may be contained in the detailed data field of the sending control message.

The message reporting the additional PDN connection-related parameter to the MTC device 100 that has already established the PDN connection may be sent not by broadcasting but by unicasting. In such a case, when establishing the first PDN connection (e.g. during an attach procedure), the MTC device 100 receives the sending control message including the additional PDN connection-related parameter (e.g. maximum number of PDN connections establishable by each MTC device 100, QoS assignable to the additional PDN connection, etc.) from the communication system entity. Having obtained the parameter information, the MTC device 100 sends the PDN connection establishment request for establishing the additional PDN connection according to the obtained parameter information as described above.

The timing of reporting the additional PDN connection-related parameter information to the MTC device 100 is not limited to when the first PDN connection establishment request is received from the MTC device 100, but may be an arbitrary timing after the PDN connection establishment. That is, when the network side detects congestion, the parameter information is reported to the MTC device 100 that has already established the PDN connection. Moreover, when the additional PDN connection establishment request is received from the MTC device 100, the sending control message reporting that the establishment request is rejected and including the additional PDN connection-related parameter information may be sent to the MTC device 100.

### Embodiment 9

In Embodiment 9 of the present invention, the MTC device 100 that has already established a PDN connection and wants to further establish an additional PDN connection releases the already established PDN connection and establishes the additional PDN connection based on congestion-related information sent from the network.

There is a situation where the MTC device 100 wants to newly establish a PDN connection and send data even when the network is congested. An example of this is the case where the MTC device 100, which is a human sensor and sends maintenance data for checking if the sensor is not malfunctioning and sensing data actually obtained by the sensor to different MTC servers 150, has already established a PDN connection for maintenance and wants to establish a PDN connection for sensing data only for an arbitrary time period. Another example of this is the case where the MTC device 100, which is a vending machine and uses different PDN connections for connecting to the MTC server 150 and for connecting to an IMS (IP Multimedia Subsystem), has already established a PDN connection for connecting to the MTC server 150 and wants to establish a PDN connection for connecting to the IMS at an arbitrary timing. However, there is a possibility that the network detects congestion during a time from when the first PDN connection is established to when the additional PDN connection is established. When this happens, the additional PDN connection establishment request sent from the MTC device 100 is rejected. Here, the data to be sent using the additionally established PDN connection may have a higher priority level than the data being sent using the already established PDN connection. In such a case, the failure of the MTC device 100 to establish the additional PDN connection causes a disadvantage that high priority data cannot be communicated between the MTC device 100 and the MTC server 150, the MTC user 160, or the like. To solve this problem, the MTC device 100 that has already established the PDN connection releases the already established PDN connection and establishes the additional PDN connection based on congestion-related information sent from the network.

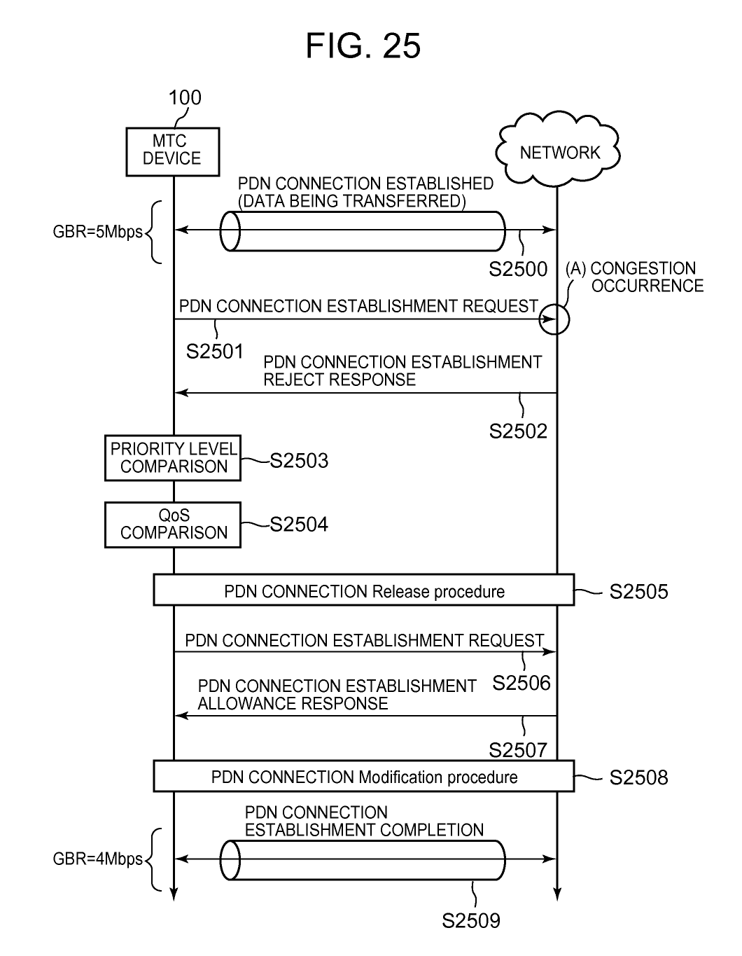

The following describes Embodiment 9 of the present invention with reference to FIGS. 25, 26, 27A to 27E, 28 to 30, 35, and 36.

It is assumed that the MTC device 100 in Embodiment 9 of the present invention has already established one PDN connection with the network and a bit rate (GBR: Guaranteed Bit Rate) guaranteed by the network for an EPS bearer in the already established PDN connection is 5 Mbps, for ease of explanation of Embodiment 9 of the present invention. The MTC device 100 sends a PDN connection establishment request to establish an additional PDN connection.

“GBR=5 Mbps” means that the network guarantees the bit rate of 5 Mbps for the MTC device 100. For example, while the GBR of 5 Mbps is assigned to the MTC device 100, the network does not provide a bit rate (e.g. 4 Mbps) less than 5 Mbps to the MTC device 100.

An operation of the MTC device 100 that has already established the PDN connection including the EPS bearer to which “GBR=5 Mbps” is assigned is described below, with reference to FIG. 25.

In FIG. 25, it is assumed that the MTC device 100 that has already established the PDN connection including the EPS bearer to which “GBR=5 Mbps” is assigned tries to establish the additional PDN connection (step S2500). To establish the additional PDN connection, the MTC device 100 sends a PDN connection establishment request (step S2501: PDN connection establishment request). When establishing the PDN connection, the MTC device 100 may use, for example, a PDN connectivity request message, a service request, or a create bearer request message defined in Non-patent Document 3.

Suppose congestion occurs on the network side that receives the PDN connection establishment request ((A) congestion occurrence in FIG. 25). The network accordingly sends a PDN connection establishment reject response to reject the PDN connection establishment request sent from the MTC device 100 in step S2501 (step S2502: PDN connection establishment reject response).

The MTC device 100 whose additional PDN connection establishment request is rejected compares a priority level of the additional PDN connection and a priority level of the already established PDN connection (step S2503: priority level comparison). Note that each PDN connection priority level may be obtained using a priority level assigned to each application, which can be acquired from the application layer, a policy held in the MTC device 100, information statically stored in the MTC device 100 for MTC (e.g. an application activated first is processed with priority), or the like.

In the case of determining that the additional PDN connection has a higher priority level, the MTC device 100 compares QoS information (e.g. GBR information) assigned to the EPS bearer of the already established PDN connection and QoS information (e.g. GBR information) necessary for an EPS bearer of the additional PDN connection, in order to check whether or not the additional PDN connection can be established instead of the already established PDN connection (step S2504: QoS comparison).

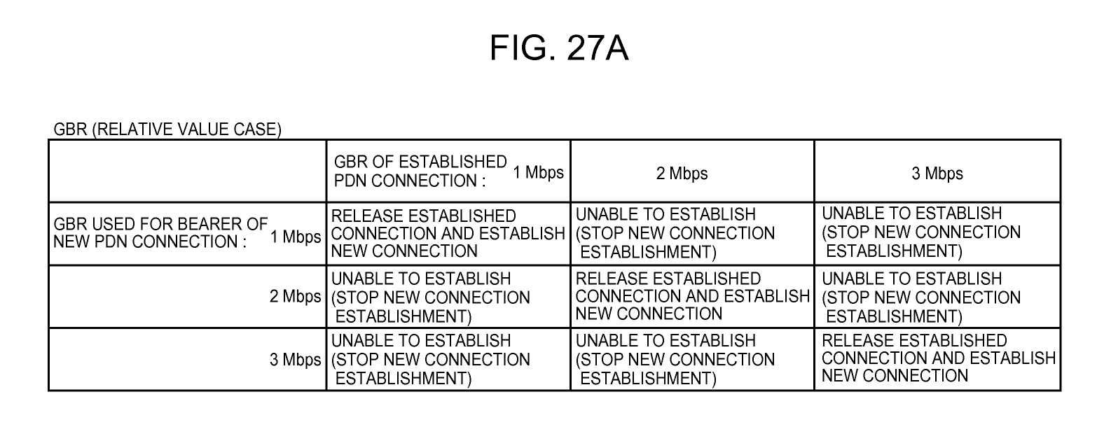

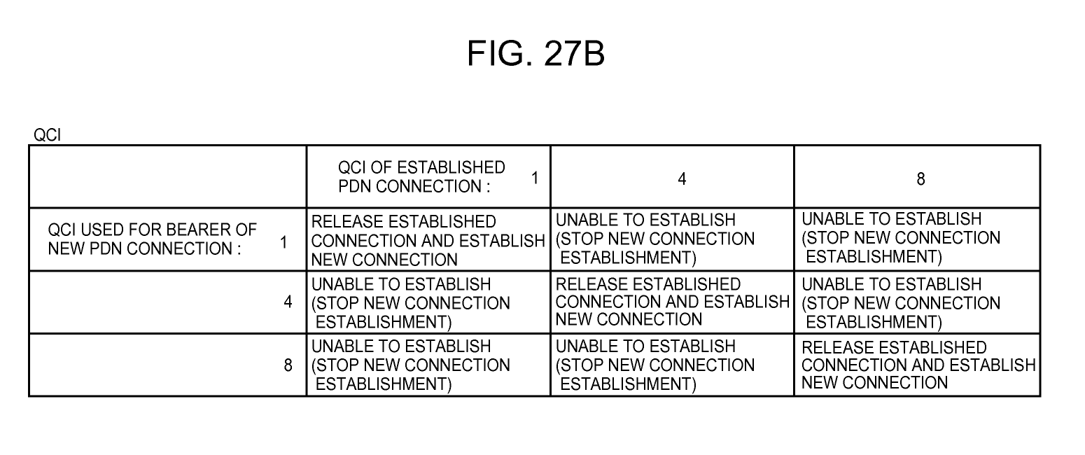

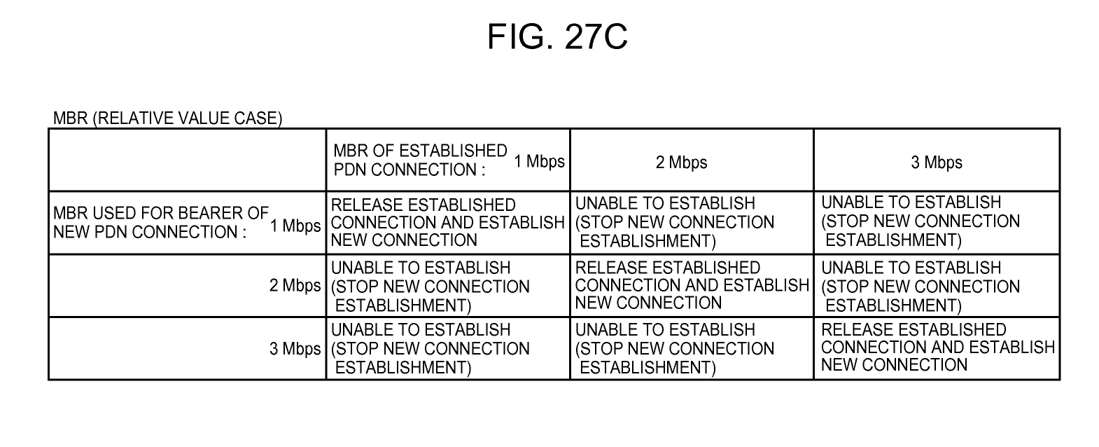

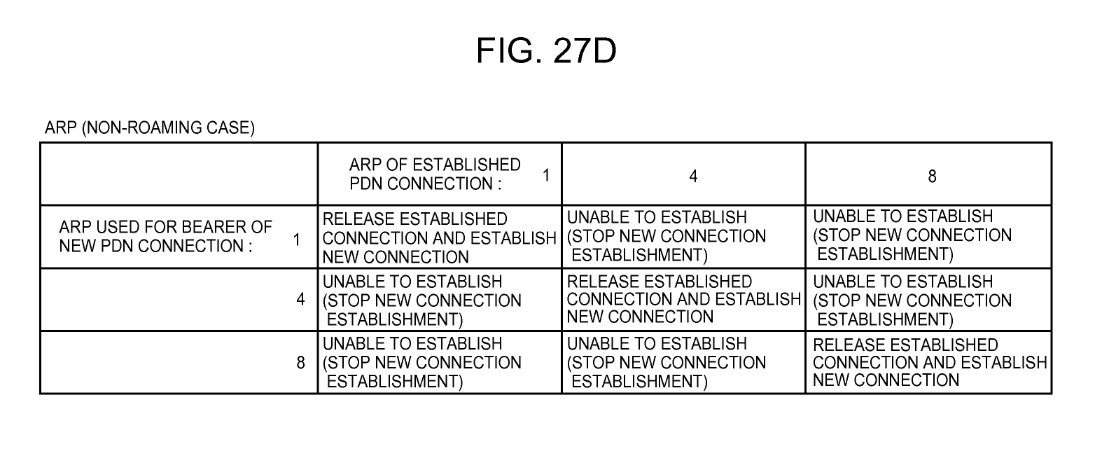

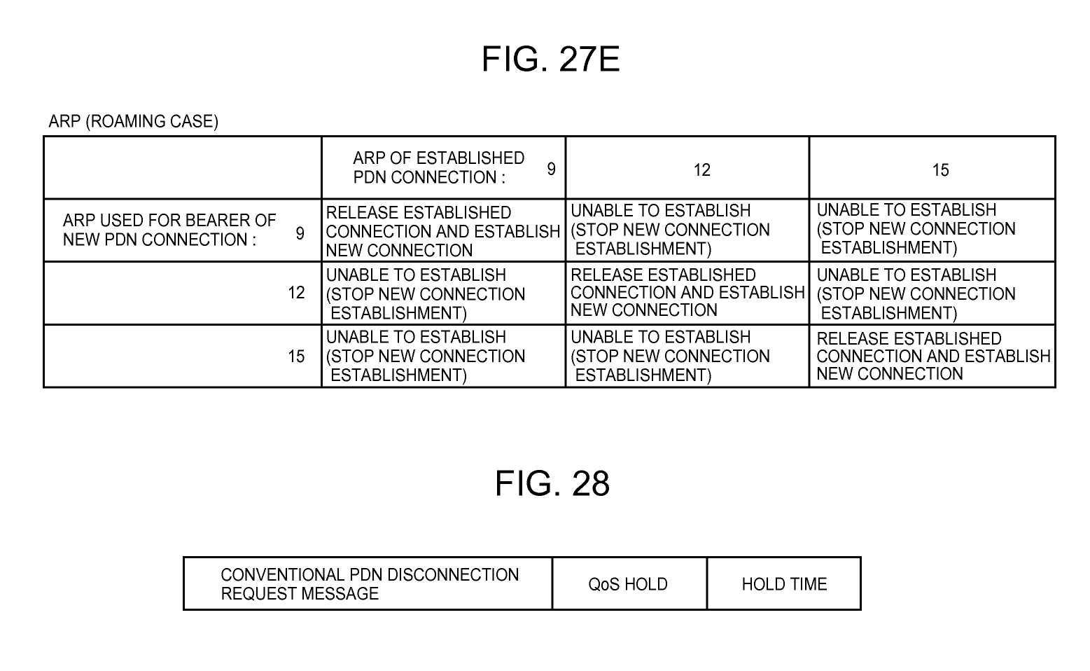

For example, in GBR comparison, in the case where the GBR necessary for the EPS bearer of the additional PDN connection is equal to or less than 1 Mbps when the GBR assigned to the EPS bearer of the already established PDN connection is 1 Mbps, the MTC device 100 can establish the additional PDN connection by releasing the already established PDN connection, as shown in FIG. 27A. Though conventionally the MTC device 100 cannot establish the additional PDN connection, the MTC device 100 releases the already established PDN connection and then establishes the additional PDN connection in the case of recognizing that the additional PDN connection has a higher priority level than the already established PDN connection.

In QCI comparison, in the case where the QCI of the additional PDN connection matches the QCI assigned to the already established PDN connection, the MTC device 100 can establish the additional PDN connection by releasing the already established PDN connection, as shown in FIG. 27B. It may also be determined that the MTC device 100 can establish the additional PDN connection by releasing the already established PDN connection in the case where the QCIs match and also the GBR of the already established PDN connection is more than the GBR of the additional PDN connection. As described above with regard to the GBR, though conventionally the MTC device 100 cannot establish the additional PDN connection, the MTC device 100 releases the already established PDN connection and then establishes the additional PDN connection in the case of recognizing that the additional PDN connection has a higher priority level than the already established PDN connection.

A plurality of pieces of QoS information may be used to determine whether or not the MTC device 100 can release the already established PDN connection and establish the additional PDN connection. For example, the MTC device 100 may use the GBR and the MBR as QoS information. In the first step, the MTC device 100 checks whether or not the GBR used for the bearer of the additionally established PDN connection is equal to or less than the GBR used for the bearer of the already established PDN connection. In the case where the GBR is equal to or less than the GBR used for the bearer of the already established PDN connection, the MTC device 100 equally checks the MBR following the GBR. In the case where the MBR is equal to or less than the MBR used for the bearer of the already established PDN connection, too, the MTC device 100 determines that the additional PDN connection can be established using resources secured by releasing the already established PDN connection, and releases the already established PDN connection. The MTC device 100 then establishes the new PDN connection.

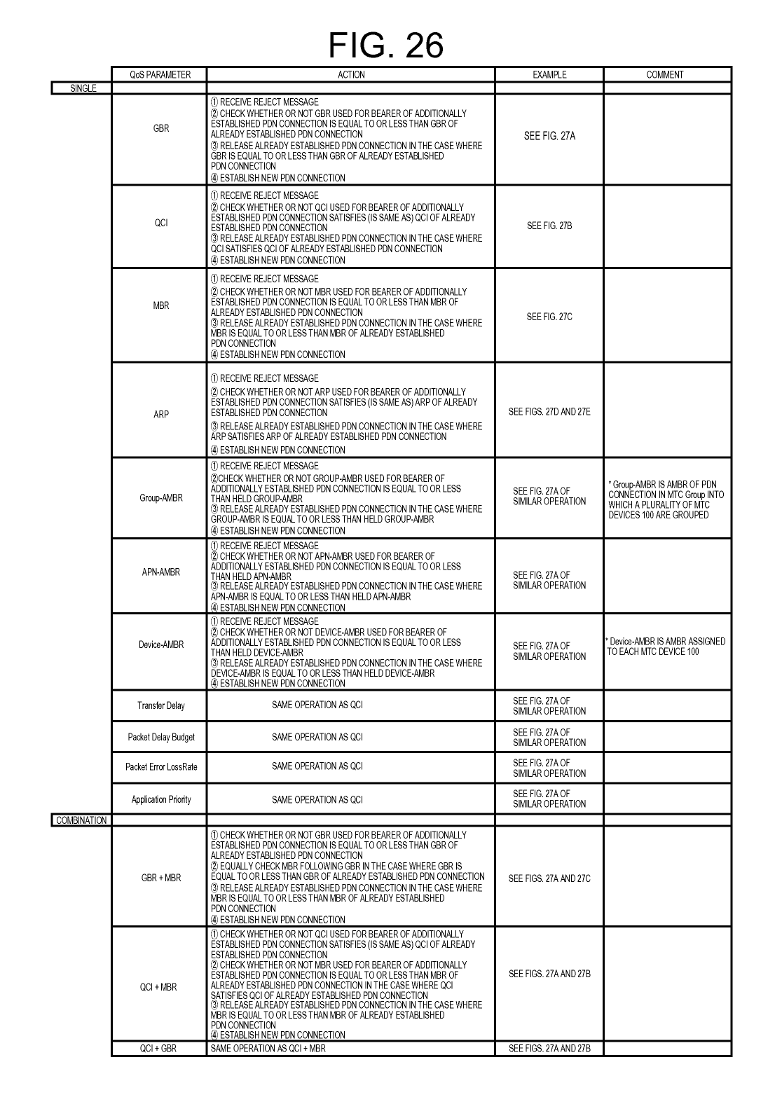

Though the above describes the use of the GBR, the QCI, and the MBR in the QoS information comparison process, FIG. 26 and FIGS. 27A to 27E respectively show actions and action results including examples relating to other QoS information.

Though the above describes the QoS comparison process based on an assumption that the MTC device 100 has already established one PDN connection, in a state where the MTC device 100 has already established a plurality of PDN connections, the MTC device 100 can establish the additional PDN connection in the case where a sum total (e.g. GBR sub total) of QoS information assigned to each PDN connection or the EPS bearer of each PDN connection or both of them (e.g. QCI matching bearer case) satisfy the QoS information necessary for the additionally established PDN connection. Here, the MTC device 100 may release all established PDN connections, or select two or more PDN connections that need to be released to secure the QoS information necessary for the additional PDN connection and release the selected PDN connections.

The QoS information necessary for the additional PDN connection or EPS bearer may be obtained, for example, from the MTC service application, the policy held by the MTC device 100, the information statically stored in the MTC device 100 for MTC, or the information directly reported from the MTC server 150 or the MTC user 160.

If the QoS information (GBR information) of the EPS bearer of the additionally established PDN connection is equal to or less than the QoS information (GBR information) assigned to the EPS bearer of the already established PDN connection as a result of the comparison in step S2503 (e.g. the GBR information assigned to the EPS bearer of the already established PDN connection is 5 Mbps and the GBR information necessary for the EPS bearer of the additionally established PDN connection is 4 Mbps), the MTC device 100 releases the already established PDN connection (step S2505: PDN connection release procedure). When releasing the already established PDN connection, the MTC device 100 may use, for example, a UE requested PDN disconnection procedure, a UE-initiated detach procedure, or a UE requested bearer resource modification procedure defined in Non-patent Document 3.

There is a possibility that the resources secured as a result of the MTC device 100 releasing the PDN connection are assigned to not the MTC device 100 but another MTC device or UE. In view of this, upon releasing the already established PDN connection, the MTC device 100 reports to the network that the QoS information (GBR) information assigned to the EPS bearer of the released PDN connection is reused for the PDN connection to be newly established.

FIG. 28 shows an example of a format of a message by which the MTC device 100 reports to the network side that the resources (QoS information) assigned to the EPS bearer of the released PDN connection are reused for the newly established PDN connection, using the UE requested PDN disconnection procedure.

The message shown in FIG. 28 has, in addition to a conventional PDN disconnection request message field, a QoS hold field for reporting not to assign the QoS information (GBR information) to another MTC device 100 or UE 105, and a hold time field indicating a time for holding the QoS information on the network side as requested by the MTC device 100.

In FIG. 25, after releasing the already established PDN connection, the MTC device 100 sends a PDN connection establishment request (step S2506: PDN connection establishment request). It is assumed here that the network side is capable of identifying the MTC device 100 as an MTC device 100 that tries to newly establish the PDN connection using the resources secured by the PDN connection release. For example, the MTC device 100 may be identified using the IMSI or IMEI of the MTC device 100 contained in the PDN connection establishment request, a new identifier exchanged during the PDN connection release procedure, or the like.

Upon receiving the PDN connection establishment request in step S2506, the network recognizes that the MTC device 100 is an MTC device 100 that tries to newly establish the PDN connection using the resources secured by the PDN connection release, and sends a PDN connection establishment allowance response (step S2507: PDN connection establishment allowance response).

After the PDN connection establishment, the MTC device 100 executes a PDN connection modification procedure, to modify to the QoS information (GBR information) used for the EPS bearer of the PDN connection established in step S2507 (step S2508). It is assumed that the network is capable of identifying the MTC device 100 as an MTC device 100 relating to the secured resources in this step as in step S2506. In the case where, after the QoS information comparison in step S2504, the MTC device 100 can secure a PDN connection equal to the new PDN connection just by performing the PDN connection modification procedure without performing the process of releasing the already established PDN connection and establishing the new PDN connection, steps S2505 to 2507 may be omitted.

After updating the QoS information of the already established PDN connection, the MTC device 100 ends the PDN connection establishment process (step S2509: PDN connection establishment completion).

In Embodiment 9, when the MTC device 100 sends the additional PDN connection request, the network detects congestion and rejects the PDN connection establishment. Alternatively, for example when congestion occurs due to data sent from another MTC device 100 or UE 105, the network may report, by a broadcast message, the additional PDN connection establishment rejection to a plurality of MTC devices 100 or UEs 105 such as MTC devices 100 belonging to the same MTC group or connected to the same eNB 110.

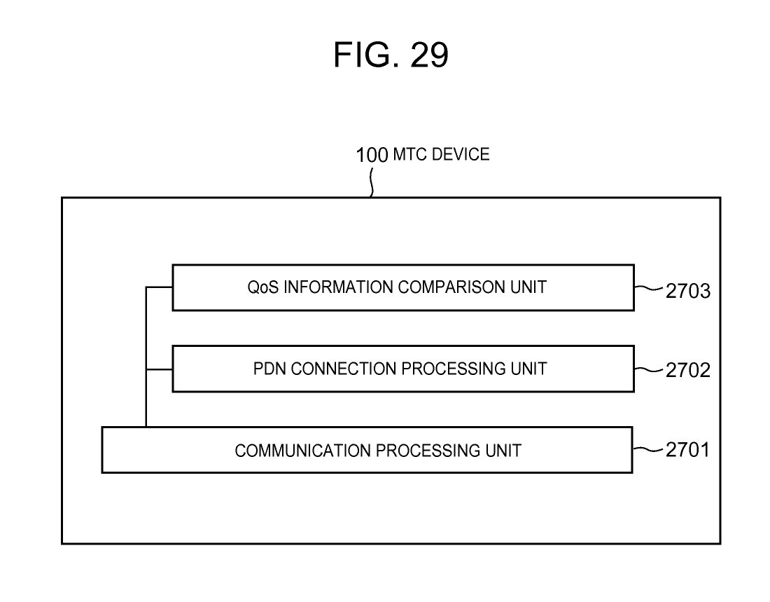

The following describes a structure of the MTC device 100 in Embodiment 9 of the present invention, with reference to FIG. 29. FIG. 29 is a diagram showing an example of the structure of the MTC device 100 in Embodiment 9 of the present invention.

In FIG. 29, the MTC device 100 at least includes: a communication processing unit 2701 that is connected to the communication system (e.g. E-UTRAN or UTRAN) and performs communication processing in a lower layer and packet communication processing of IP or the like in a higher layer; a PDN connection processing unit 2702 that performs processing such as sending a PDN connection establishment request, updating QoS information assigned to an EPS bearer of an established PDN connection, and releasing a PDN connection; and a QoS information comparison unit 2703 that compares QoS information of an established PDN connection and QoS information of an additionally established PDN connection. Though not shown in FIG. 29, the MTC device 100 may also include a priority level comparison unit that compares a priority level of an additional PDN connection and a priority level of an established PDN connection.

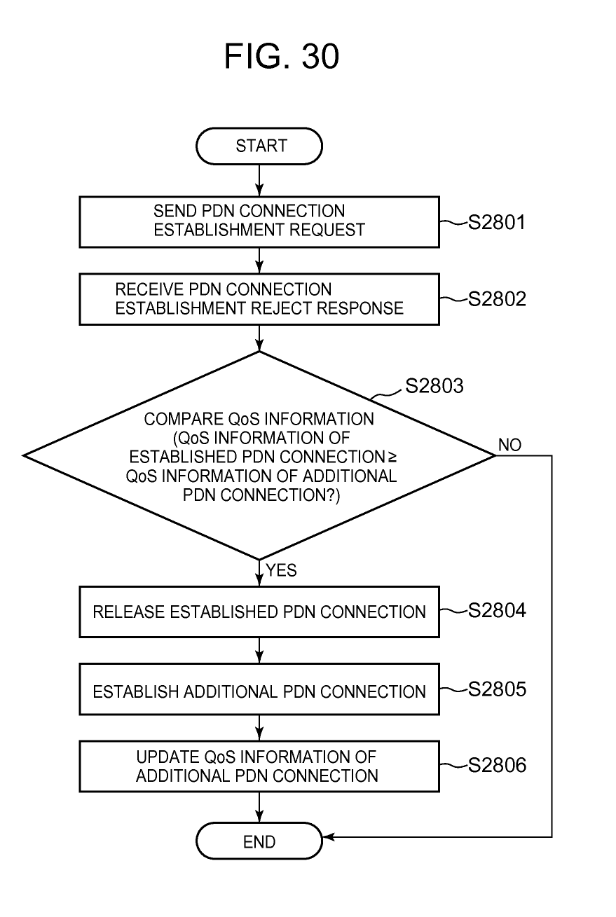

The MTC device 100 having the structure shown in FIG. 29 is described in detail below while mainly focusing on characteristic processing in the present invention, with reference to FIG. 30.

In FIG. 30, the MTC device 100 is in a state where one PDN connection has been already established, and sends an additional PDN connection establishment request to the network from the PDN connection processing unit 2702 via the communication processing unit 2701 (step S2801: send PDN connection establishment request).

Since the network receiving the PDN connection establishment request detects congestion, the MTC device 100 receives a PDN connection establishment reject response from the 3G access network (step S2802: receive PDN connection establishment reject response).

The MTC device 100 whose additional PDN connection establishment request is rejected compares QoS information assigned to an EPS bearer of the already established PDN connection and QOS information necessary for an EPS bearer of the additionally established PDN connection in the QoS information comparison unit 2703 (step S2803: compare QoS information). Here, the MTC device 100 may compare a priority level of the additional PDN connection and a priority level of the already established PDN connection in the priority level comparison unit and, in the case of determining that the additional PDN connection has a higher priority level, compare the QoS information in order to check whether or not the additional PDN connection can be established instead of the already established PDN connection.

If the QoS information of the additionally established PDN connection is equal to or less than the QoS information of the already established PDN connection as a result of the comparison in step S2803 (e.g. the GBR necessary for the EPS bearer of the additionally established PDN connection is 4 Mbps and the GBR of the EPS bearer of the already established PDN connection is 5 Mbps), the MTC device 100 instructs to release the already established PDN connection from the QoS information comparison unit 2703 to the PDN connection processing unit 2702, and sends a message for releasing the PDN connection via the communication processing unit 2701 (step S2804: release established PDN connection). When doing so, the MTC device 100 contains an identifier for instructing not to assign, to another MTC device 100 or UE 105, the resources (e.g. communication resources and bandwidth resources) assigned to the released PDN connection, in the message to be sent.

On the other hand, if the QoS information of the additionally established PDN connection is more than the QoS information of the already established PDN connection as a result of the comparison in step S2803 (e.g. the GBR necessary for the EPS bearer of the additionally established PDN connection is 6 Mbps and the GBR of the EPS bearer of the already established PDN connection is 5 Mbps), the MTC device 100 maintains the already established PDN connection without releasing it.

Having released the already established PDN connection, the MTC device 100 establishes the additional PDN connection from the PDN connection processing unit 2702 via the communication processing unit 2701 (step S2805: establish additional PDN connection). In this step as in step S2804, the MTC device 100 contains an identifier for identifying that the MTC device 100 is the MTC device 100 releasing the PDN connection, in the additional PDN connection establishment request.

After establishing the PDN connection, the MTC device 100 updates default PDN connection QoS information to the QoS information necessary for the additional PDN connection, using a UE requested bearer resource modification procedure defined in Non-patent Document 3 or the like (step S2806: update QoS information of additional PDN connection). In this step as in step S2804, the MTC device 100 contains an identifier for identifying that the MTC device 100 is an MTC device 100 releasing the PDN connection, in the already established PDN connection QoS information update message.

In the case where, after the QoS information comparison in step S2803, the MTC device 100 can attain the required PDN connection by performing the PDN connection modification procedure without performing the process of releasing the already established PDN connection and establishing the new PDN connection, steps S2804 and 2805 may be omitted.

In Embodiment 9 of the present invention, the congestion-related information is sent from the network to the MTC device 100, and the MTC device 100 compares the QoS information assigned to the already established PDN connection or the EPS bearer of the PDN connection with the QoS information necessary for the additional PDN connection, to determine whether or not the resources secured by releasing the already established PDN connection can be used for establishing the new PDN connection. In addition to the QoS information, the number of PDN connections establishable by the MTC device 100 may be used when determining whether or not to release the already established PDN connection.

For example, the MTC device 100 may obtain the information of the number of establishable PDN connections from the information statically stored for MTC. Alternatively, the network may report the number of establishable PDN connections to the MTC device beforehand, at an arbitrary timing (e.g. upon congestion detection). Alternatively, the MTC device 100 may obtain information indicating that “the number of PDN connections establishable by the MTC device 100 is one” from the network, at the time of establishment of the already established PDN connection. Alternatively, in the case where the network cannot contain the QoS information but can only contain the information that “the number of PDN connections establishable by the MTC device 100 is one” in the PDN connection establishment reject response, the network may send the information that “the number of PDN connections establishable by the MTC device 100 is one” in the response (PDN connection establishment reject response) to the PDN connection establishment request sent from the MTC device 100 upon additional PDN connection establishment.

By combining the QoS information and the number of establishable PDN connections in this way, the network can control the assignable resources with high accuracy. For example, when the network receives the additional PDN connection establishment request from the MTC device 100 that has already established on PDN connection, the network sends the PDN connection establishment reject response to the MTC device 100. The MTC device 100 checks the number of PDN connections currently established, using the held information of the number of establishable PDN connection. Moreover, in the case where there is the already established PDN connection, the MTC device 100 compares the QoS information (e.g. GBR=1 Mbps) assigned to the already established PDN connection or the EPS bearer of the already established PDN connection with the QoS information (500 kbps) necessary for the additionally established PDN connection. If the QoS information necessary for the additional PDN connection is satisfied, the MTC device 100 can release the already established PDN connection and establish the additional PDN connection.

There is an instance where information sharing (synchronization) is not established in the PDN connection processing unit managing the number of PDN connections and the information of the number of establishable PDN connections held in the MTC device 100, an instance where the information (e.g. the congestion level or the number of PDN connections establishable currently) obtainable from the PDN connection establishment reject response is obtained, or an instance where the establishment of the PDN connection of a higher priority level than the already established PDN connection is requested. This raises a possibility that the MTC device 100 sends the PDN connection establishment request to establish the additional PDN connection despite a state in which the number of already established PDN connections reaches the number of establishable PDN connections indicated by the information held in the MTC device 100.

As described above, according to Embodiment 9 of the present invention, when the MTC device 100 that has already established the PDN connection establishes the additional PDN connection, even if the network detects congestion, the MTC device 100 can compare the QoS information assigned to the already established PDN connection and the QoS information necessary for the additionally established PDN connection and, in the case where the QoS information necessary for the additionally established PDN connection satisfies the QoS information assigned to the already established PDN connection, release or modify the already established PDN connection and establish the additional PDN connection. This enables the MTC device 100 to send data of a high priority level, thereby solving the problem that data of a high priority level cannot be communicated between the MTC device 100 and the MTC server 150, the MTC user 160, or the like.

### Embodiment 10

In Embodiment 10 of the present invention, the MTC device 100 that has already established a PDN connection and wants to further establish an additional PDN connection releases the already established PDN connection and establishes the additional PDN connection based on information of communication resources and bandwidth resources assignable to the MTC device 100 or the UE 105 sent from the network.

A scenario assumed in Embodiment 10 is the same as that in Embodiment 9. The difference from Embodiment 9 lies in that, when the MTC device 100 establishes the additional PDN connection, the MTC device 100 determines to release the already established PDN connection in the case where resources that combine QoS information assigned to the already established PDN connection or an EPS bearer of the PDN connection and QoS information (e.g. communication resource or bandwidth resource) assignable to the MTC device 100 as reported by the network are more than resources necessary for the newly established PDN connection. The difference from Embodiment 9 is mainly described in detail below.

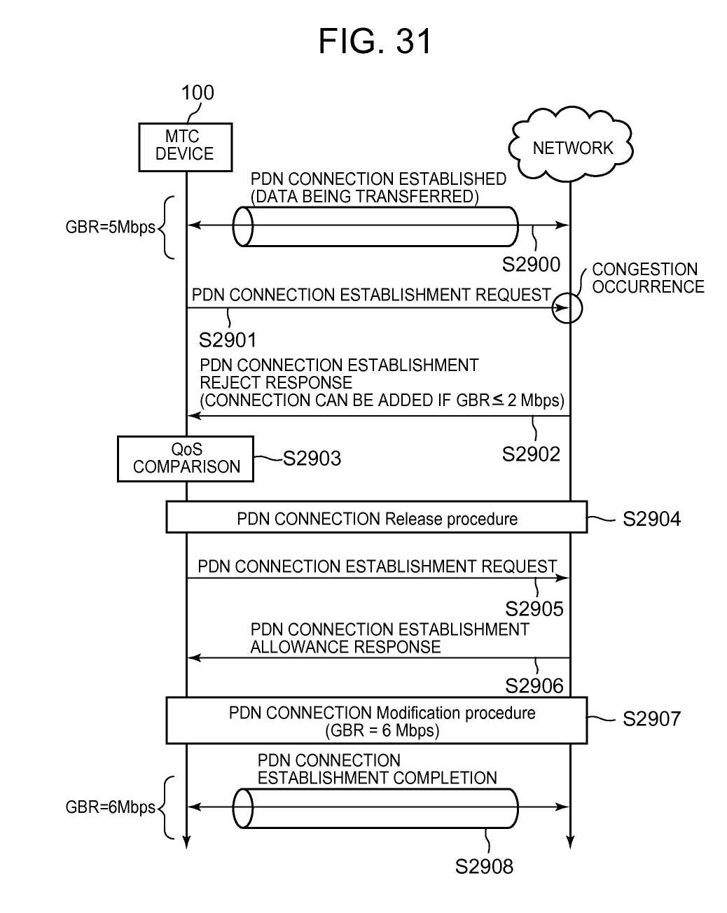

The following describes Embodiment 10 of the present invention with reference to FIGS. 31, 32, 33A to 33E, and 34 to 36.

As in Embodiment 9 of the present invention, it is assumed that the MTC device 100 in Embodiment 10 of the present invention has already established one PDN connection with the network and a bit rate (GBR: Guaranteed Bit Rate) guaranteed by the network for an EPS bearer in the already established PDN connection is 5 Mbps, for ease of explanation of Embodiment 10 of the present invention. The MTC device 100 sends a PDN connection establishment request to establish an additional PDN connection. Here, the MTC device 100 recognizes that data sent using the additional established PDN connection has a higher priority level than data sent using the already established PDN connection.

An operation in which, when the MTC device 100 that has established the PDN connection including the EPS bearer to which “GBR=5 Mbps” is assigned establishes the additional PDN connection, the MTC device 100 releases the already established PDN connection and establishes the additional PDN connection based on QoS information sent form the network is described below, with reference to FIG. 31.

In FIG. 31, it is assumed that the MTC device 100 that has established the PDN connection including the EPS bearer to which “GBR=5 Mbps” is assigned tries to establish the additional PDN connection (step S2900). To establish the additional PDN connection, the MTC device 100 sends a PDN connection establishment request (step S2901: PDN connection establishment request). Steps S2900 and S2901 in FIG. 31 are the same as steps S2500 and S2501 in FIG. 25, and so their detailed description is omitted here.

Upon detecting congestion, the network sends a PDN connection establishment reject response containing QoS information (e.g. allowed if GBR<=2 Mbps) assignable to the MTC device 100 which is the sender of the PDN connection establishment request (step S2902: PDN connection establishment reject response). Examples of QoS information other than the GBR includes the QCI (QoS Class Indicator), the ARP (Allocation and Retention Priority), the

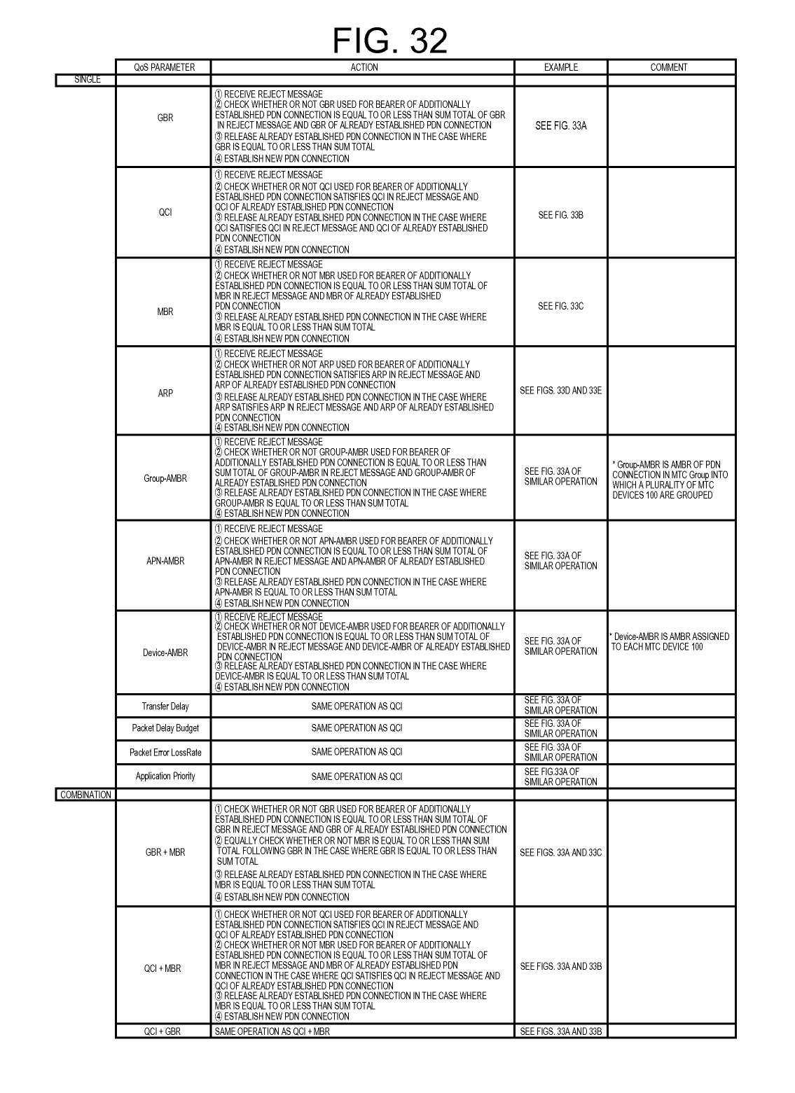

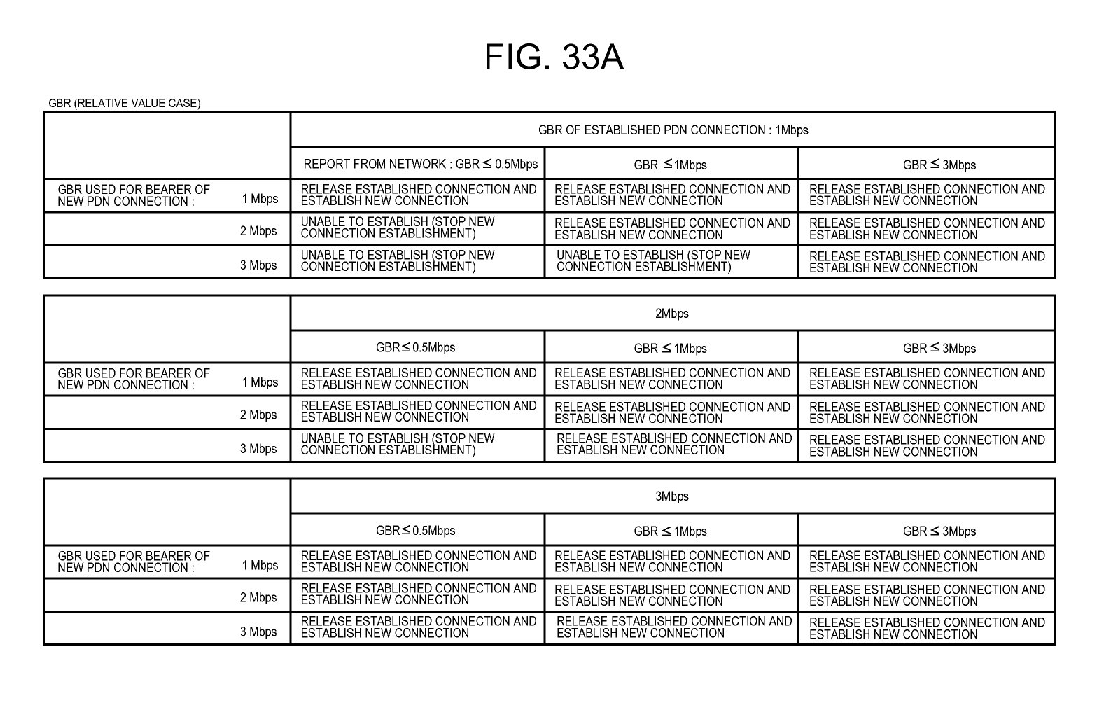

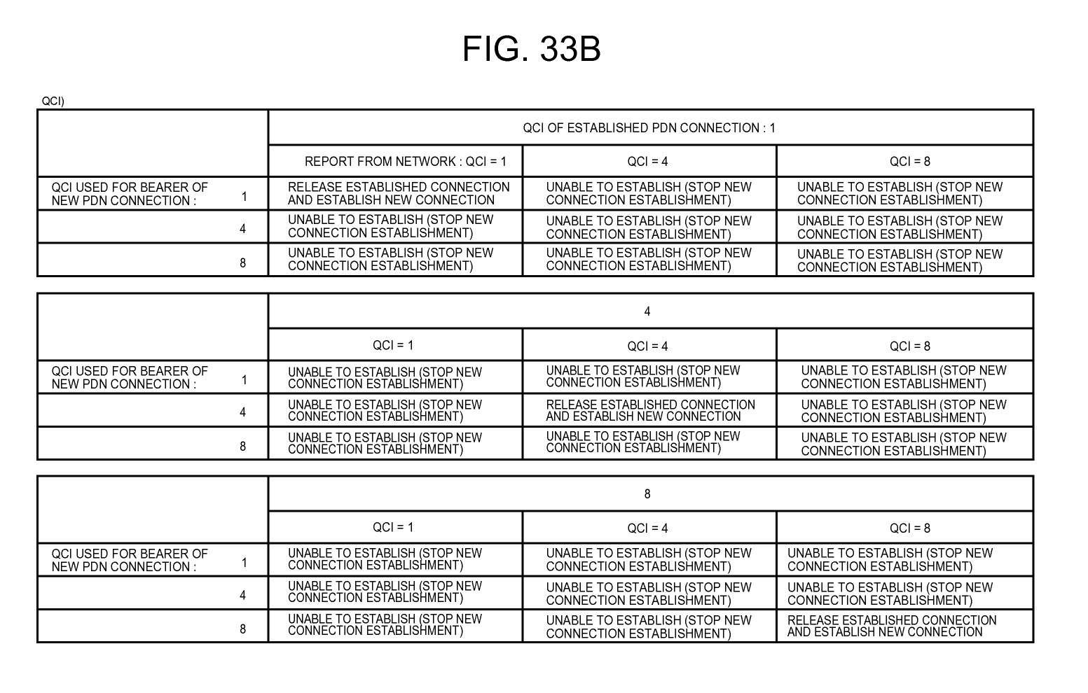

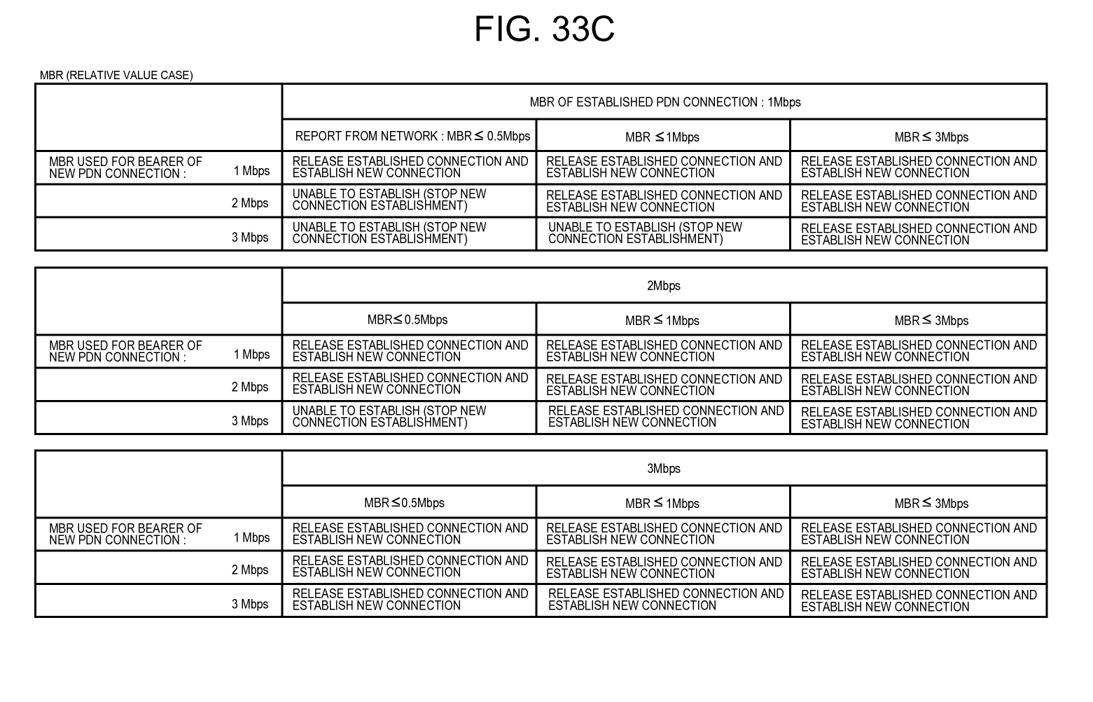

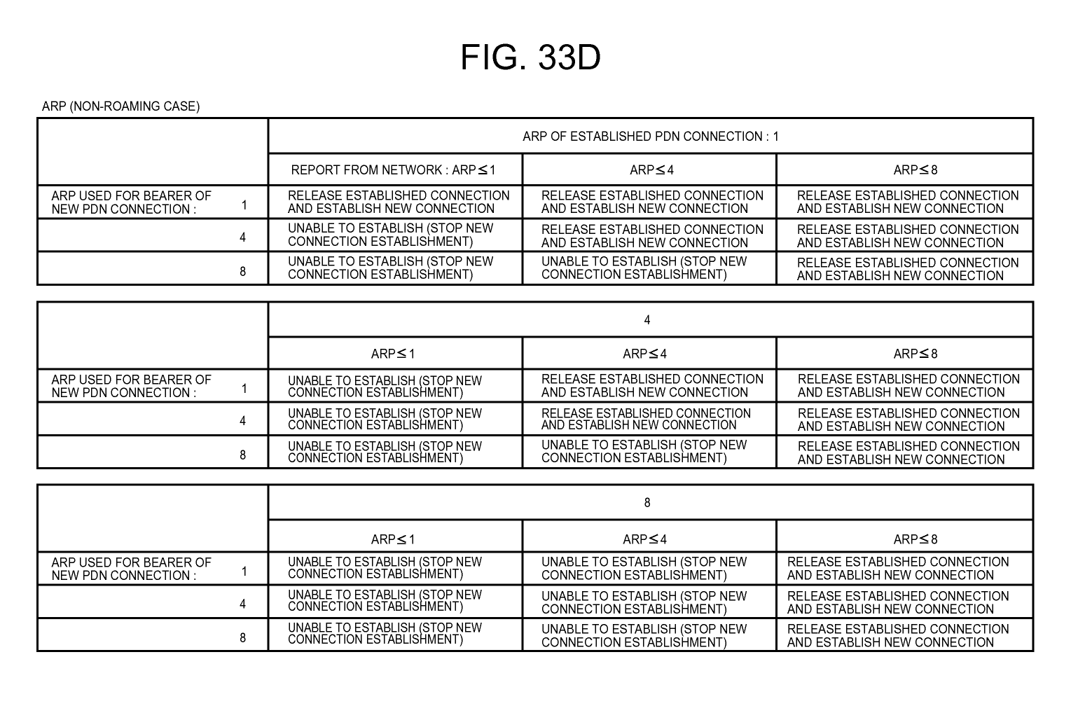

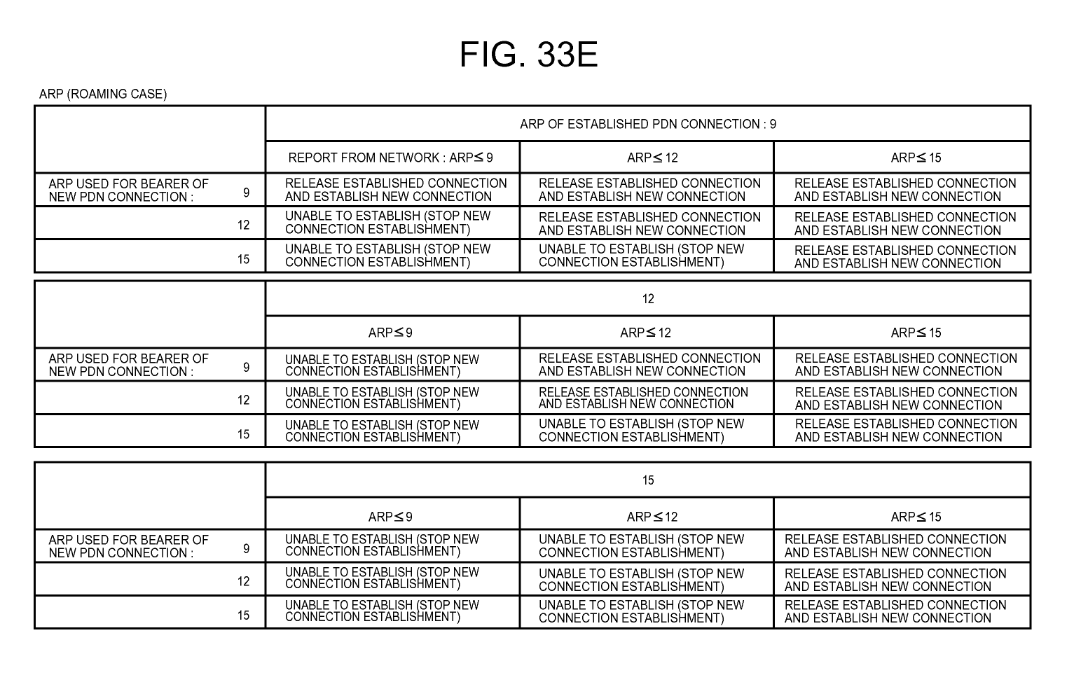

MBR (Maximum Bit Rate), the group-AMBR (Group-Aggregated Maximum Bit Rate), the APN-AMBR (Access Point Name-AMBR), the transfer delay, the packet delay budget, the packet error loss rate, the application priority, and so on, as shown in FIGS. 32 and 33A to 33E.

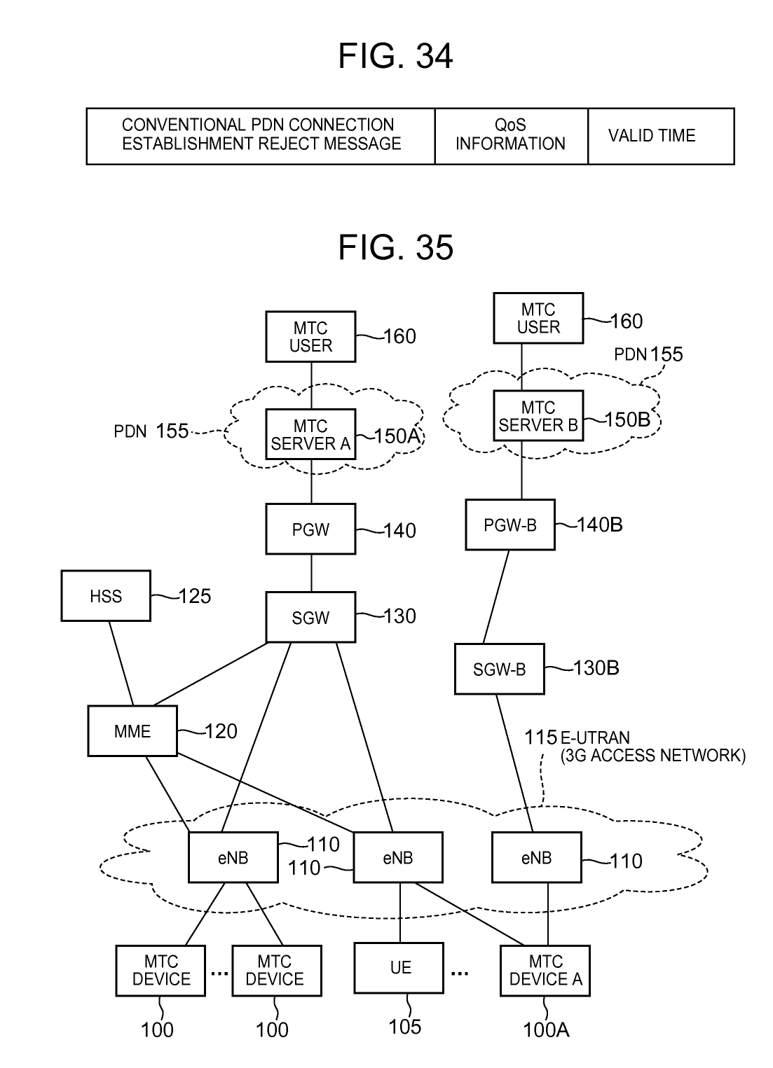

FIG. 34 shows an example of a format of a message when the 3G access network reports the QoS information assignable to the additional PDN connection to the MTC device 100.

The message shown in FIG. 34 has, in addition to a conventional PDN connection establishment reject message field, a QoS information field containing the QoS information assignable to the MTC device 100, and a valid time field indicating a valid time (assignable time) of the information contained in the QoS information field. The valid time field may be used in combination with the wait time described in Embodiment 8 of the present invention.

As shown in FIG. 31, upon receiving the report of the QOS information assignable to the MTC device 100 from the network, the MTC device 100 compares whether or not the QoS information necessary for the additionally established PDN connection is equal to or less than a sum total of the QoS information assigned to the already established PDN connection and the QoS information assignable to the MTC device 100 as reported in step S2092 (step S2903: QoS comparison).

For example, in GBR comparison, in the case where the GBR is equal to or less than 1.5 Mbps when the GBR assigned to the EPS bearer of the already established PDN connection is 1 Mbps and the GBR assignable to the additional PDN connection as reported in the PDN connection establishment reject response from the network is 0.5 Mbps, the MTC device 100 can establish the additional PDN connection, as shown in FIG. 33A. That is, the additional PDN connection can be established if the GBR necessary for the EPS bearer of the additional PDN connection is equal to or less than 1.5 Mbps. Here, the already established PDN connection needs to be released if the GBR of PDN connection additionally established by the MTC device is such that “(GBR reported from network)<(GBR of additionally established PDN connection)<(sum total of GBR reported from network and GBR assigned to EPS bearer of already established PDN connection)”. Though the QoS information assignable to the additional PDN connection as reported from the network to the MTC device 100 in this specific example is QoS information assignable to the current MTC device 100, QoS information representing an absolute value establishable by the MTC device 100 may be used. For example, in the case of the GBR, the 3G access network may report 1.5 Mbps ((GBR assigned to EPS bearer of already established PDN connection) (1 Mbps)+(GBR assignable to additional PDN connection) (0.5 Mbps)), as the QoS information assigned to the MTC device 100.

In QCI comparison, in the case where the QCI of the PDN connection additionally established by the MTC device 100 matches the QCI assignable to the MTC device 100 as reported from the 3G access network, the MTC device 100 can establish the additional PDN connection.

Though described in detail later, in the case where the number of PDN connections establishable by the MTC device 100 is reported to the MTC device 100 in addition to the QoS information (for example, the MTC device 100 is allowed to establish one PDN connection in total during a predetermined time (e.g. wait time (backoff time) reported during congestion)), the MTC device 100 checks the QCI of the already established PDN connection, and compares it with the QCI of the additionally established PDN connection. If the QCIs match and also the number of establishable PDN connections is one, the MTC device 100 can release the already established PDN connection and establish the additional PDN connection.

Though the above describes the use of the GBR and the QCI in the QoS information comparison process, FIG. 32 and FIGS. 33A to 33E respectively show actions and action results including examples relating to other QoS information.

Before performing the QoS comparison in step S2903, the MTC device 100 whose additional PDN connection establishment request is rejected may compare the priority level of the additional PDN connection and the priority level of the already established PDN connection, as described in Embodiment 9 of the present invention. Note that each PDN connection priority level may be obtained using a priority level assigned to each application, which can be acquired from the application layer, a policy held in the MTC device 100, information statically stored in the MTC device 100 for MTC (e.g. an application activated first is processed with priority), or the like.

Steps S2904 to S2908 after the QoS comparison in step S2903 in FIG. 31 are the same as steps S2505 to S2509 in FIG. 25, and so their detailed description is omitted here.

Though Embodiment 10 of the present invention describes the case where the QoS information assignable to the MTC device 100 is reported using the PDN connection establishment reject response to the additional PDN connection establishment request from the MTC device 100, the network may report the QoS information using a PDN connection establishment allowance response given that there are resources assignable to the MTC device 100. In such a case, the PDN connection establishment reject response in step S2902 is replaced with the PDN connection establishment allowance response. In addition, the PDN connection modification procedure in step S2907 can be performed while omitting steps S2903 to S2906.

Though Embodiment 10 of the present invention describes the case where the QOS information is reported from the network to the MTC device 100, the number of PDN connections establishable by the MTC device 100 may be reported in addition to the QoS information. By combining the QoS information and the number of establishable PDN connections in this way, the network can control the assignable resources with high accuracy. For example, when the network receives the additional PDN connection establishment request from the MTC device 100 that has already established on PDN connection, the network sends, to the MTC device 100, the PDN connection establishment reject response containing the information indicating that “the number of PDN connections establishable by the MTC device 100 is one” and the QoS information indicating that “the QoS information (GBR) assignable to the additional PDN connection is 1 Mbps”. From the information that “the number of PDN connections establishable by the MTC device 100 is one”, the MTC device 100 can recognize that the already established PDN connection needs to be released to establish the additional PDN connection. Further, from the QoS information that “the QoS information (GBR) assignable to the additional PDN connection is 1 Mbps”, the MTC device 100 can recognize whether or not the QoS information necessary for the additional PDN connection is satisfied. In the case where the QoS information necessary for the additional PDN connection is equal to or less than the QoS information assigned to the already established PDN connection, the MTC device 100 can release the already established PDN connection and establish the additional PDN connection.

As described above, according to Embodiment 10 of the present invention, when the MTC device 100 that has already established the PDN connection establishes the additional PDN connection, even if the network detects congestion, the MTC device 100 can compare the QoS information assignable to the MTC device as reported from the network, the QoS information assigned to the already established PDN connection, and the QoS information necessary for the additionally established PDN connection and, in the case where the QoS information necessary for the additionally established PDN connection satisfies the QoS information assigned to the already established PDN connection, release the already established PDN connection and establish the additional PDN connection. This enables the MTC device 100 to send data of a high priority level, thereby solving the problem that data of a high priority level cannot be communicated between the MTC device 100 and the MTC server 150, the MTC user 160, or the like.

Embodiments 9 and 10 of the present invention described above are based on an assumption that the connection destination of the PDN connection already established by the MTC device 100 and the connection destination of the PDN connection additionally established by the MTC device 100 are the same.

FIG. 35 shows a state where the MTC device 100 is capable of establishing PDN connections with a plurality of connection destinations. In FIG. 35, the MTC device A 100A can connect to a plurality of MTC servers 150. As an example, the connection destination of the first PDN connection (already established PDN connection) is an MTC server A 150A, and the connection destination of the second PDN connection (additionally established PDN connection) is an MTC server B 150B.

In the case where the MTC device A 100A has different connection destinations, a connection destination check process step is needed after the PDN connection establishment reject response reception in Embodiments 9 and 10 of the present invention.

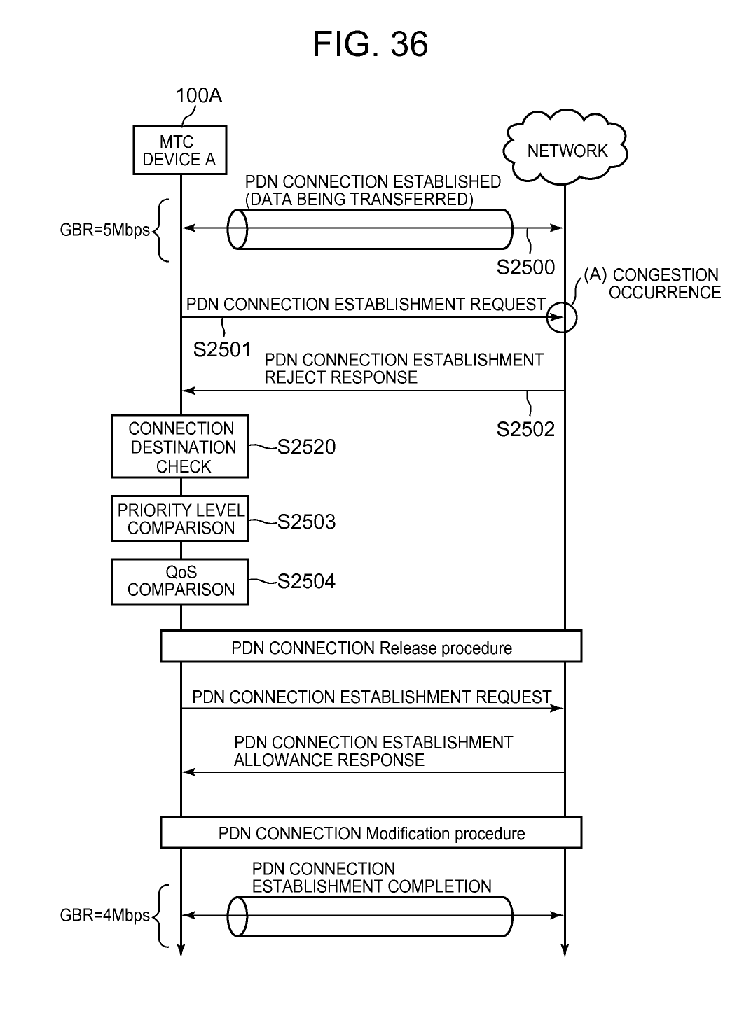

FIG. 36 is a sequence chart in which the connection destination check process step is added between steps S2502 and S2503 in FIG. 25. Here, the MTC device A 100A in FIG. 35 corresponds to the MTC device A 100A in FIG. 36.

The MTC device A 100A that has already established the PDN connection for sending data to the MTC server A 150A sends a PDN connection establishment request to the network to establish the PDN connection for sending data to the MTC server B 150B (step S2501). The network that receives the PDN connection establishment request for sending data to the MTC server B sends a PDN connection establishment reject response due to (A) congestion occurrence (step S2502).

As a process for determining whether or not the MTC device A 100A can release the already established PDN connection and establish the additional PDN connection, the MTC device A 100A checks whether or not the connection destination of the already established PDN connection and the connection destination of the additional PDN connection are the same (step S2520). An APN may be used as information indicating each connection destination. That is, the MTC device A 100A determines that the connection destinations are the same in the case where the APNs are the same, and that the connection destinations are different in the case where the APNs are different.

In the case where the connection destination of the already established PDN connection and the connection destination of the additional PDN connection are the same, the MTC device A 100A performs the same process as in Embodiment 9 (process from step S2503 in FIG. 25) or the same process as in Embodiment 10 (process from step S2903 in FIG. 31).

On the other hand, in the case where the connection destination of the already established PDN connection and the connection destination of the additional PDN connection are different, e.g. in the case where congestion is detected in the MTC server B 150B receiving the additional PDN connection establishment request but no congestion is detected (no congestion occurs) in the MTC server A 150A to which data is being transferred from the MTC device A 100A via the already established PDN connection, the MTC device A 100A determines that the resources secured by releasing the already established PDN connection cannot be reused for establishing the additional PDN connection. Note that the reason of rejecting the additional PDN connection establishment request is not limited to congestion detection in the MTC server B 150B but may be, for example, congestion occurring in a network (communication system) entity such as an SGW-B 130B or a PGW-B 140B.

When the additional PDN connection establishment request sent from the MTC device A 100A is rejected due to congestion of the MTC server B 150B in a state where no congestion occurs in the MTC server A 150A, the MTC device A 100A cannot establish the PDN connection for sending data to the MTC server B 150B even if the PDN connection for sending data to the MTC server A 150A is released. Accordingly, the MTC device A 100A maintains the already established PDN connection, and cancels the additional PDN connection establishment.

Even in a situation where the connection destination of the already established PDN connection and the connection destination of the additional PDN connection are different, if the MTC device A 100A can change the connection destination of the rejected additional PDN connection (e.g. in the case where the MTC server A 150A and the MTC server B 150B are under the authority of the same operator are or are connected to the MTC user 160, or the MTC server A 150A and the MTC server B 150B have a PDN connection switch contract with each other and automatically perform negotiation), the MTC device A 100A changes the connection destination of the additionally established PDN connection. The MTC device A 100A then releases the PDN connection with the MTC server A 150A which is the connection destination of the already established PDN connection, and establishes the additional PDN connection for transferring data to the MTC server A 150A. The process of changing the connection destination of the additional PDN connection and the process of releasing the PDN connection with the MTC server A 150A which is the connection destination of the already established PDN connection may be performed in any order.

The connection destination may be identified by any connection destination identifiable information such as the address or identity (e.g. MTC server TEID) of the MTC server 150 or the MTC user 160, the address or identity (e.g. PGW TEID) of the PGW as a network (communication system) device, or the APN.

In the above embodiments (Embodiments 2 to 8 in particular), the event information (e.g. device ID, device type ID) is contained in the reverse event report message (event information) or the sending control message. Here, the eNB ID or the eNB address (and the S1-U TEID corresponding to the EPS bearer of the MTC device 100), the address of the MTC device A 100A which is the sender of the event report message (event information) @ device A, or the information managed in the MTC service (such as the location information of the MTC device A 100A (e.g. the third floor, the room 301, the third street)) may further be added so that the MTC device 100 receiving the reverse event report message (event information) determines whether or not to make the mode transition.

Though the present invention is described using, as an example, a method of suppressing a redundant event report message that can be generated when the MTC device A 100A having a communication module implemented in a smoke sensor detects smoke, the present invention is also applicable in the following cases.

As an example, in an environment in which a plurality of MTC devices A 100A each having a communication module implemented in a gas pipe sensor for checking a state of a gas pipe (e.g. whether or not damaged) and a plurality of MTC devices B 100B each having a communication module implemented in a gas sensor for detecting gas leakage and mainly placed in a residential space belong to the same MTC group, an event report message (event information) @ device A sent from an MTC device A 100A due to gas pipe damage may be used to suppress an event report message of each MTC device B 100B. In detail, upon receiving the event report message (event information) @ device A containing the event information (e.g. gas pipe sensor ID) from the MTC device A 100A, the network device (e.g. the MME 120, the MTC server 150) sends a reverse event report message containing the event information (e.g. gas pipe sensor ID) to each MTC device 100 in the MTC group so that the MTC device 100 determines whether or not to make the mode transition (whether or not to send a high priority event report message). By applying the present invention to such an MTC service, it is possible to suppress redundant high priority event report messages from a plurality of MTC devices 100 that each detect an event (e.g. gas pipe damage or gas leakage) of further gas pipe damage or gas leakage which is expected to be caused by the gas pipe damage. This can reduce the processing load on the MTC device 100 and the network device (e.g. the MME 120, the MTC server 150) and the network traffic load.

As another example, in the case where a plurality of MTC devices 100 each having a communication module implemented in a car equipped with an impact sensor that operates with an air back encounter a multiple-car crush (e.g. multiple collision), a high priority event report message sent to the network device (e.g. the MME 120, the MTC server 150) first may be used to suppress subsequent high priority event report messages. In detail, the network device (e.g. the MME 120, the MTC server 150) broadcasts a reverse event report message containing event information (e.g. impact sensor ID) in the event report message received first to each MTC device 100 in the area (e.g. under the eNB 110 to which the event report message is sent) where the crush occurs, thereby suppressing any high priority event report message of the same event or an event caused by the incident that causes the former event. By applying the present invention to such an MTC service, it is possible to suppress redundant high priority event report messages that are likely to be generated when a plurality of cars each carrying the impact sensor crush. This can reduce the processing load on the MTC device 100 and the network device (e.g. the MME 120, the MTC server 150) and the network traffic load.

As another example, in an environment in which a plurality of MTC devices 100 each having a communication module implemented in an accelerometer or a tilt sensor for monitoring a landslide are installed in an area (e.g. mountain, cliff) where a landslide is likely to occur, an event report message sent from an MTC device 100 when a landslide occurs may be used to suppress subsequent high priority event report messages. In detail, upon receiving the event report message (event information) containing the event information (e.g. accelerometer ID) from the MTC device 100, the network device (e.g. the MME 120, the MTC server 150) sends a reverse event report message containing the event information (e.g. accelerometer ID) to each MTC device 100 in the MTC group so that the MTC device 100 determines whether or not to make the mode transition (whether or not to send a high priority event report message). In such an environment in which the MTC service for monitoring only the single event is predefined, it is clear which event occurs even when the event information (e.g. accelerometer ID) is not included, so that the event information may be omitted.

The present invention is equally applicable to an MTC service for checking any abnormality of a bridge by monitoring vibrations of the bridge by each MTC device having a communication module implemented in a vibration sensor.

In each of the above embodiments of the present invention, the event report message sent from the MTC device 100 triggers the network device (e.g. the MME 120, the SGW 130, the PGW 140, the MTC server 150) to broadcast the reverse event report message for suppressing a redundant event report message. However, the broadcasting of the reverse event report message may be triggered not by the event report message but when a mismatch of association between the MTC device 100 and a UICC (Universal Integrated Circuit Card) incorporated in the MTC device 100 is detected, when the MTC features functioning on the MTC device 100 are inconsistent with the MTC features registered in the subscription data of the MTC device 100 held by the HSS, when a change in location information of the MTC device 100 is detected in an environment in which the MTC device 100 has a limited or fixed placement location (e.g. vending machine, smoke sensor, flame sensor), i.e. in an environment in which the location information of the MTC device 100 is unlikely to change (except for switching the base station connected with the MTC device 100 due to a communication environment change or a base station load balance), when a PDN connection or an EPS bearer between the MTC device 100 and the network is disconnected, or the like.

In each of the above embodiments of the present invention, the network device (e.g. the MME 120, the SGW 130, the PGW 140, the MTC server 150) receiving the event report message from the MTC device 100 transfers the event report message to another network device (e.g. the MME 120 receiving the event report message transfers the event report message or only the necessary information to the MTC server 150 via the SGW 130 and the PGW 140 in Embodiment 2 of the present invention). However, such transfer may be omitted according to the operator policy, the MTC application specifications, or the like.

In each of the above embodiments of the present invention, the MTC device 100 detects the event after establishing the PDN connection and the EPS bearer with the network. Alternatively, the MTC device 100 may establish the PDN connection and the EPS bearer and sends the event information or the sensing information after detecting the event.

In each of the above embodiments of the present invention, the network device sending the reverse event report message is the MME 120, the PGW 140, or the MTC server 150 as an example. However, the present invention is not limited to such, and the SGW 130 or a device located in an external network (e.g. roaming destination network device, AAA server, SIP server) may send the reverse event report message.

In each of the above embodiments of the present invention, the network device (e.g. the MME 120, the SGW 130, the PGW 140, the MTC server 150) receiving the event report message broadcasts the reverse event report message. Alternatively, the network device (e.g. the MME 120, the SGW 130, the PGW 140, the MTC server 150) may instruct the base station (the eNB 110) to which the MTC device 100 is connected to broadcast the reverse event report message so that the eNB 110 broadcasts the reverse event report message. For example, by utilizing and extending a technique whereby the eNB broadcasts paging to cause the UE 105 to obtain ETWS information as currently specified, the present invention can be implemented without significantly affecting an existing system.

In each of the above embodiments of the present invention, the network device (e.g. the MME 120, the SGW 130, the PGW 140, the MTC server 150) receiving the event report message broadcasts the reverse event report message, thereby suppressing a redundant event report message. Alternatively, a message having another role may be broadcast. For example in the case where the network detects a change in location information of one vending machine due to theft in an environment in which a plurality of vending machines (MTC devices 100) are installed in a specific area, such a change in location information of the vending machine may trigger the network device to broadcast a message instructing to send location information (tracking area update), to the plurality of vending machines in the specific area. In this way, the states of the other vending machines can be checked more promptly and reliably than in the case of regular location information update.

In each of the above embodiments of the present invention, the network device (e.g. the MME 120, the SGW 130, the PGW 140, the MTC server 150) receiving the event report message broadcasts the reverse event report message. However, if the network device can recognize each MTC device 100 to which the reverse event report message is to be sent, the reverse event report message may be sent by multicasting or unicasting.

Each functional block used in the description of the above embodiments of the present invention is typically implemented as LSI (Large Scale Integration) which is an integrated circuit. Each of the functional blocks may be separately implemented on one chip, or all or part of the functional blocks may be implemented on one chip. Though LSI is mentioned as the integrated circuit here, the integrated circuit may be called any of an IC (Integrated Circuit), system LSI, super LSI, or ultra LSI depending on the degree of integration.

Moreover, the integrated circuit method is not limited to LSI, and may be realized by a dedicated circuit or a general-purpose processor. A FPGA (Field Programmable Gate Array) that can be programmed after LSI manufacturing or a reconfigurable processor capable of reconfiguring connections and settings of circuit cells inside LSI may also be used.

Furthermore, when an integrated circuit technology that replaces LSI emerges from advancement of semiconductor technologies or other derivative technologies, such a technology can be used for the functional block integration. For instance, biotechnology may potentially be adapted in this way.

### INDUSTRIAL APPLICABILITY

The present invention has an advantageous effect of, in an environment in which a communication node (MTC device 100) sends event detection information to a network server (MTC server 150) using a high priority message, reducing the processing load on an MTC server and communication system entities (e.g. eNB, MME, SGW, PGW) and the network traffic load by suppressing sending of an event report message in a high priority mode when another communication node in the neighborhood detects the same event or an event caused by the former event. The present invention also has an advantageous effect of reducing the processing load on an MTC server and communication system entities (e.g. eNB, MME, SGW, PGW) and the network traffic load in the case where congestion is detected on the network side. The present invention is particularly effective in an environment in which a plurality of communication nodes (MTC devices 100) are grouped (MTC grouping). Thus, the present invention is applicable to a communication technique of sending an emergency event report message in a high priority mode and a communication technique of alleviating congestion in a network. The present invention is particularly applicable to an MTC technique where a PAM sending feature or a time controlled feature (time tolerant feature) is defined.

1.-15. (canceled)

16. A connection establishment method wherein a communication node establishing a first connection with an entity in a network establishes a second connection, the connection establishment method comprising:
a step of comparing a priority of the first connection and a priority of the second connection, in the case where a connection establishment request message for establishing the second connection is rejected;
a step of comparing first QoS information assigned to the first connection and second QoS information necessary for the second connection, to determine whether or not the first QoS information is reusable for the second QoS information, in the case where the priority of the second connection is higher than the priority of the first connection; and
a step of modifying the first connection to establish the second connection, in the case of determining that the first QoS information is reusable for the second QoS information.

17. The connection establishment method according to claim 16, further comprising a step of checking whether or not a connection destination of the first connection and a connection destination of the second connection are the same.

18. The connection establishment method according to claim 16, wherein the step of modifying the first connection to establish the second connection sends the connection establishment request message for establishing the second connection, after releasing the first connection.

19. The connection establishment method according to claim 16, wherein the priority is obtained from information held by the communication node.

20. The connection establishment method according to claim 16, wherein the priority is obtained from an application used by the communication node.

21. The connection establishment method according to claim 16, wherein the second QoS information is obtained from information held by the communication node.

22. The connection establishment method according to claim 16, wherein the second QoS information is obtained from an application used by the communication node.

23. The connection establishment method according to claim 16, wherein the second QoS information is obtained from a communication node other than the communication node.

24. A communication node that establishes a connection with an entity in a network, the communication node comprising:
a sending unit configured to send a connection establishment request message for establishing the connection with the entity;
a comparison unit configured to compare a priority of a first connection and a priority of a second connection, when the communication node holds the first connection established with the entity and in the case where the connection establishment request message for establishing the second connection sent from the sending unit is rejected;
a determination unit configured to compare first QoS information assigned to the first connection and second QoS information necessary for the second connection, to determine whether or not the first QoS information is reusable for the second QoS information, in the case where the priority of the second connection is higher than the priority of the first connection; and
a modification unit configured to modify the first connection to establish the second connection, in the case where the first QoS information is determined to be reusable for the second QoS information.
